(19) United States
(12) Patent Application Publication
(10) Pub. No.: US 2025/0217320 A1
(43) Pub. Date: Jul. 3, 2025

(54) MULTI-SERVICE BUSINESS PLATFORM SYSTEM HAVING CUSTOM WORKFLOW ACTIONS SYSTEMS AND METHODS

(71) Applicant: HUBSPOT, INC., Cambridge, MA (US)

(72) Inventors: Jared WILLIAMS, Somerville, MA (US); Timothy HENNEKEY, Fairport, NY (US); Jonathan MEHARRY, Cambridge, MA (US); Scott JUDSON, Dallas, TX (US); Andrew PITRE, Cambridge, MA (US); Kevin WALSH, Cambridge, MA (US); Sophie HIGGS, Cambridge, MA (US); Jesse TREMBLAY, Arlington, MA (US)

(21) Appl. No.: 19/088,184

(22) Filed: Mar. 24, 2025

Related U.S. Application Data
(63) Continuation of application No. 18/428,305, filed on Jan. 31, 2024, now Pat. No. 12,282,457.
Application No. 18/428,305 is a continuation-in-part of application No. 18/196,672, filed on May 12, 2023.
Application No. 18/428,305 is a continuation-in-part of application No. 17/660,085, filed on Apr. 21, 2022, now Pat. No. 12,271,847.
Application No. 18/428,305 is a continuation-in-part of application No. 17/654,544, filed on Mar. 11, 2022, now Pat. No. 12,271,869.
Application No. 18/428,305 is a continuation-in-part of application No. 17/655,320, filed on Mar. 17, 2022.
Application No. 17/655,320 is a continuation of application No. 17/448,228, filed on Sep. 21, 2021.
Application No. 18/428,305 is a continuation-in-part of application No. 18/217,594, filed on Jul. 2, 2023.
Application No. 18/217,594 is a continuation of application No. 17/882,950, filed on Aug. 8, 2022, now Pat. No. 11,727,287.
Application No. 17/882,950 is a continuation of application No. 16/716,688, filed on Dec. 17, 2019, now Pat. No. 11,449,775.
Application No. 18/428,305 is a continuation-in-part of application No. 18/217,592, filed on Jul. 2, 2023, now Pat. No. 12,125,045.
Application No. 18/217,592 is a continuation of application No. 17/522,101, filed on Nov. 9, 2021, now Pat. No. 11,710,136.
Application No. 17/522,101 is a continuation of application No. 16/408,020, filed on May 9, 2019, now Pat. No. 11,200,581.
Application No. 18/428,305 is a continuation-in-part of application No. 17/657,687, filed on Apr. 1, 2022, now Pat. No. 12,271,926.
Application No. 17/657,687 is a continuation of application No. 16/668,696, filed on Oct. 30, 2019, now Pat. No. 11,321,736.
Application No. 16/668,696 is a continuation of application No. PCT/US2018/032348, filed on May 11, 2018.
Application No. 18/428,305 is a continuation-in-part of application No. 18/524,294, filed on Nov. 30, 2023.
Application No. 18/524,294 is a continuation of application No. 17/443,211, filed on Jul. 22, 2021, now Pat. No. 11,836,199.
Application No. 17/443,211 is a division of application No. 15/807,869, filed on Nov. 9, 2017, now abandoned.
Application No. 18/428,305 is a continuation-in-part of application No. 18/114,657, filed on Feb. 27, 2023, now Pat. No. 12,271,436.
Application No. 18/114,657 is a continuation of application No. 17/121,300, filed on Dec. 14, 2020, now Pat. No. 11,604,842.
(60) Provisional application No. 63/341,646, filed on May 13, 2022.
(60) Provisional application No. 63/201,274, filed on Apr. 21, 2021.
(60) Provisional application No. 63/160,446, filed on Mar. 12, 2021.
(60) Provisional application No. 63/080,900, filed on Sep. 21, 2020.
(60) Provisional application No. 62/785,544, filed on Dec. 27, 2018.
(60) Provisional application No. 62/669,617, filed on May 10, 2018.
(60) Provisional application No. 62/504,549, filed on May 11, 2017.
(60) Provisional application No. 62/419,772, filed on Nov. 9, 2016.
(60) Provisional application No. 63/450,282, filed on Mar. 6, 2023.
(60) Provisional application No. 62/050,548, filed on Sep. 15, 2014.

(51) Int. Cl. G06F 16/16; G06F 16/11; G06F 16/28

(52) U.S. Cl. CPC G06F 16/164; G06F 16/122; G06F 16/284

(57) ABSTRACT

Techniques are provided for implementing an artificial intelligence and machine learning (AI/ML) copilot (e.g., an AI/ML concierge). The AI/ML copilot receives a natural language command through a chat interface. The natural language command is parsed using AI/ML parsing functionality to determine a desired outcome. Programming code is generated for execution to achieve the desired outcome. The programming code is executed to generate content related to the desired outcome. The programming code interacts with objects within the CRM database in order to generate the content. In this way, the content is displayed through the chat interface.

### CROSS-REFERENCE TO RELATED APPLICATIONS

This application claims priority to and is a continuation of U.S. patent application, title “MULTI-SERVICE BUSINESS PLATFORM SYSTEM HAVING CUSTOM WORKFLOW ACTIONS SYSTEMS AND METHODS”, filed on Jan. 31, 2024 and accorded application Ser. No. 18/428,305, which is incorporated herein by reference.

application Ser. No. 18/428,305 claims priority to and is a continuation-in-part of U.S. patent application, titled “SYSTEM AND METHOD OF TRANSLATING A TRACKING MODULE TO A UNIQUE IDENTIFIER”, filed on May 12, 2023 and accorded application Ser. No. 18/196,672, which claims priority to U.S. Provisional Patent Application, filed on May 13, 2022 and accorded Application No.: 63/341,646, which are incorporated herein by reference.

application Ser. No. 18/428,305 claims priority to and is a continuation-in-part of U.S. patent application, titled “MULTI-SERVICE BUSINESS PLATFORM SYSTEM HAVING CUSTOM WORKFLOW ACTIONS SYSTEMS AND METHODS”, filed on Apr. 21, 2022 and accorded application Ser. No. 17/660,085, which claims priority to U.S. Provisional Patent Application, filed on Apr. 21, 2021 and accorded Application No.: 63/201,274, which are incorporated herein by reference.

application Ser. No. 18/428,305 claims priority to and is a continuation-in-part of U.S. patent application, titled “MULTI-SERVICE BUSINESS PLATFORM SYSTEM HAVING CONVERSATION INTELLIGENCE SYSTEMS AND METHODS”, filed on Mar. 11, 2022 and accorded application Ser. No. 17/654,544, which claims priority to U.S. Provisional Patent Application, filed on Mar. 12, 2021 and accorded Application No.: 63/160,446, which are incorporated herein by reference.

application Ser. No. 18/428,305 claims priority to and is a continuation-in-part of U.S. patent application, titled “MULTI-SERVICE BUSINESS PLATFORM SYSTEM HAVING CUSTOM OBJECT SYSTEMS AND METHODS”, filed on Mar. 17, 2022 and accorded application Ser. No. 17/655,320, which claims priority to and is a continuation of U.S. patent application, titled “MULTI-SERVICE BUSINESS PLATFORM SYSTEM HAVING CUSTOM OBJECT SYSTEMS AND METHODS”, filed on Sep. 21, 2021 and accorded application Ser. No. 17/448,228, which claims priority to U.S. Provisional Patent Application, filed on Sep. 21, 2020 and accorded Application No.: 63/080,900, which are incorporated herein by reference.

application Ser. No. 18/428,305 claims priority to and is a continuation-in-part of U.S. patent application, titled “SYSTEM AND METHOD OF TRANSLATING A TRACKING MODULE TO A UNIQUE IDENTIFIER”, filed on May 12, 2023 and accorded application Ser. No. 18/428,305, which claims priority to U.S. Provisional Patent Application, filed on May 13, 2022 and accorded Application No.: 63/341,646, which are incorporated herein by reference.

application Ser. No. 18/428,305claims priority to and is a continuation-in-part of U.S. patent application, titled “MULTI-CLIENT SERVICE SYSTEM PLATFORM”, filed on Jul. 2, 2023 and accorded application Ser. No. 18/217,594, which claims priority to and is a continuation of U.S. patent application, titled “MULTI-CLIENT SERVICE SYSTEM PLATFORM”, filed on Aug. 8, 2022 and accorded application Ser. No. 17/882,950, which claims priority to and is a continuation of U.S. patent application, titled “MULTI-CLIENT SERVICE SYSTEM PLATFORM”, filed on Dec. 17, 2019 and accorded application Ser. No. 16/716,688, which claims priority to U.S. Provisional Patent Application, filed on Dec. 27, 2018 and accorded Application No.: 62/785,544, which are incorporated herein by reference.

application Ser. No. 18/428,305 claims priority to and is a continuation-in-part of U.S. patent application, titled “MULTI-CLIENT SERVICE SYSTEM PLATFORM”, filed on Jul. 2, 2023 and accorded application Ser. No. 18/217,592, which claims priority to and is a continuation of U.S. patent application, titled “MULTI-CLIENT SERVICE SYSTEM PLATFORM”, filed on Nov. 9, 2021 and accorded application Ser. No. 17/522,101, which claims priority to and is a continuation of U.S. patent application, titled “MULTI-CLIENT SERVICE SYSTEM PLATFORM”, filed on May 9, 2019 and accorded application Ser. No. 16/408,020, which claims priority to U.S. Provisional Patent Application, filed on May 10, 2018 and accorded Application No.: 62/669,617, which are incorporated herein by reference.

application Ser. No. 18/428,305 claims priority to and is a continuation-in-part of U.S. patent application, titled “METHODS AND SYSTEMS FOR AUTOMATED GENERATION OF PERSONALIZED MESSAGES”, filed on Apr. 1, 2022 and accorded application Ser. No. 17/657,687, which claims priority to and is a continuation of U.S. patent application, titled “METHODS AND SYSTEMS FOR AUTOMATED GENERATION OF PERSONALIZED MESSAGES”, filed on Oct. 30, 2019 and accorded application Ser. No. 16/668,696, which claims priority to and is a continuation of International Patent Application, titled “METHODS AND SYSTEMS FOR AUTOMATED GENERATION OF PERSONALIZED MESSAGES”, filed on May 11, 2018 and accorded International Application Serial Number No.: PCT/US18/32348, which claims priority to U.S. Provisional Patent Application, filed on May 11, 2017 and accorded Application No.: 62/504,549, which are incorporated herein by reference.

application Ser. No. 18/428,305 claims priority to and is a continuation-in-part of U.S. patent application, titled “METHODS AND SYSTEMS FOR A CONTENT DEVELOPMENT AND MANAGEMENT PLATFORM”, filed on Nov. 30, 2023 and accorded application Ser. No. 18/524,294, which claims priority to and is a continuation of U.S. patent application, titled “METHODS AND SYSTEMS FOR A CONTENT DEVELOPMENT AND MANAGEMENT PLATFORM”, filed on Jul. 22, 2021 and accorded application Ser. No. 17/443,211, which claims priority to and is a divisional application of U.S. patent application, titled “METHODS AND SYSTEMS FOR A CONTENT DEVELOPMENT AND MANAGEMENT PLATFORM”, filed on Nov. 9, 2017 and accorded application Ser. No. 15/807,869, which claims priority to U.S. Provisional Patent Application, filed on Nov. 9, 2016 and accorded Application No.: 62/419,772, which are incorporated herein by reference.

application Ser. No. 18/428,305 claims priority to and is a continuation-in-part of U.S. patent application, titled “METHOD OF ENHANCING CUSTOMER RELATIONSHIP MANAGEMENT CONTENT AND WORKFLOW”, filed on Feb. 27, 2023 and accorded application Ser. No. 18/114,657, which claims priority to and is a continuation of U.S. patent application, titled “METHOD OF ENHANCING CUSTOMER RELATIONSHIP MANAGEMENT CONTENT AND WORKFLOW”, filed on Dec. 14, 2020 and accorded application Ser. No. 17/121,300, which claims priority to and is a divisional application of U.S. patent application, titled “METHOD OF ENHANCING CUSTOMER RELATIONSHIP MANAGEMENT CONTENT AND WORKFLOW”, filed on Sep. 15, 2015 and accorded application Ser. No. 14/854,591, which claims priority to U.S. Provisional Patent Application, filed on Sep. 15, 2014 and accorded Application No.: 62/050,548, which are incorporated herein by reference.

### BACKGROUND

Businesses are required to undertake complex and time-consuming tasks to obtain relevant information for one activity from the others, such as forming queries, using complicated APIs, or otherwise extracting data from separate databases, networks, or other information technology systems (some on premises and others in the cloud), transforming data from one native format to another suitable form for use in a different environment, synchronizing different data sources when changes are made in different databases, normalizing data, cleansing data.

### SUMMARY

The present disclosure is directed to various ways of improving the functioning of computer systems, information networks, data stores, search engine systems and methods, and other advantages. As stated above, more personalized, context-dependent search engine operations are departing from traditional absolute metrics for ranking search results. Instead, search results may be further dependent on the identity, demographic, location and online history of a person making a search query. More sophisticated search engine systems and methods are required to give an advantage to a promoter or marketer in such a search environment so as to push the marketer or promoter's subject matter to the top of the search engine rankings.

Among other features and advantages, the present system and method can benefit from large scale analysis of online content (e.g., Web pages) and vast amounts of information kept and processed from prior searches to develop intelligent associations between various content with one another. Some aspects employ machine learning systems and methods to further enhance the present goals including assisting users to develop successful content strategy for online content generation. Other aspects employ novel arrangements of data in data stores to extract best associations and deliver greater search engine rankings to users in an increasingly context-based or personalized type of searching environment. In particular, this system and method can improve the architecture that guides promoters to understanding what online subject matter to direct their efforts at for maximum effect on the target marketplace.

In embodiments of the present disclosure, a platform is provided for enabling automated development of content, typically for an enterprise, that is adapted to support a variety of enterprise functions, including marketing strategy and communications, website development, search engine optimization, sales force management, electronic commerce, social networking, and others. Among other benefits, the content development platform uses a range of automated processes to extract and analyze existing online content of an enterprise, parse and analyze the content, and develop a cluster of additional content that is highly relevant to the enterprise, without reliance on conventional keyword-based techniques.

In embodiments, the platform integrates functions of a content management system (CMS) with functions of a customer relationship management (CRM) system, including sharing access to database records and other information typically stored in and/or accessed by either.

A platform is provided for generating a cluster of correlated content from a primary online content object, the methods and systems including an automated crawler for crawling the primary online content object and storing a set of results from the crawling in a data storage facility; a parser for parsing the stored content from the crawling to generate a plurality of key phrases and to generate a content corpus from the primary online content object; a plurality of models for processing at least one of the key phrases and the corpus, the models comprising at least two of a word2vec model, a doc2vec model, a latent semantic analysis (LSA) extraction model, and a key phrase logistic regression model, wherein the processing results in a plurality of content clusters representing topics within the primary online content object; a content cluster data store for storing the content clusters; and a suggestion generator for generating, using output from at least one of the models, a suggested topic that is similar to at least one topic among the content clusters and for storing the suggested topic and information regarding the similarity of the suggested topic to at least one content cluster in the content cluster data store.

In embodiments, the plurality of models used by the platform may comprise at least one of a word2vec model, a doc2vec model, a latent semantic analysis extraction model, a latent semantic indexing model, a principle component analysis model, and a key phrase logistic regression model. In embodiments, the parser uses a machine learning system to parse the crawled content. In embodiments, the machine learning system iteratively applies a set of weights to input data, wherein the weights are adjusted based on a parameter of success, wherein the parameter of success is based on the success of suggested topics in the online presence of an enterprise. In embodiments, the machine learning system is provided with a training data set that is created based on human analysis of the crawled content.

In embodiments, a model is used in the platform uses a machine learning system to cluster content. In embodiments, the machine learning system iteratively applies a set of weights to input data, wherein the weights are adjusted based on a parameter of success, wherein the parameter of success is based on the success of suggested topics in the online presence of an enterprise. In embodiments, the machine learning system is provided with a training data set that is created based on human clustering of a set of content topics.

In embodiments, the suggestion generator uses machine learning to suggest topics. In embodiments, the machine learning system iteratively applies a set of weights to input data, wherein the weights are adjusted based on a parameter of success, wherein the parameter of success is based on the success of suggested topics in the online presence of an enterprise. In embodiments, the machine learning system is provided with a training data set that is created based on human creation of a set of suggested topics.

In embodiments, the methods and systems disclosed herein may further include an application for developing a strategy for development of online presence content, the application accessing the content cluster data store and having a set of tools for exploring and selecting suggested topics for online presence content generation. In embodiments, the application provides a list of topics that are of highest semantic relevance for an enterprise based on the parsing of the primary online content object. In embodiments, the methods and systems may further include a user interface of the application for presenting a suggestion, wherein the generated suggestion is presented with an indicator of the similarity of the suggested topic to a content cluster topic as calculated by at least one of the models. In embodiments, the methods and systems may further include a user interface of the application for presenting a suggested topic, wherein the user interface facilitates generation of content related to the suggested topic. In embodiments, the user interface includes at least one of key words and key phrases that represent the suggested topic. In embodiments, the at least one of key words and key phrases are used to prompt the user with content for generation of online presence content. In embodiments, the online presence content is at least one of website content, mobile application content, a social media post, a customer chat, a frequently asked question item, a product description, a service description and a marketing message. In embodiments, the user interface for generation of content includes a plurality of suggested topics, each associated with an indicator of the similarity of a given suggested topic to a content cluster topic as calculated by at least one of the models.

In embodiments, the data storage facility is a cloud-based storage facility. In embodiments, the data storage facility is a distributed data storage facility. In embodiments, the primary online content is a web page of an enterprise. In embodiments, the primary online content is a social media page of an enterprise.

In embodiments, the methods and systems may further include an application for developing a strategy for development of online presence content, the application accessing the content cluster data store and having a set of tools for exploring and selecting suggested topics for online presence content generation, wherein the application further accesses the content of a customer relationship management system. In embodiments, the application includes a user interface for developing content regarding a suggested topic for presentation in a communication to a customer, wherein selection of a suggested topic for presentation to a customer is based at least in part on a semantic relationship between the suggested topic as determined by at least one of the models and at least one data record relating to the customer stored in the customer relationship management system.

Also provided herein are methods and systems for automated discovery of topics for interactions with customers of an enterprise, including methods and systems that assist various functions and roles within an enterprise in finding appropriate topics to draw customers into relevant conversations and to extend the conversations in a way that is relevant to the enterprise and to each customer. Automated discovery of relevant content topics may support processes and workflows that require insight into what topics should be written about, such as during conversations with customers. Such processes and workflows may include development of content by human workers, as well as automated generation of content, such as within automated conversational agents, bots, and the like. Automated discovery may include identifying concepts that are related by using a combination of analysis of a relevant item of text (such as core content of a website, or the content of an ongoing conversation) with an analysis of linking (such as linking of related content). In embodiments, this may be performed with awareness at a broad scale of the nature of content on the Internet, such that new, related topics can be automatically discovered that further differentiate an enterprise, while remaining relevant to its primary content. The new topics can be used within a wide range of enterprise functions, such as marketing, sales, services, public relations, investor relations and other functions, including functions that involve the entire lifecycle of the engagement of a customer with an enterprise.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosures and the following detailed description of certain embodiments thereof may be understood by reference to the following figures:

FIGS. 1A-1E are block diagrams illustrating examples of computing environment wherein one or more of the provisions set forth herein may be implemented.

FIG. 1F is a flow chart illustrating an example of a set of operations for performing one or more of the provisions set forth herein.

FIGS. 2A-2F are block diagrams illustrating examples of computing environment wherein one or more of the provisions set forth herein may be implemented.

FIG. 2G is a flow chart illustrating an example of a set of operations for performing one or more of the provisions set forth herein.

FIG. 2H is a flow chart illustrating an example of a set of operations for performing one or more of the provisions set forth herein.

FIG. 2I is a block diagram illustrating an example of a computing environment wherein one or more of the provisions set forth herein may be implemented.

FIG. 2J is a flow chart illustrating an example of a set of operations for performing one or more of the provisions set forth herein.

FIGS. 3-5 are block diagrams illustrating examples of computing environment wherein one or more of the provisions set forth herein may be implemented.

FIG. 6 is a flow chart illustrating an example of a set of operations for performing one or more of the provisions set forth herein.

FIGS. 7-9 are block diagrams illustrating examples of computing environment wherein one or more of the provisions set forth herein may be implemented.

FIG. 10 is a flow chart illustrating an example of a set of operations for performing one or more of the provisions set forth herein.

FIGS. 11-15 are block diagrams illustrating examples of computing environment wherein one or more of the provisions set forth herein may be implemented.

FIG. 16 is a flow chart illustrating an example of a set of operations for performing one or more of the provisions set forth herein.

FIGS. 17-19 are block diagrams illustrating examples of computing environment wherein one or more of the provisions set forth herein may be implemented.

FIG. 20 is a flow chart illustrating an example of a set of operations for performing one or more of the provisions set forth herein.

FIG. 21 is a flow chart illustrating an example of a set of operations for performing one or more of the provisions set forth herein.

FIG. 22 is a block diagram illustrating an example of a computing environment wherein one or more of the provisions set forth herein may be implemented.

FIGS. 23A and 23B are flow charts illustrating example of sets of operations for performing one or more of the provisions set forth herein.

FIGS. 24A-26 are block diagrams illustrating examples of computing environment wherein one or more of the provisions set forth herein may be implemented.

FIGS. 27-30 are flow charts illustrating example of sets of operations for performing one or more of the provisions set forth herein.

FIGS. 31-35 are block diagrams illustrating examples of computing environment wherein one or more of the provisions set forth herein may be implemented.

FIG. 36 is a flow chart illustrating an example of a set of operations for performing one or more of the provisions set forth herein.

FIGS. 37-39 are block diagrams illustrating examples of computing environment wherein one or more of the provisions set forth herein may be implemented.

FIG. 40 is an example of a computer readable medium in which an embodiment of the present technology may be implemented.

FIG. 41 illustrates an exemplary computing environment wherein one or more of the provisions set forth herein may be implemented.

### DETAILED DESCRIPTION

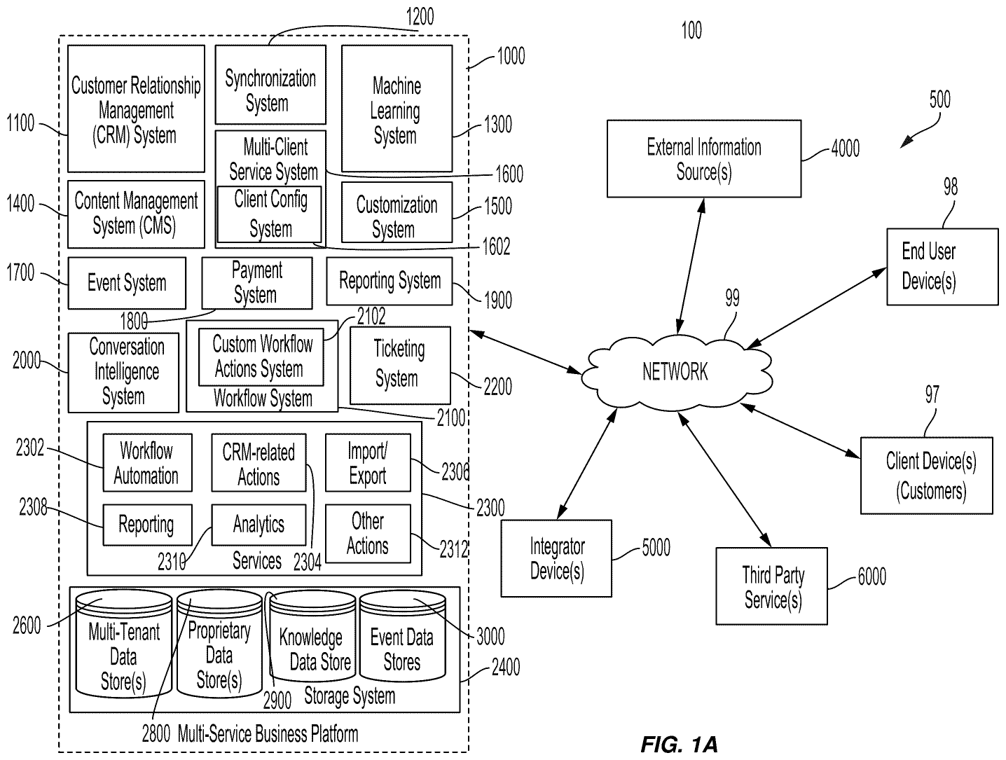

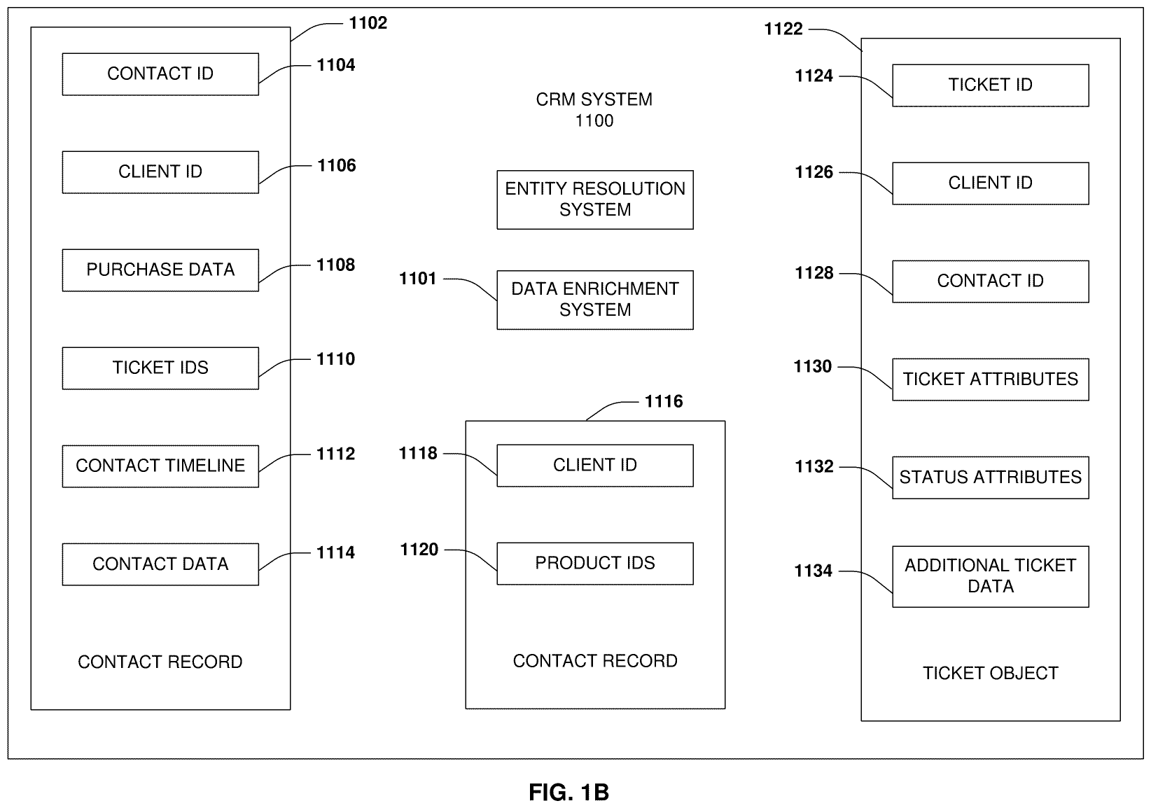

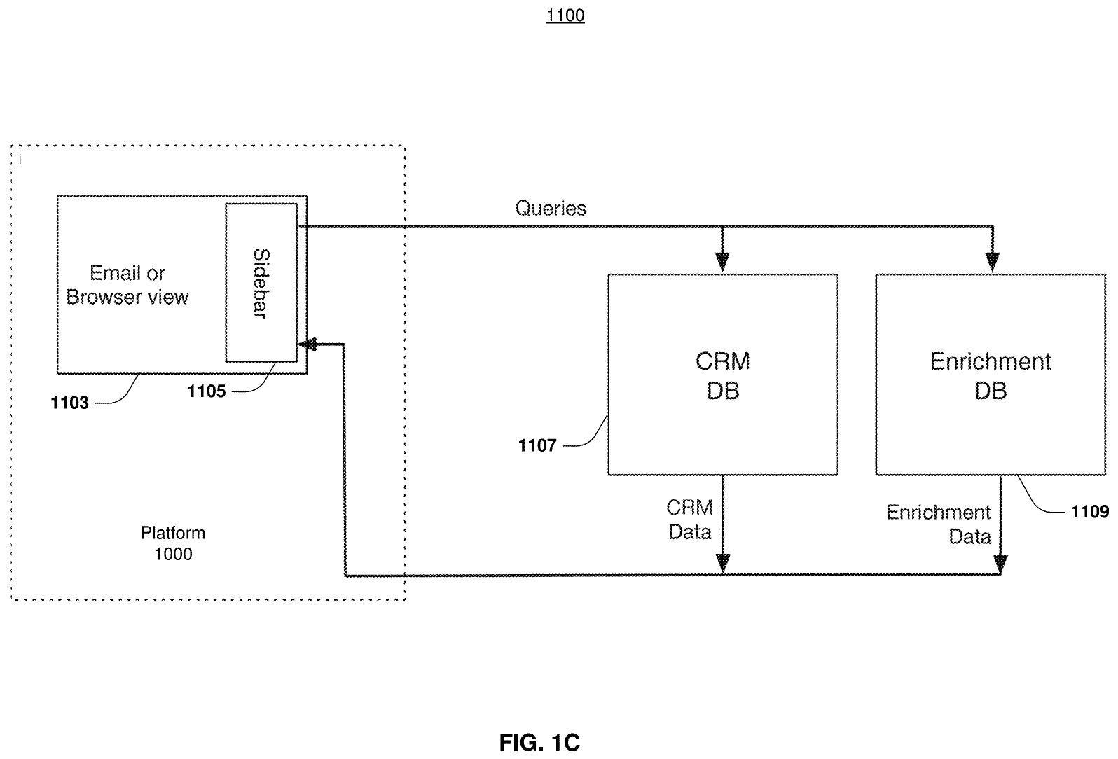

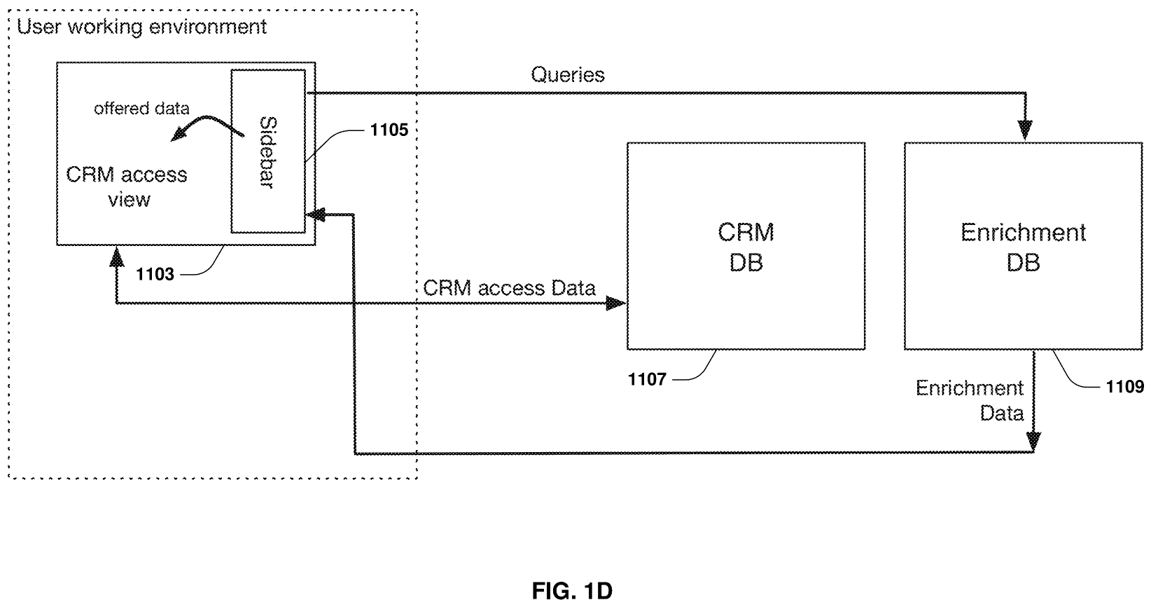

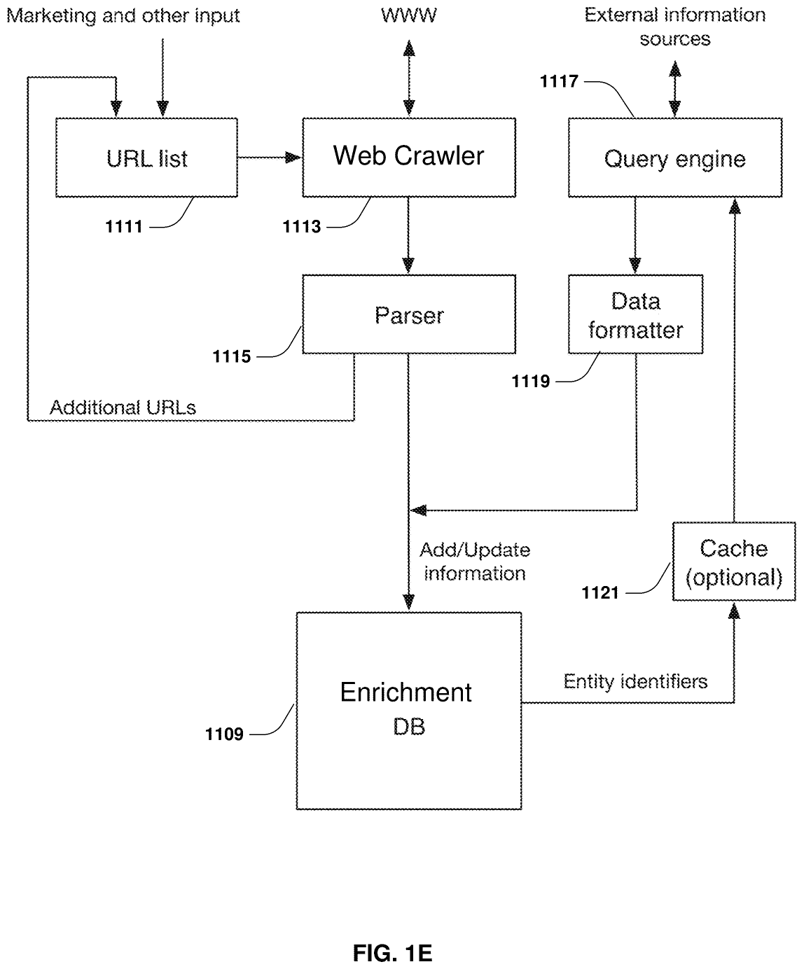

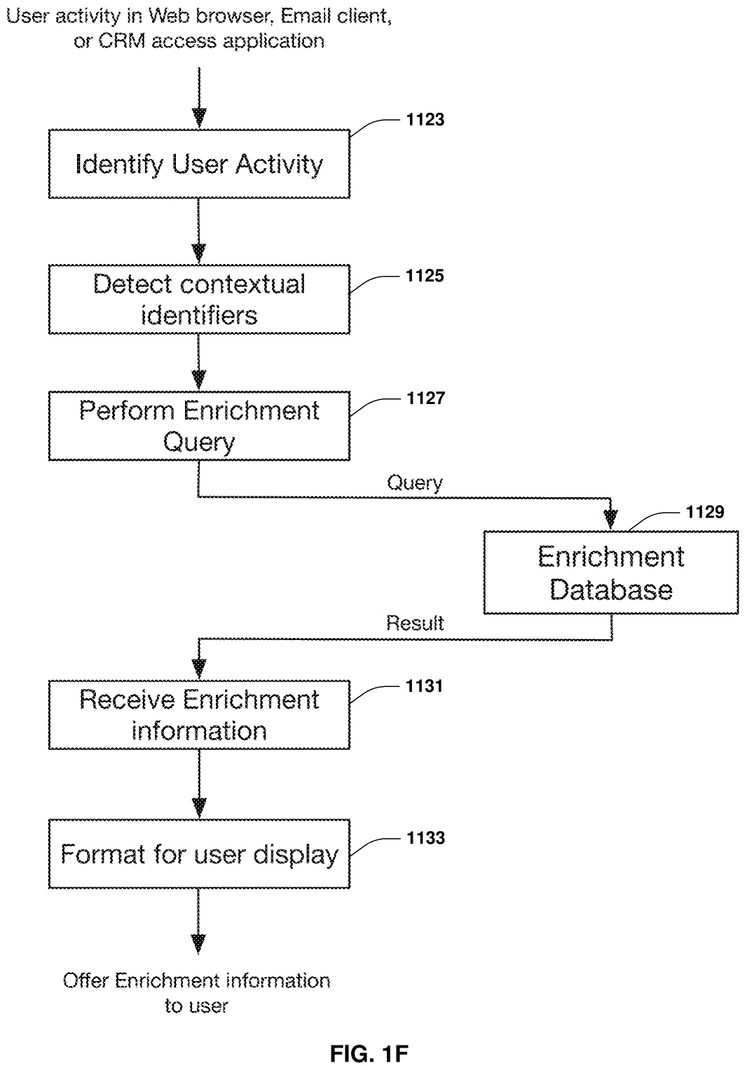

FIG. 1 illustrates an example environment 100 including a multi-service business platform 1000 (referred to herein also as multi-tenant distributed system or multi-function business platform (“platform”) or framework system. The platform 1000 may communicate with various systems, devices, and data sources. The platform 1000 may serve the needs of multiple clients who in turn use the system to provide services, support, and the like for their customers or end users. The platform 1000 includes a Customer Relationship Management (CRM) System 1100, a synchronization system 1200, an Artificial Intelligence (AI)/Machine Learning (ML) system (“AI/ML system”) 1300, a content management system (CMS) 1400, a customization system 1500, a multi-client servicing system 1600, an event system 1102, a payment system 1800, a reporting system 1600, a conversational intelligence system 2000, a workflow system 2100 having a custom workflow actions system 2102, an entity resolution system 2200, a services module 2300 and a storage system 2400. The services module 2300 includes a workflow automation service 2302, a CRM related action service 2304, an import/export service 2306, a reporting service 2308, an analytics service 2310 and other services 2312. Other services 2312 may include, for example, filtering used to search, filter, and list objects (e.g., contact objects) that may be used with other objects and/or create lists for other types of objects. In some examples, other services 2312 may include reporting, permissioning, auditing, user-defined calculations, and aggregations.

The storage system 2400 includes one or more multi-tenant data stores 2600, one or more proprietary data stores 2800, one or more knowledge graph data structures 2900 and one or more event data stores 3000. Custom objects and/or core objects may include information that may be stored in the multi-tenant data stores 2600 of the storage system 2400. The custom objects and/or core objects as well as possible relationships (e.g., associations) between objects may be stored in an ontology of the knowledge data structure 2900. The platform 1000 may communicate with external systems and data sources via a communication network 99 (e.g., Internet, public network, private network, etc.). Specifically, the multi-service business platform 1000 may communicate with a user device(s) 98 who is using the one or more systems of the platform 1000 (e.g. CRM 1110, customization system) 1500 to reach their customers who are accessing the user side of the platform 1000 (content, ticketing system, etc.) via one or more user device(s) 98. The platform 1000 may allow the client 97 to track various activities of their customers (users 98) for purposes of sales and marketing (e.g. using custom objects).

The platform 1000 may refer to a computing system that provides customer service solutions for any number of different clients. As used herein, a client may refer to an organization (e.g., a business, a government agency, a non-profit, and the like) that engages in some form of commercial or service-related activity, whereby the platform 1000 may provide a customized or semi-customized customer service solution to service the customers of the client. In embodiments, the platform 1000 is a multi-tenant platform, such that the system serves the needs of multiple clients, who in turn use the system to provide service, support and the like to their own customers. As used herein, the term “service” should be understood to encompass, except where context indicates otherwise, any of a wide range of activities involved in providing services to customers and others, such as via various workflows of a business, including providing services for value, servicing goods, updating software, upgrading software, providing customer support, answering questions, providing instructions of use, issuing refunds or returns, and many others. As used herein, except where context indicates otherwise, a customer may refer to an entity or individual that engages with the client (e.g., a purchaser of a product or service of the client, a user of the client's software platform, and the like), and the term “customer” should be understood to encompass individuals at different stages of a relationship with a client, such as individuals/organizations who are being targeted with marketing and promotional efforts, prospects who are engaged in negotiations with sales people, customers who have purchased a product, and users of the product or service (such as individuals within a customer organization). Furthermore, as will be discussed in further detail, the term “contact” is used to describe organizational entities or individuals that do engage with, may engage with, or previously engaged with the client. For example, a “contact” may refer to a sales lead, a potential customer, a closed customer (e.g., purchaser, licensee, lessee, loan recipient, policy holder, or the like), and/or a previous customer (e.g., a purchaser that needs service or may review the organization). In this way, the platform 1600 may help track a contact through an entire contact lifecycle (e.g., from the time the contact first comes to the attention of the client as a lead (such as when the client opens a promotional email or clicks on a promotional offer) until the end of the lifecycle of the client's offering(s)). It should be noted that the term contact may refer to a customer, but also to individuals and organizations that may not qualify as “customers” or users of a client.

The platform 100 may also communicate with one or more external information sources 4000 that may include company information or data on customers, products, sales, third party data, resource description framework (RDF) site summary (RSS) feeds or really simple syndication (RSS) feeds, telemetrics (e.g., from email, websites, app usage), and the like with respect to custom objects. The platform 1000 may also communicate with third party service(s) 6000 (e.g., third party applications, websites, data lakes and warehouses, etc.) via network 99.

The platform 1000 may also communicate with integrator device(s) 5000. Integrator devices 5000 may refer to user devices 98 used by third-party integrator users that may create and may define a series of custom objects that may be integrated with other objects in the multi-service business platform 1000 and may be offered to users of the multi-service business platform 1000. The platform 1000 may include APIs (as described in the disclosure) that a user may use to define custom objects and integrate those custom objects into the CRM system 1100 and thereby into the platform 1000. These same APIs may be available to integrator users to do the same thing. The integrator users may define a series of custom objects, then the integrator users may define object definitions. When a client installs that integration into their instance of the platform 1000, the client may then start creating instances of custom objects defined by the integrators.

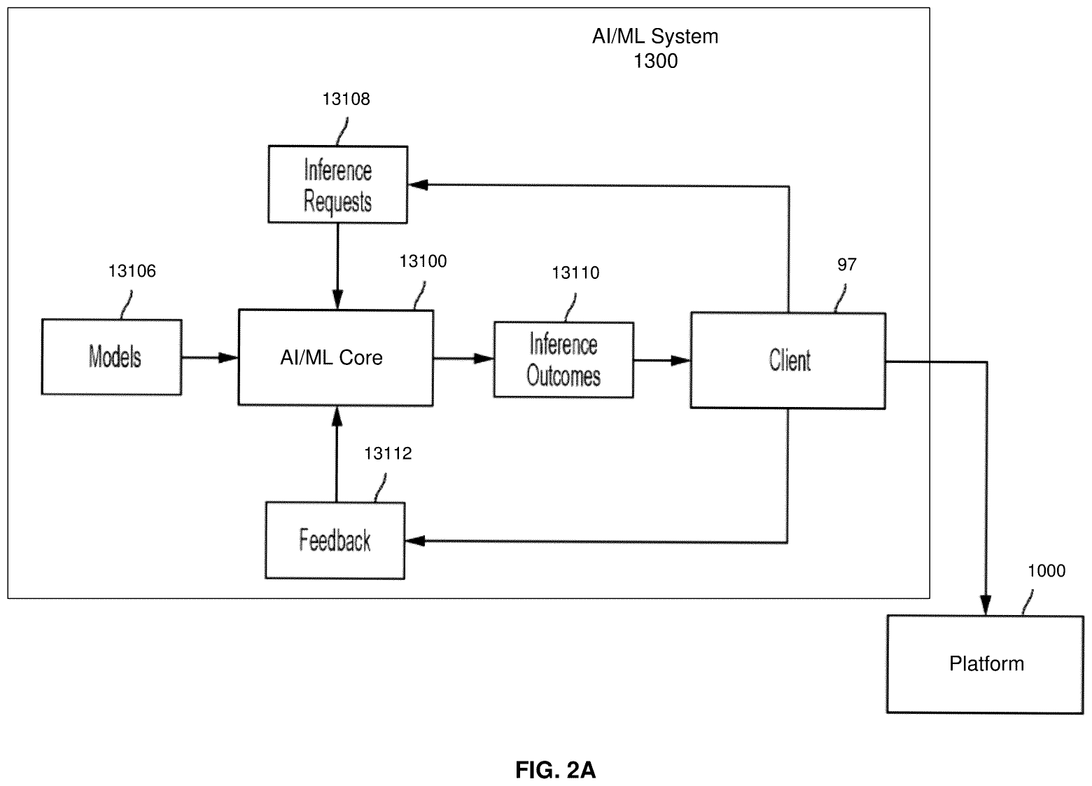

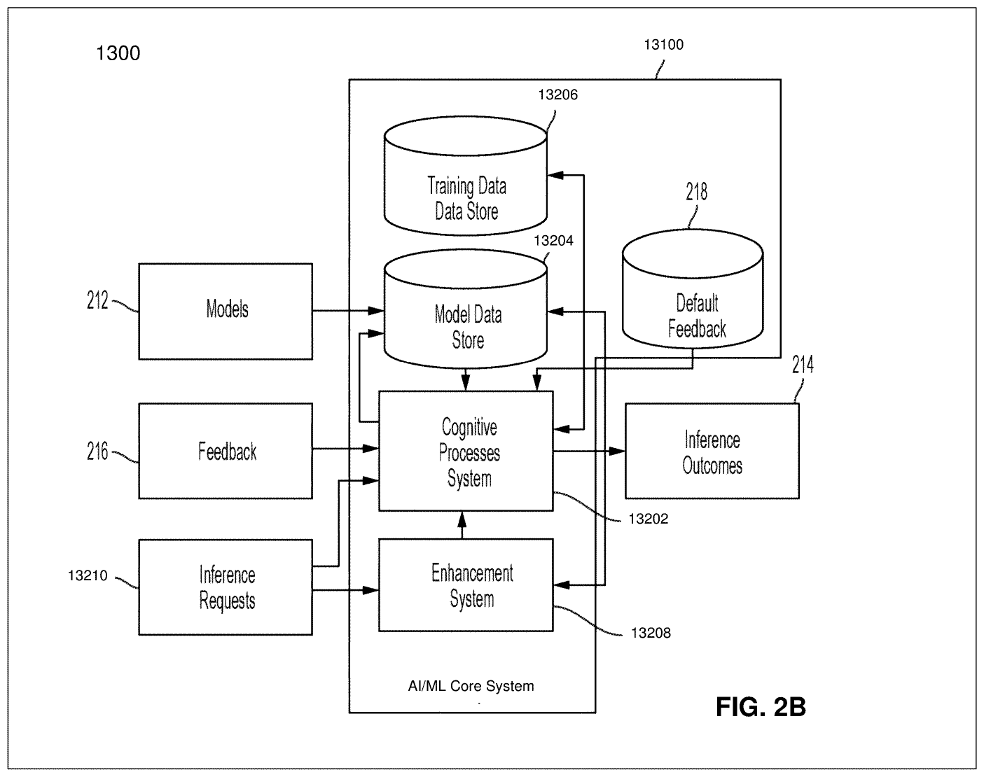

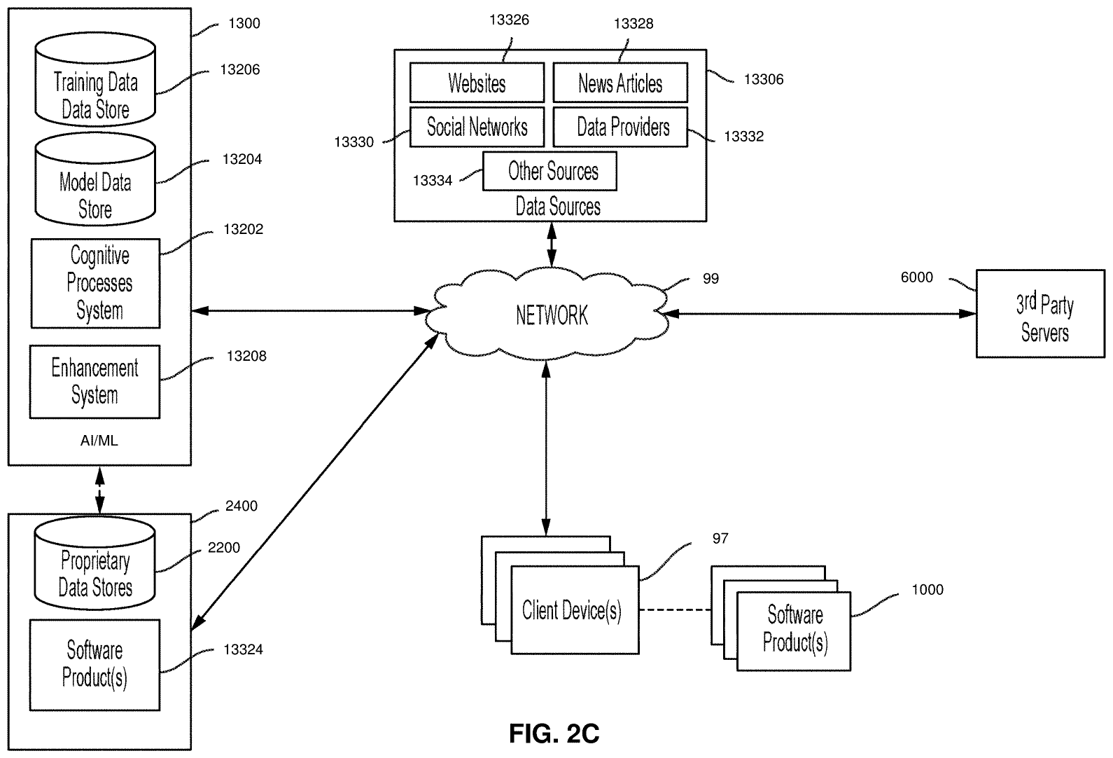

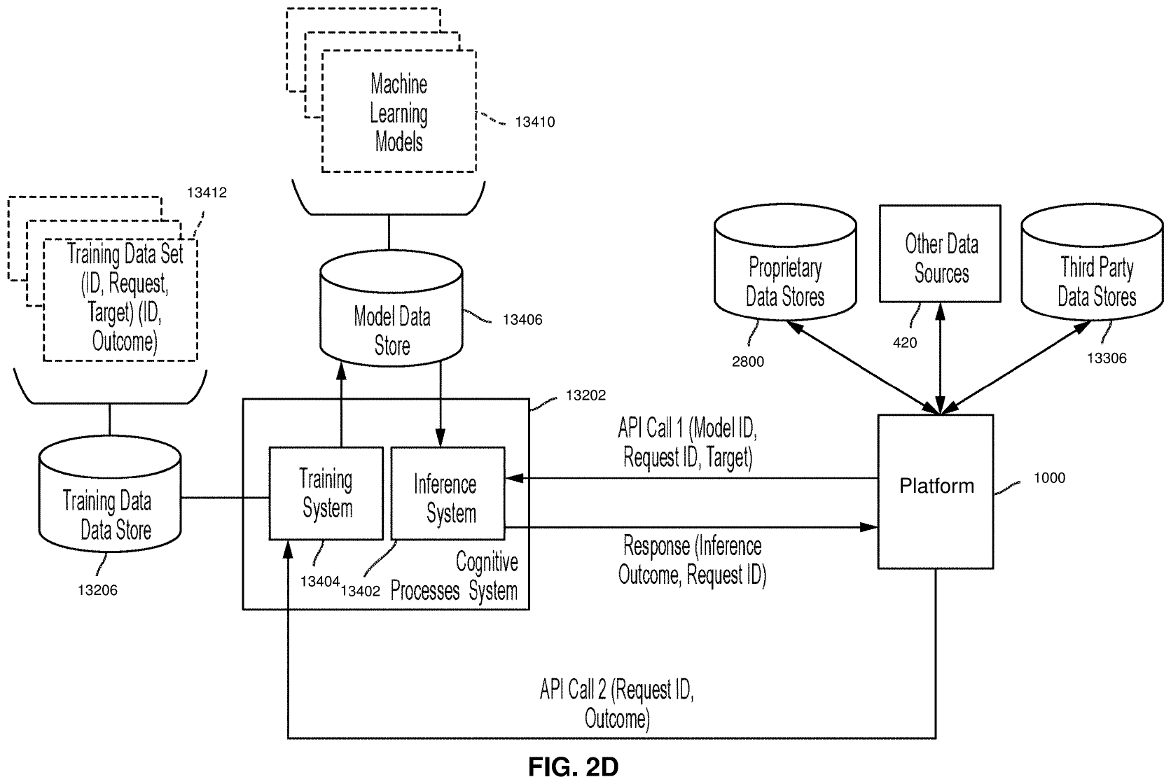

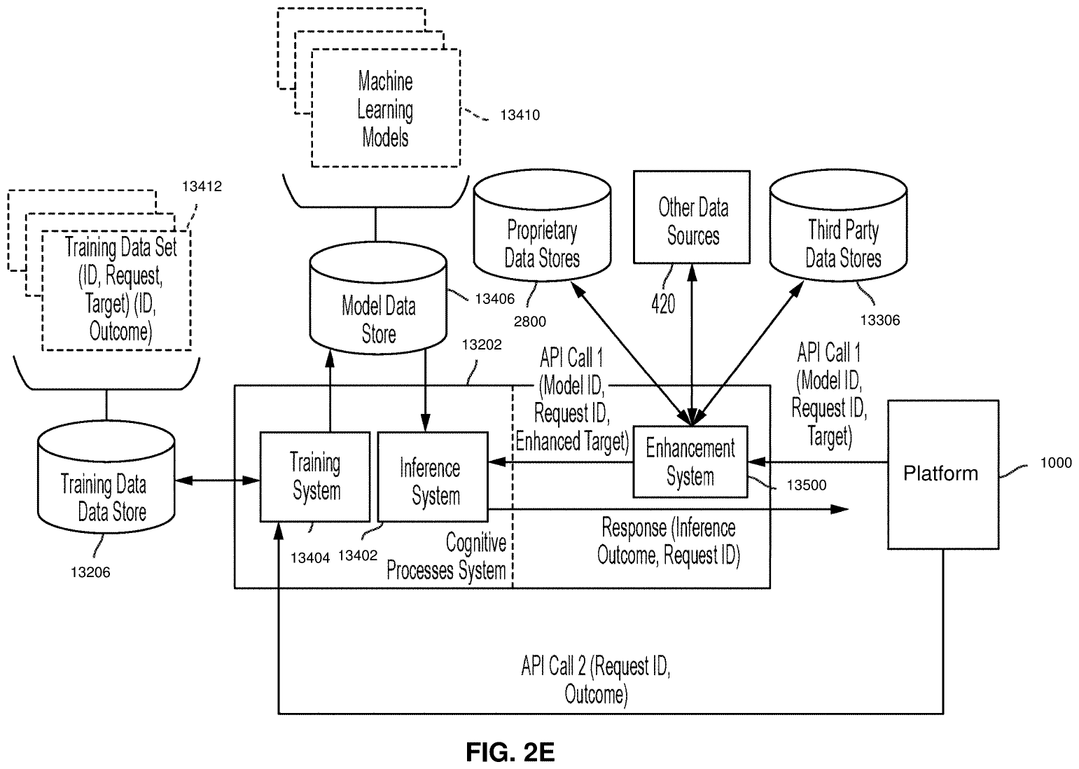

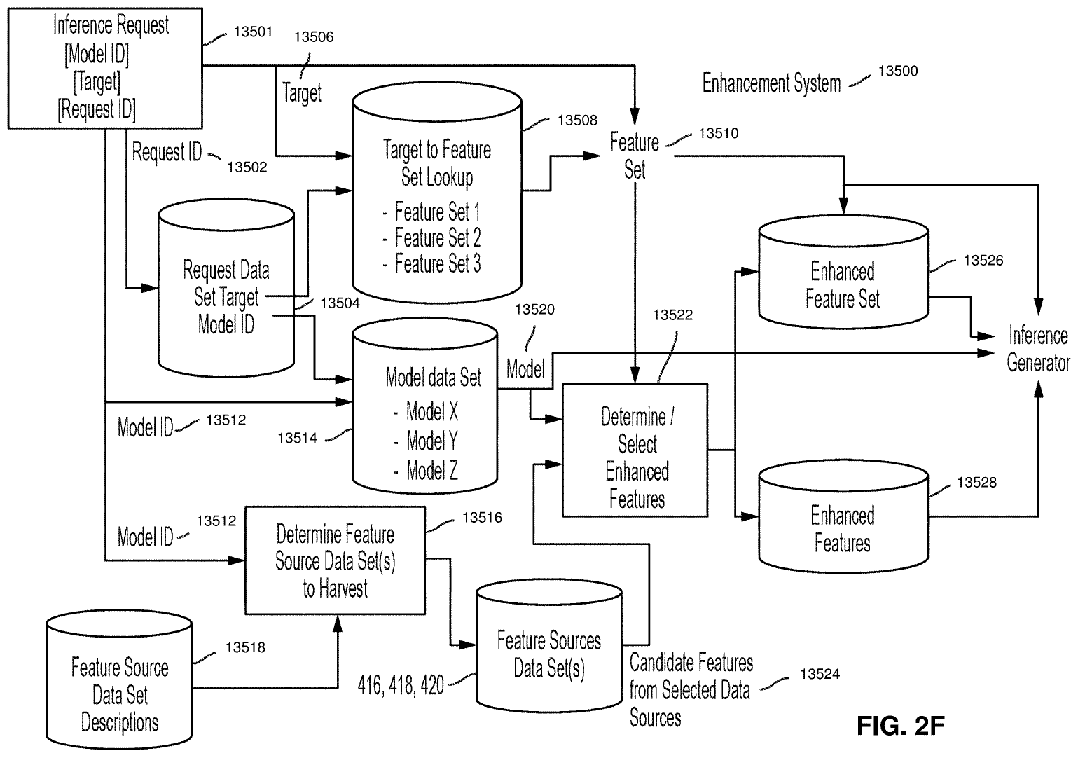

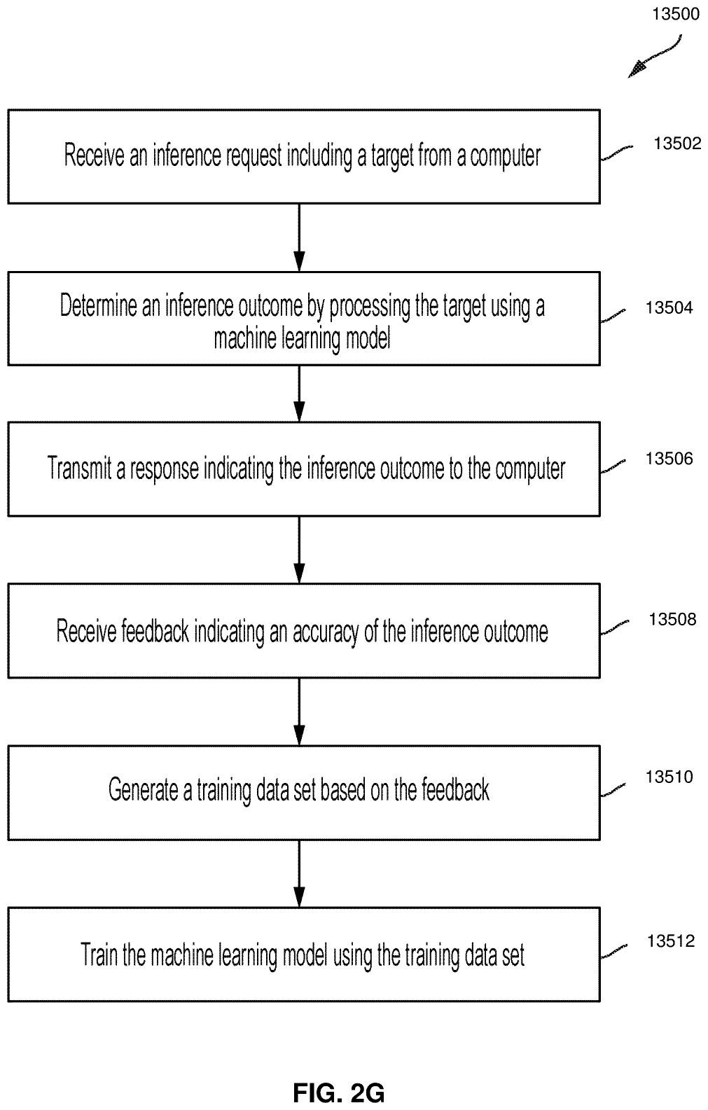

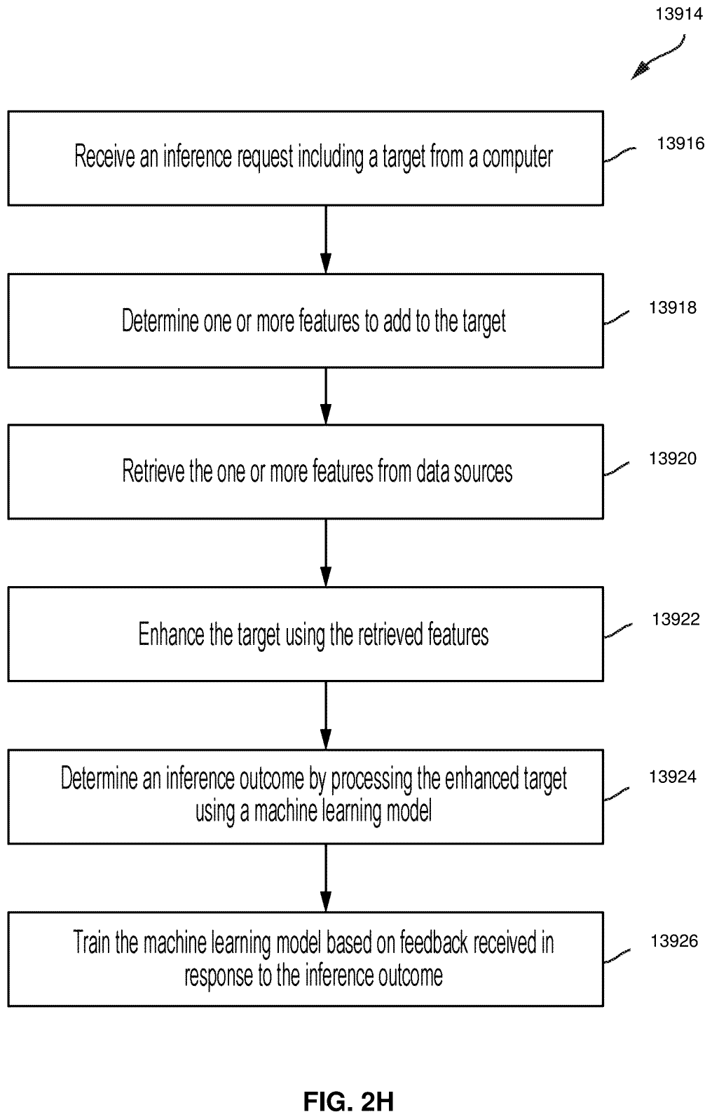

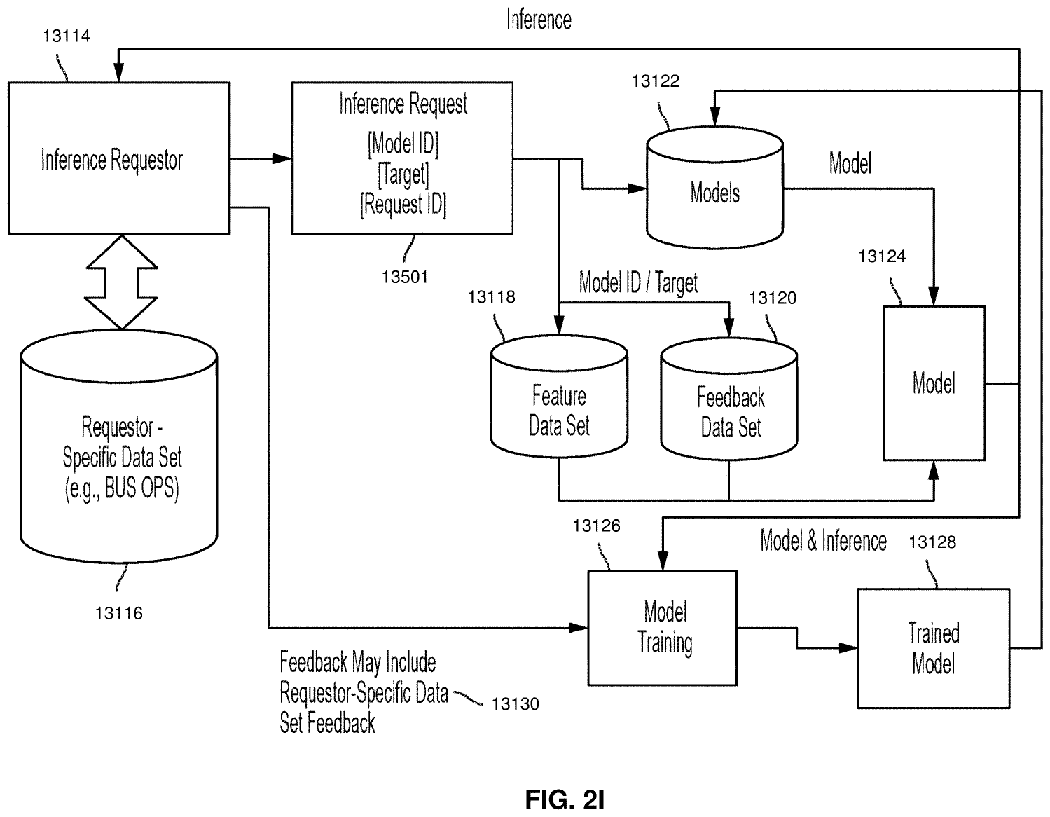

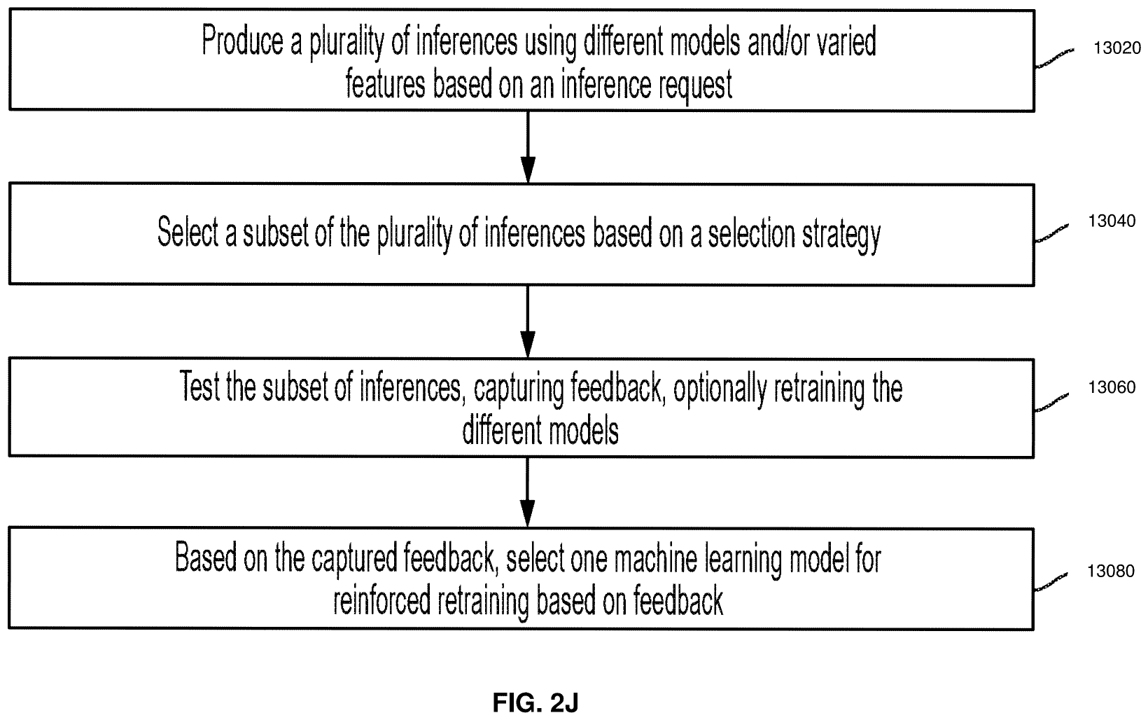

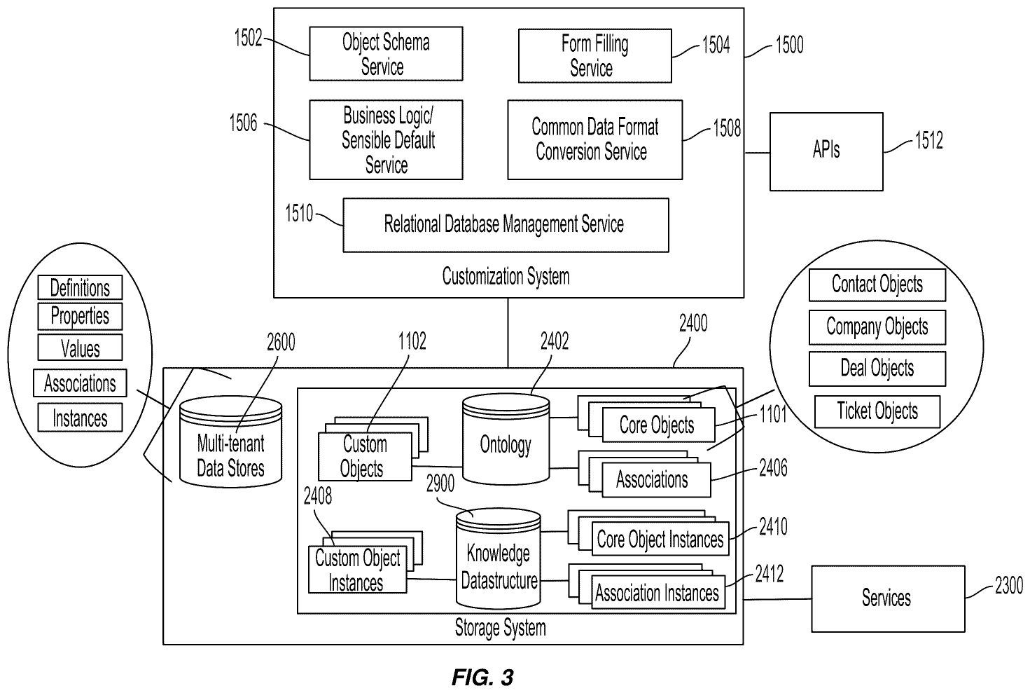

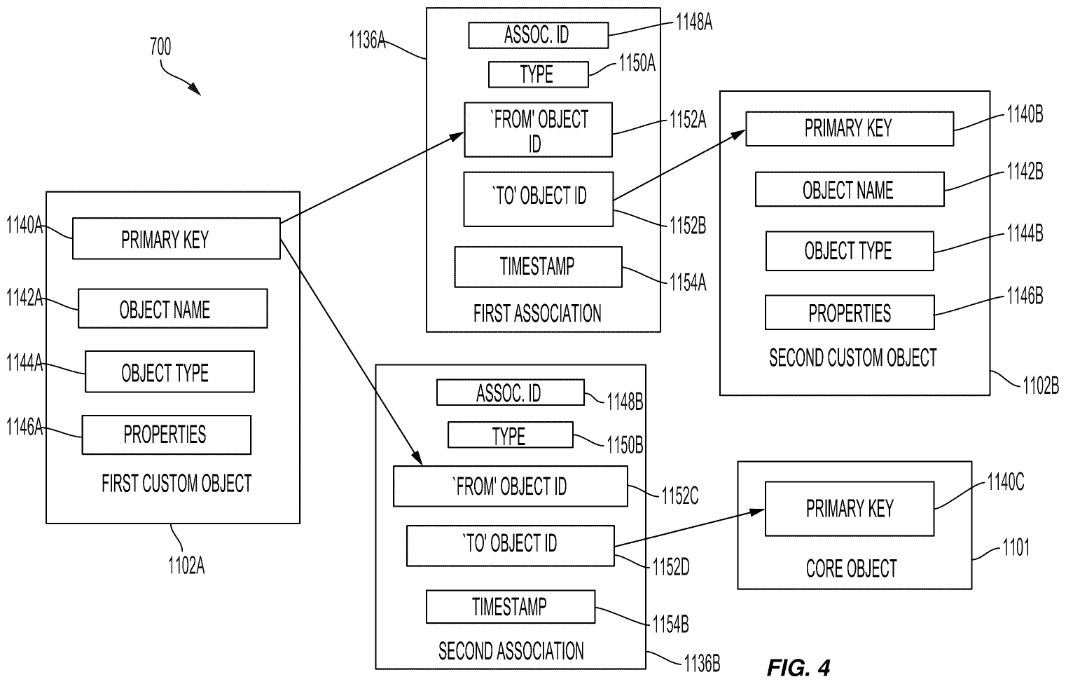

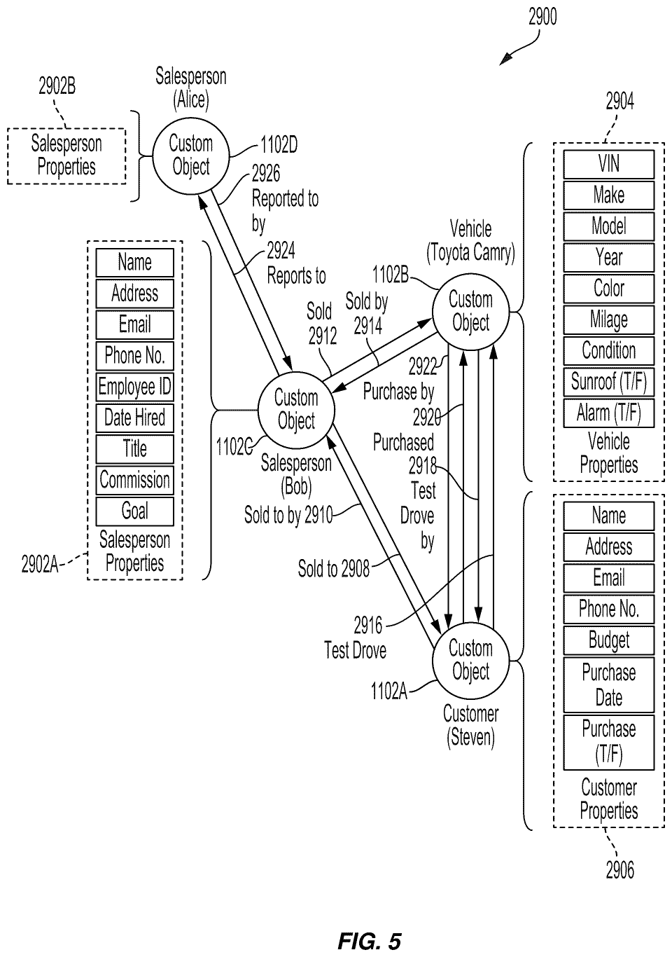

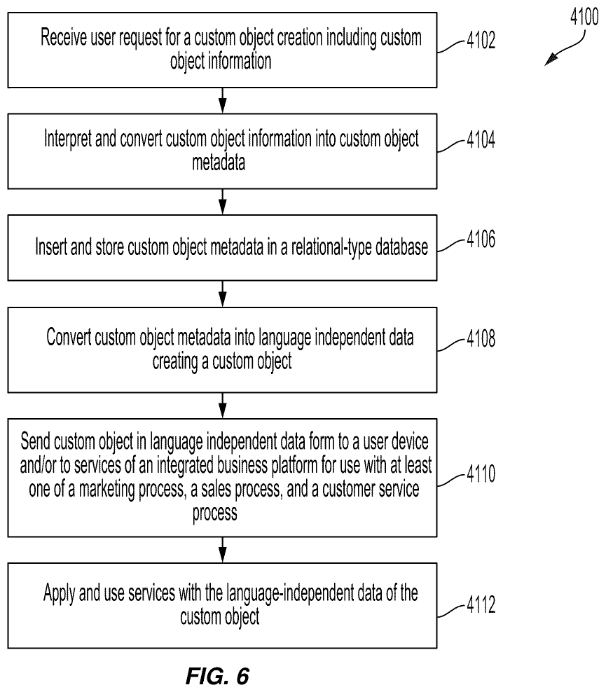

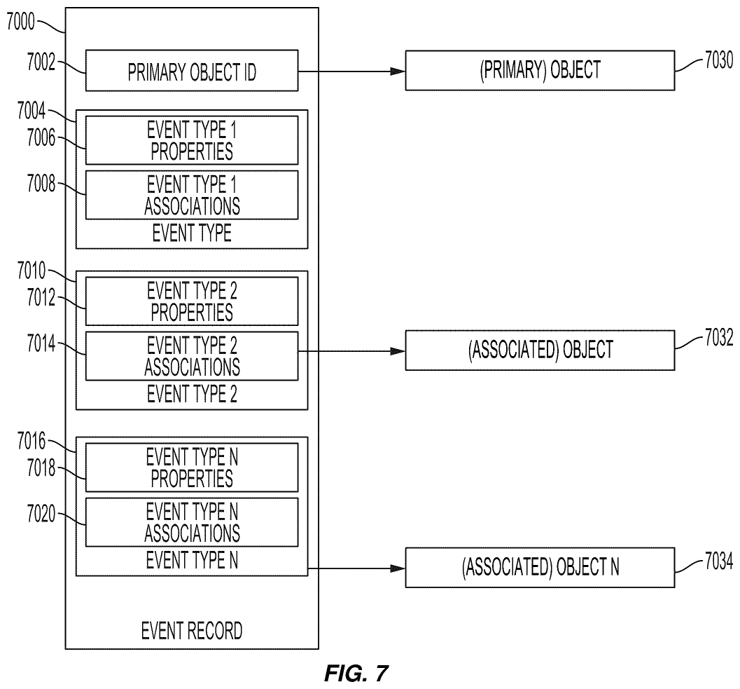

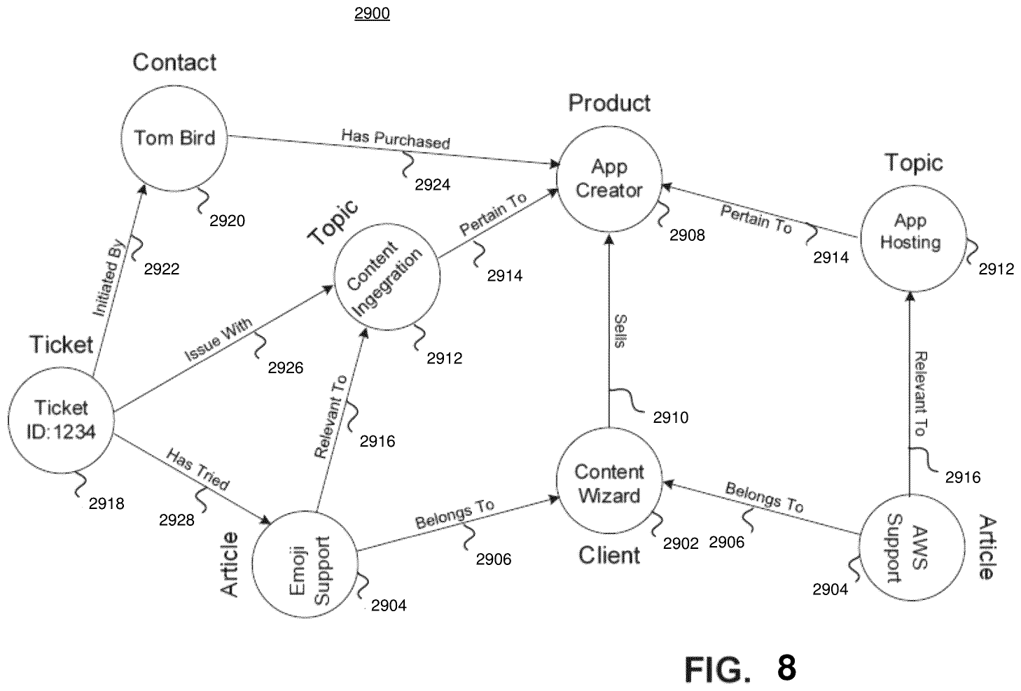

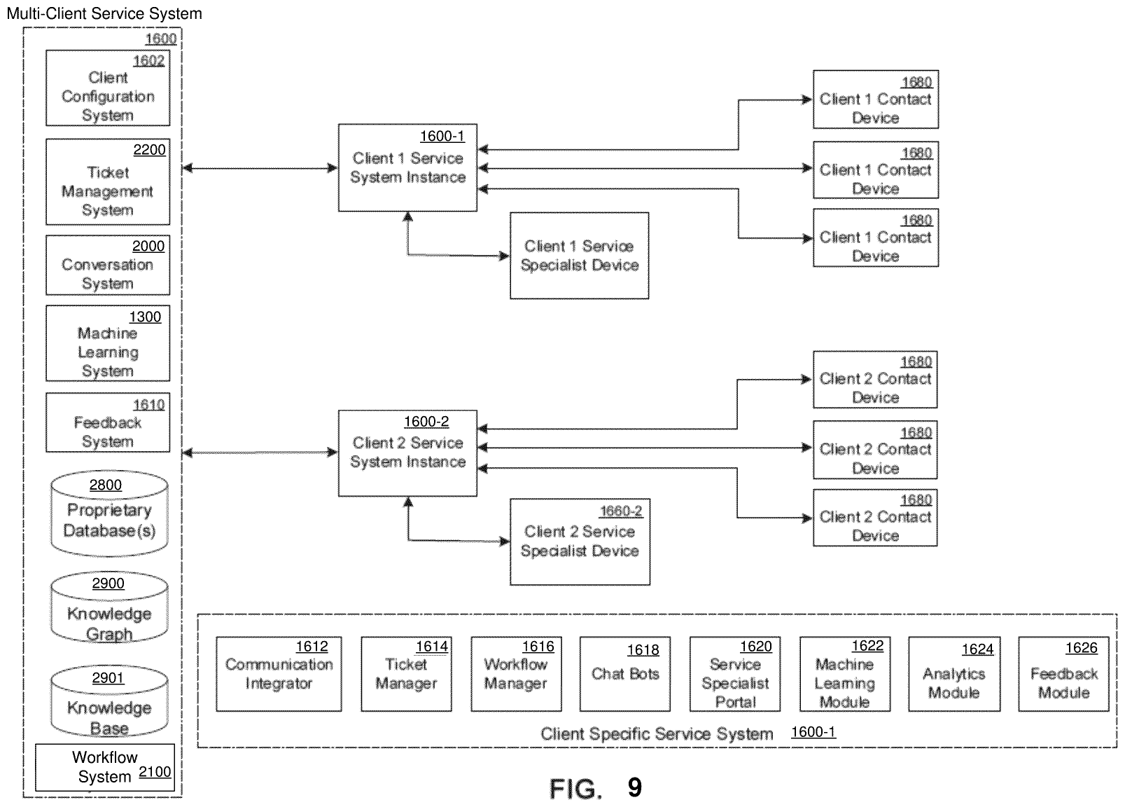

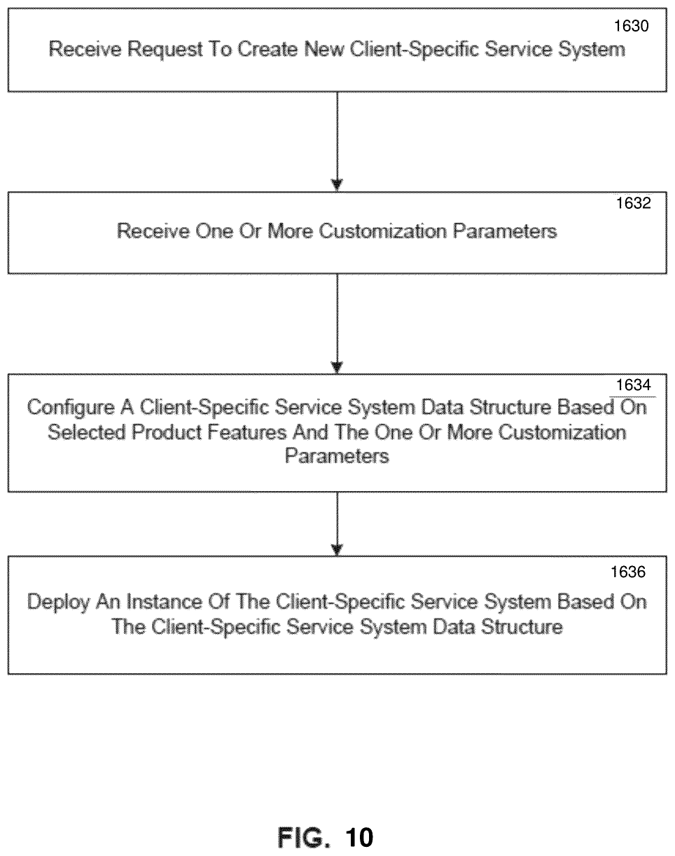

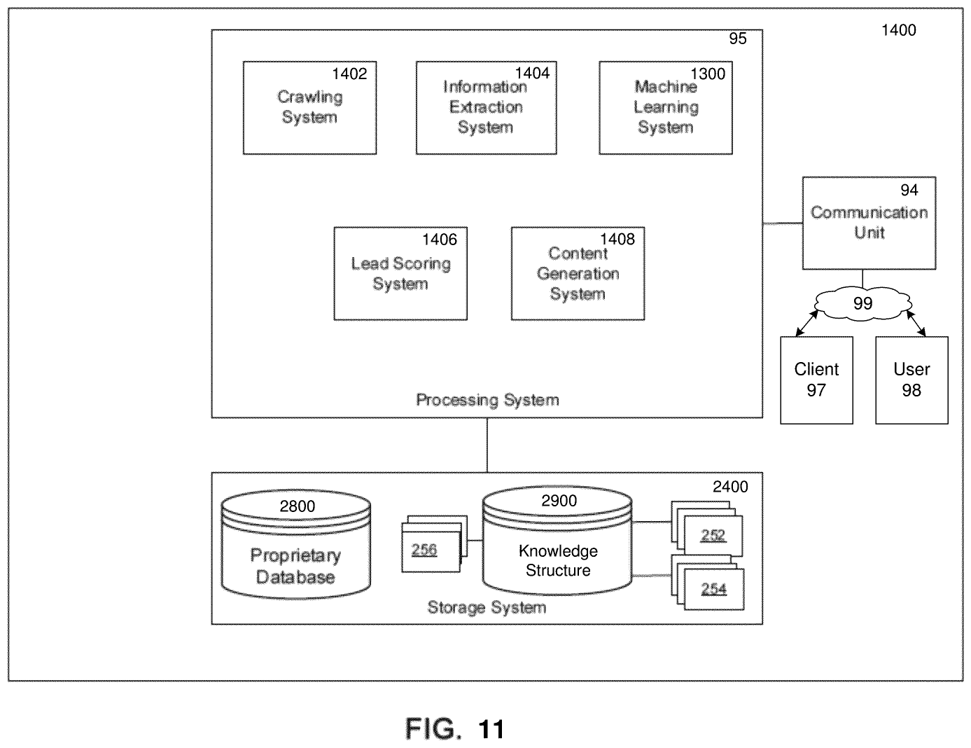

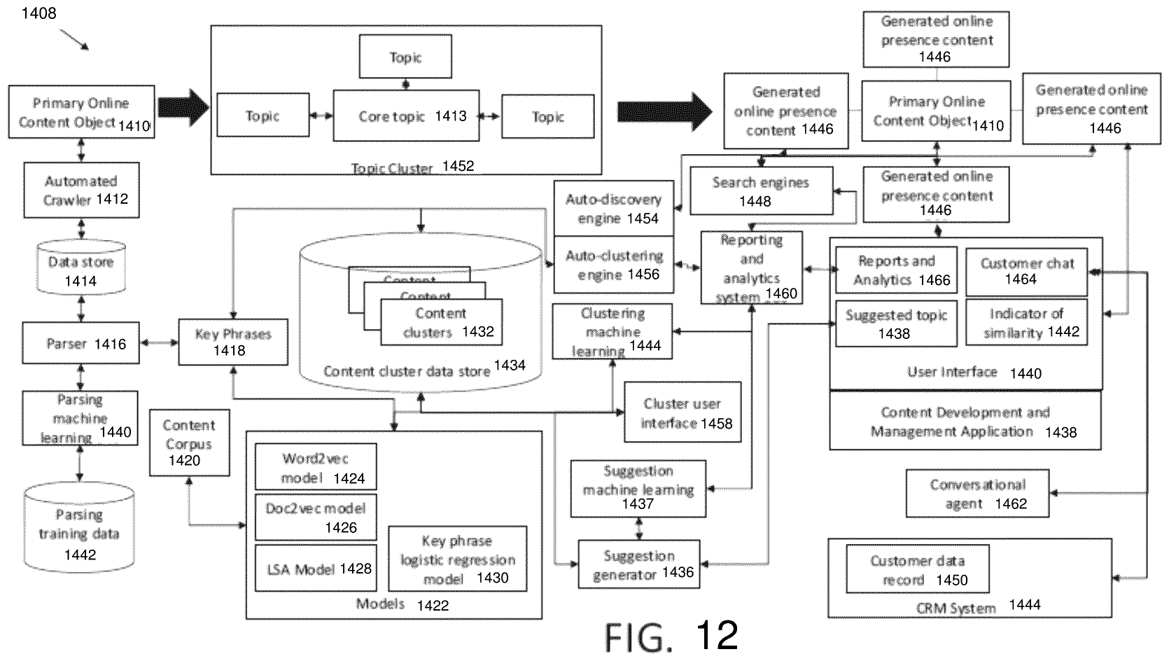

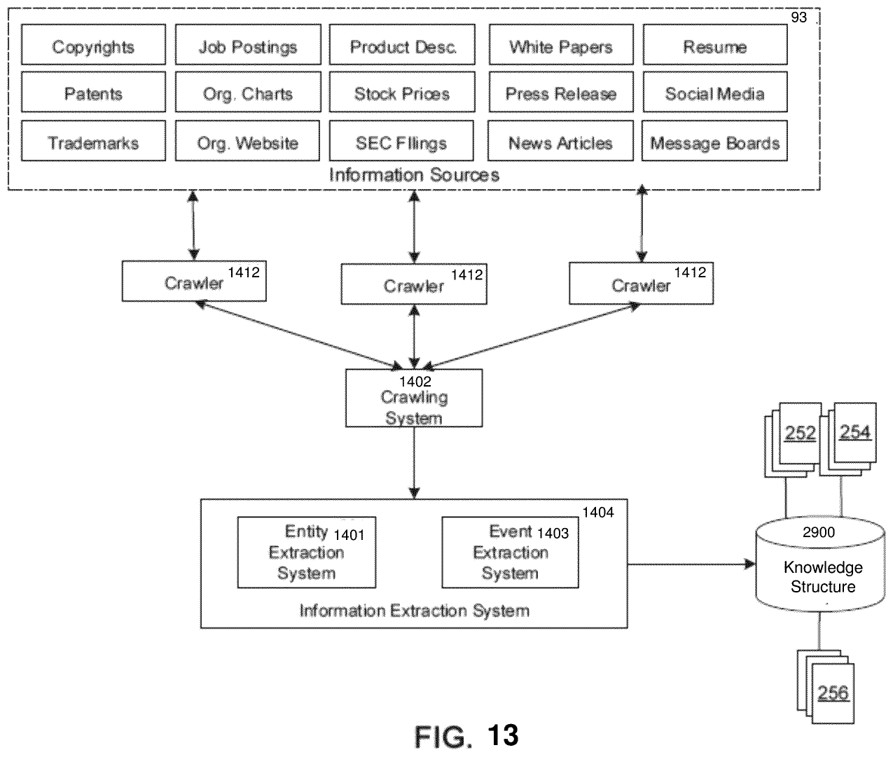

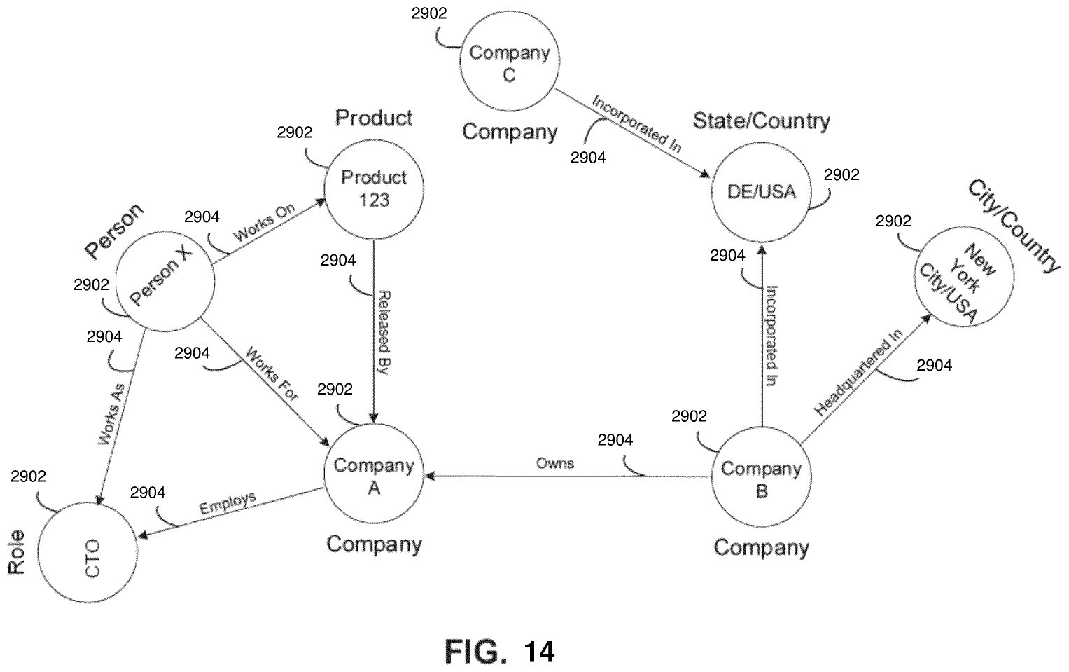

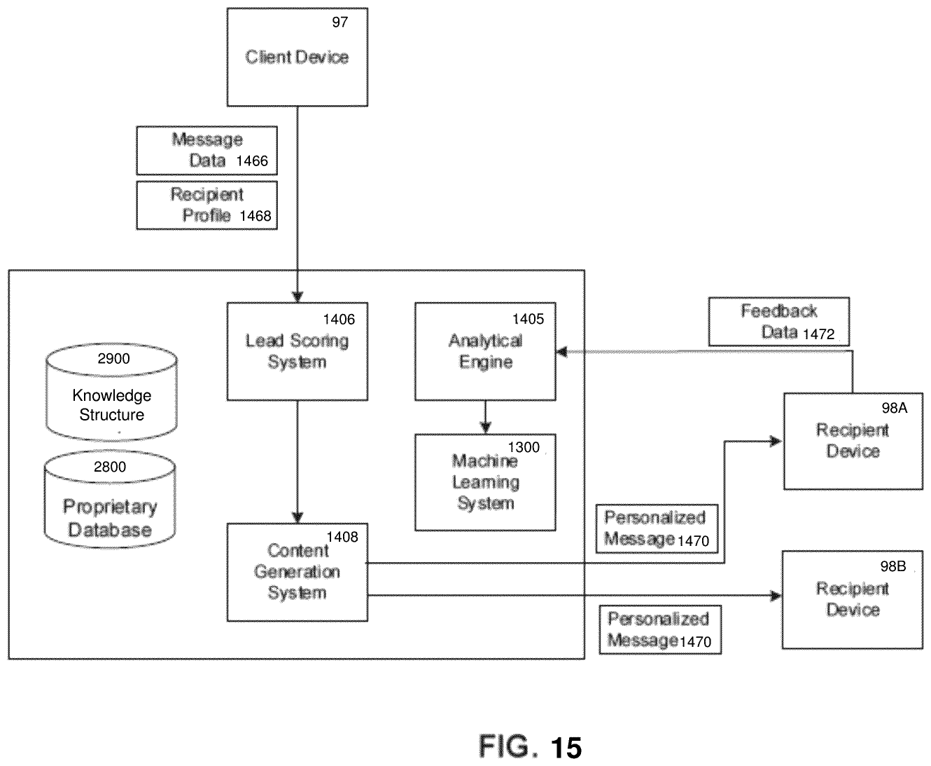

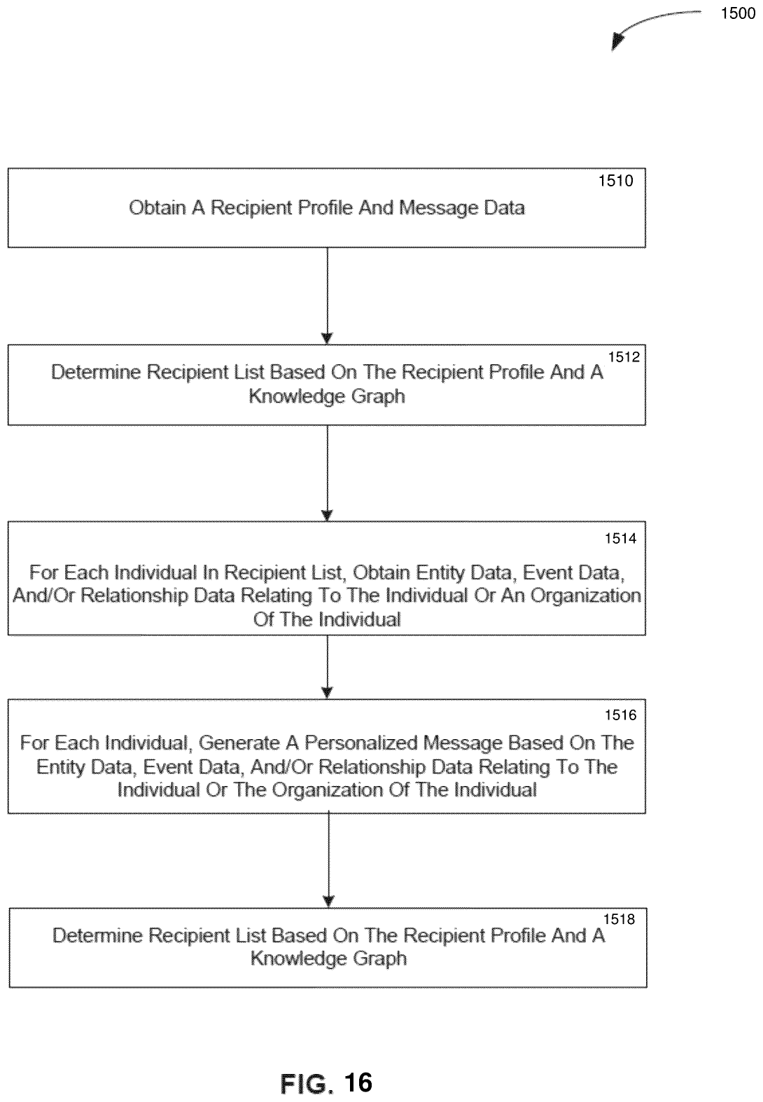

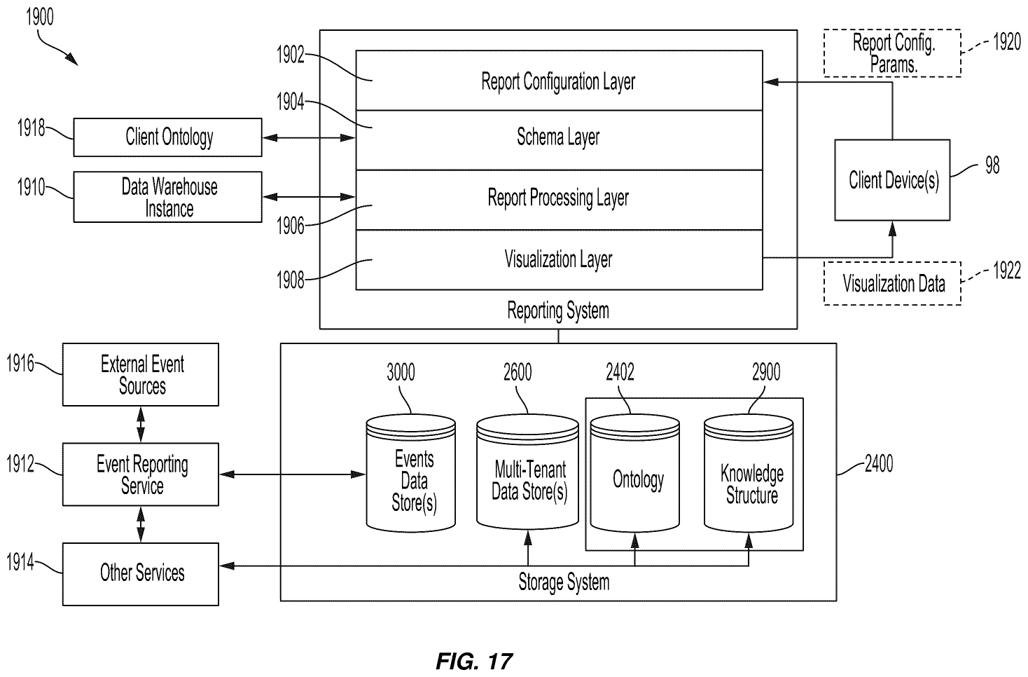

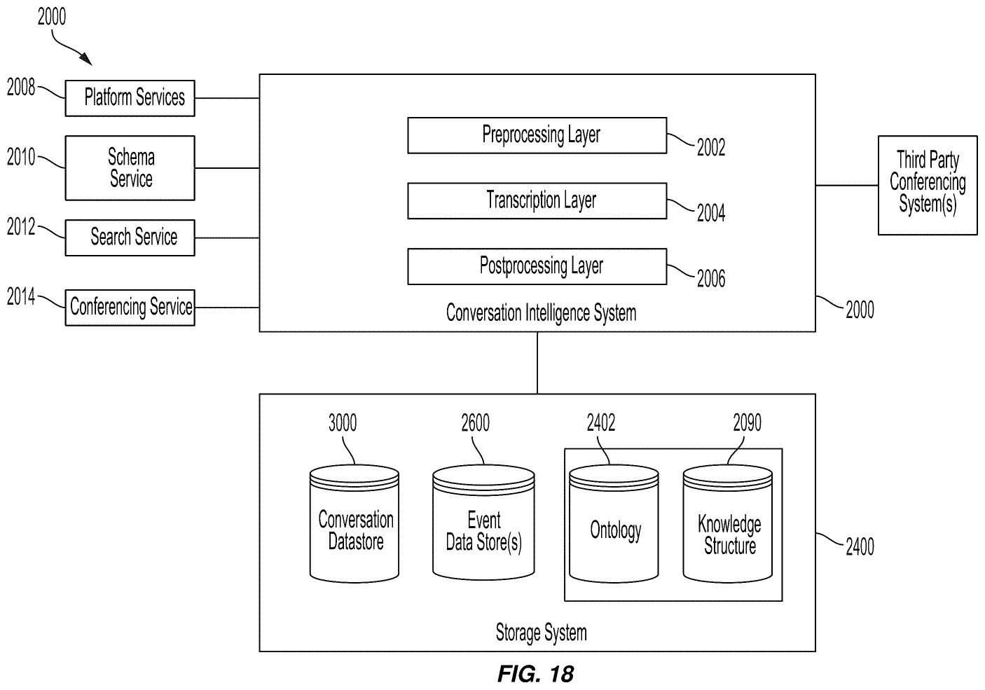

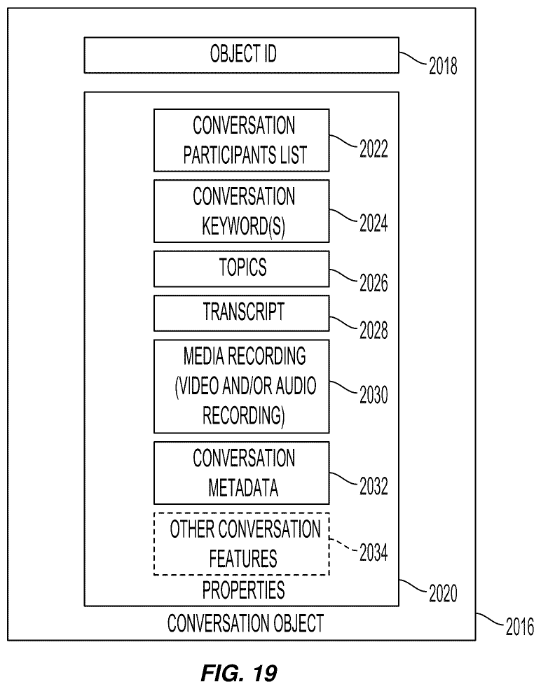

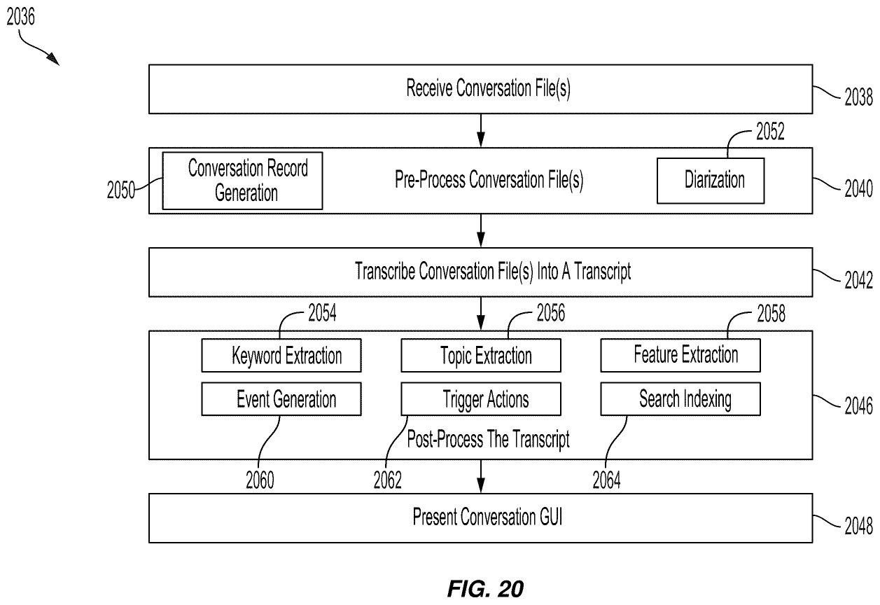

FIG. 2. Illustrates a functional diagram of the CRM System in accordance with an aspect of the present disclosure. In an aspect, the CRM 1100 maintains records of contacts and interactions associated with a particular customer or potential customer, including relevant corporate information, named individuals in significant roles, purchasing history, etc. In an aspect, the CRM system 1100 supports a consistent set of features and information is structured, so that individuals may be associated with corporate roles, and attributes such as progress status may be associated with objects such as product orders. Controlled change procedures may be provided to, as examples, provide auditable logs of information change activity, or to require particular authority to make such changes.

As shown in FIG. 2, the CRM 1100 is configured to access, associate and manage objects which are associated with potential and existing contacts (or customers) which create value to the client user 97 who is using the platform 1000. Contact objects may be considered as people who may communicate with the client 97 (e.g., anyone who may interact with business) such as customers or prospective customers of the business (e.g., people who may convert on a form, people who contact chat team of business, and/or people who met business team at an event). Each contact object may be defined with properties (e.g., a name of the contact, a phone number of the contact, an email address of the contact, a physical address of the contact, a title of the contact, and the like). Contacts may work at companies such that company objects may also be important to represent in data. Company objects may be defined as organizations or businesses that may communicate with a user's organization. Each company object may include properties such as a company name, an address of the company (e.g., main location, headquarters, or the like), and other suitable properties.

A deal object may be considered opportunities that may be available from interactions with contacts (e.g., contact objects) and/or companies (e.g., company objects). Deal objects may be defined as and represent transactions that may be typically between two businesses. Each deal object may include properties such as a sale made by a customer to a company via a contact. Some examples of deal objects may include the amount of a deal (e.g., deal_amount), an estimated close date for a deal (e.g., estimated_close_date), and a likelihood to close a deal (e.g., likelihood_to_close). Likelihood to close may be determined from machine learning. For example, machine learning may be used to take previously closed deals and may create a model around what types of properties (e.g., attributes) and objects may create a highly likely result to close and then may output values based on this predictive machine learning.

In an aspect, ticket objects may be considered as customer deals, requests for support or help (e.g., service ticket that may relate to a service request that may be issued by a company to a user via a contact). Some examples of properties for ticket objects may include date ticket was opened (e.g., date_opened), priority of ticket, last date custom replied to ticket (e.g., last_date_customer_replied), last date rep replied to ticket (e.g., last_date_rep_replied).

The CRM 1100 of the platform 1000 is configured to include associations between core and customized objects. For example, each association may be a directed association, such that a respective association may define a type of relationship from a first object to a second object. For example, an association between a contact object and a company object may be “works for” such that the contact object “works for” (association) the company object. When an instance of the contact object (e.g., the contact object instance identifies Bob as a contact) may be associated with an instance of the company object (e.g., the company object instance may identify “Acme Corp.” as a the company) with a “works for” association, then the individual indicated by the company object instance may be defined in the customer databases as working for the company indicated in the company object instance (e.g., Bob works for Acme Corp.).

In example embodiments, two objects may be associated using one or more different types of associations and the associations may be directed in both directions (e.g., association and inverse association). An inverse association of the association may be created automatically for every association. For example, the association in one direction may be “works for” and the inverse association may be “employs” which may be created for the same association automatically. This same association may be viewed from the contact object and viewed from the company object such that the association may be defined as the contact object “works for” (association) the company object or the company object “employs” (inverse association) the contact object. The associations may be between the same types of objects and/or between different types of objects. For example, in continuing the example of the company object and the contact object, a contact object instance may indicate that the company defined by the company object instance may employ the individual defined by the contact object instance vis-à-vis the “employs” association (e.g., Acme Corp employs Bob) and that the individual works for the company vis-à-vis the “works for” association (e.g., Bob works for Acme Corp).

In some example embodiments, two objects may have multiple associations in the same direction. Continuing the example of the contact object and the company object, a contact object may be associated with a company object by a “works for” association, a “previously worked for” association, a “sells to” association, and/or other suitable types of associations. Similarly, the company object may be associated with a contact object with an “employs” association, a “previously employed” association, a “buys from” association, and/or other suitable types of associations. In this way, different types of relationships between instances of objects may be defined within the customer's databases.

In example embodiments, objects may also have the same object type directed associations. For example, a contact object may be associated to itself with one or more directed associations, such as a “is supervised by” association, a “supervises” association, or the like. For example, if Bob and Alice may work for the same company and Alice may supervise Bob, then an instance of a contact object that may define Bob may be associated with a contact object instance that may identify Alice with a “is supervised by” association (e.g., Bob “is supervised by” Alice) and/or Alice's contact object instance may be associated with Bob's contact object instance with a “supervises” association (e.g., Alice “supervises” Bob).

As shown in FIG. 2, the contact data record 1100 may include a contact ID 1104, a client ID 1106, a purchase data 1108, ticket IDs 1110, a contact timeline 1112, and contact data 1114. It is noted that in an aspect, the contact record 1102 may be used across multiple platforms, such that the contact record 1102 defines data relevant to the contact through the lifecycle of the contact (e.g., from new lead and/or buyer through customer service). In an example aspect, the client's customer service function may be integrated with the sales arm of the client's business. For example, the contact record 1102 corresponds to a warehouse manager (a contact or end user 98) that purchased an industrial furnace from an HVAC business (a client 97) may identify or otherwise reference the dates on which the warehouse manager was first contacted, all communications sent between the manager and the HVAC business, a product ID of the furnace, and any tickets that have been initiated by the contact on behalf of the warehouse, and the like. Thus, in some embodiments, the integration of the client's sales and marketing data with the client's customer service infrastructure allows a client-specific service system to address issues with a more complete view of the contact's data and reduces the need for APIs to connect typically unconnected systems (e.g., invoicing system, CRM, contact database, and the like). The foregoing database object is provided for example. Not all the data types discussed are required and the object may include additional or alternative data types not herein discussed.

The contact identifier (or “contact ID”) 1104 may be a unique value (e.g., string or number) that uniquely identifies the contact (user 98) from other contacts which the client 98 has a probable or existing business relationship with. It is noted that in an aspect, the client ID 1106 is specific to a relationship between a contact 98 and a client 97, whereby the contact may only relate to a single client, although the contact may related to more than one client.

If a certain individual interacts with multiple clients, then the contact may have multiple contact records associated therewith (i.e., one for each client, where the contact is a customer of different clients (businesses) for the respective products or services of the businesses). The client ID 1106 indicates the client to which the contact corresponds. In embodiments, the client ID 1106 may be a reference to the client record 1116 (e.g., client database record). In this way, the client ID 1106 defines the relationship between the contact end user and the client.

Purchase data 1108 indicates some or all of the purchases made by the contact end user for a respective client. In an aspect, the purchase data 1108 may represent one or more products and/or services purchased by the contact and the dates on which such products or services were purchased from the client. In some embodiments, the products and services may be presented by product IDs which are unique identifiers for each product/service that is offered by the client.

The ticket IDs 1110 indicate any tickets that have been issued with respect to the client. In embodiments, the ticket IDs 1110 include any tickets, resolved or unresolved, that have been issued with respect to the contact for a particular client. In an embodiment, the ticket IDs 1110 may only include the tickets IDs 1110 that are still open. More details about ticket IDs 1110 are discussed below with regard to the ticketing system.

The contact timeline 1112 represents data relating to a timeline documenting the contact end user's interaction with the client. The contact timeline may include data from the point in time when the contact was solicited as a lead, when purchases were made by the contact, when tickets were generated on behalf of the contact, when communications were sent to the contact.

In an aspect, contact data object 1114 may include any data that is relevant to the contact end user customer with respect to a particular client of the platform 1000. The contact data 1114 may include demographic data (e.g., age and sex), geographic data (e.g., address, city, state, country), conversation data (e.g., references to communications that were engaged in with the client), contact information (e.g., phone number, email address, user name), and the like. Contact data may further include information such as a date that the contact was entered into the system, lifecycle state (what is the current relationship with the contact-current customer, lead, or service only), last purchase date, recent purchase dates, on boarding dates, in-person visit dates, last login, last event, last date a feature was used, demos presented to the contact, industry vertical of the contact, a role of the contact, behavioral data, net promoter score of the contact, and/or a contact score (e.g., net value of the contact to the client or a net promoter score).

Accordingly, contact data 1114 and the timeline data 1112 can be configured to provide a rich history of all interactions of the contact end user and the client 98 over the lifecycle of their relationship. As a result, an individual, such as a salesperson or service professional, of the client 97 using the platform 1000 can understand and reference that history for one or more end user to provide relevant communications to them.

In an aspect, the client record 1116 may include the client ID 1106 and one or more product IDs 1120. The client ID 1106 may be a unique value (e.g., string or number) that uniquely identifies the client from other clients that have accounts in the platform 1100. The product IDs 1120 identify/reference products (e.g., goods, services, software) that are offered by the client 97. The product ID 1120 of a product may reference a product record (not shown) that includes data relating to the product, including warranty data, serial numbers, descriptions, product names and the like. The foregoing database object is provided for example. Not all the data types discussed are required and the object may include additional or alternative data types not herein discussed.

Referring to FIG. 2, a ticket database record or ticket object 1122 is utilized and managed by the CRM system 1100 of the platform 1000 in accordance with an aspect of the present disclosure. In an aspect, the ticket database record 1122 may include a ticket ID 1124, the client ID 1106, a contact ID 1102, one or more ticket attributes 1130, one or more status attributes 1132, and other additional ticket data 1134. In an aspect, the ticket object 1122 stores data associated with the types of ticket attributes that may be used to identify, track, and/or manage a ticket issued to an end user contact 98 on behalf of the client 97. The ticket ID 1124 is a unique value (e.g., string or number) that uniquely identifies each ticket from other tickets that may be associated with contacts 98 of the client 97. In a ticket object 1122, the client ID 1106 is a value that indicates the client 97 with respect to which the ticket was issued. As can be appreciated, the client ID 1126 may point to the client database record 1116 and/or the contact record 1102 for a particular client 97. The contact ID 1128 uniquely identifies the contact 98 that initiated the ticket for the particular client 97. As can be appreciated, the contact ID 1128 may point to the client database record 1116 of the contact that initiated the ticket.

The ticket attributes 1130 may include or reference any data tied to the ticket. As discussed, the ticket attributes may include default ticket attributes and/or custom ticket attributes. Examples of default ticket attributes may include a ticket priority attribute (e.g., high, low, or medium), a ticket subject attribute (e.g., what is the ticket concerning), a ticket description attribute, a pipeline ID attribute, a creation date attribute, a last update attribute, and the like. The custom ticket attributes may depend on the customizations of the customer contact 98 for a particular client 97.

In an example, the ticket attributes 1130 may be customized to include a ticket type attribute 1130 indicating a type of the ticket (e.g., service request, upgrade request, refund request, lost items, etc.), a contact sentiment attribute indicating whether a sentiment score of a contact (e.g., whether the contact is happy, neutral, frustrated, angry). The ticket status attribute 1132 may include a sentiment or tone of the contact throughout the timeline, feedback from the contact, a contact score of the client, and the like. In an aspect, the product ID 1120 attribute indicates a product to which the ticket corresponds, a contact frequency attribute indicating a number of times a contact has been contacted, a media asset attribute indicating media assets (e.g., articles or videos) that have been sent to the contact during the ticket's lifetime.

In an aspect, the ticket attributes 1130 may further include the ticket status attribute 1132. The ticket status attribute 1132 can indicate a status of the ticket, whereby the status may be defined with respect to the ticket pipeline for the client 97. For example, example statuses may include: ticket is opened but not acted upon, waiting for customer response, at a chatbot stage, at service specialist, at visit stage, at refund state, issue resolved, and the like.

In an aspect, the ticket object 1122 may include additional ticket data 1134 in accordance with the CRM system 1100 of the present platform. In embodiments, the additional ticket data 1134 may include or reference the specialist or specialists that have helped service the ticket (e.g., employee IDs), any notes entered by specialists, a number of notes entered by the specialists, a list of materials that have been sent to the contact during attempts to resolve the issue, and the like. In an aspect, the additional ticket data 1134 may include references to transcripts of conversations with the contact over different mediums or knowledge base articles referred to during the handling of a ticket. For example, the additional ticket data 1134 may include or reference conversations had with a chatbot, over email, telephone call, in a WhatsApp message, SMS text message, social media posts, and/or other communications with the client's customer service specialist. The additional ticket data 1134 may include analytics data.

In an aspect, the additional ticket data 1134 may include or reference a ticket timeline (not shown) in accordance with the CRM system 1100. In an aspect, a ticket timeline may indicate all actions taken with respect to the ticket and when those actions were taken by the client 97. In an aspect, the ticket timeline may be defined with respect to a client's ticket pipeline and/or workflows managed by the client 97. The ticket timeline 1134 may identify when the ticket was initiated, when different actions defined in the workflow occurred (e.g., chatbot conversation, sent link to FAQ, sent knowledge base article, transferred to customer service specialist, made house call, resolved issue, closed ticket, and the like).

The ticket timeline 1134 of a ticket record 1122 may be updated each time a contact user 98 interacts with the client's 97 platform 1000 instance a for a particular ticket. In this way, many different types of information can be extracted from the ticket timeline (or the ticket record in general). For example, the following information may be extracted: How long a ticket took to come through the pipeline (e.g., how much time was needed to close the ticket); how many interactions with the system did the contact have; how much time passed until the first response was provided; how long did each stage in the pipeline take; how many responses were sent to the contact; how many communications were received from the contact; how many notes were entered into the record; and/or how many documents were shared with the contact.

Referring back to FIG. 1, the platform 1000 may include a workflow system 2100. In example embodiments, the workflow system 2100 may relate to controlling, configuring, and/or executing of workflows in the platform 1000. In example embodiments, the workflow system 2100 may utilize an automation application programming interface (API) which may provide “Get” functionality (e.g., get all workflows, get a specific workflow, get current enrollments, get performance stats for a workflow, and the like), “Post” functionality (e.g., enroll an object such as a contact into a workflow, create a workflow, using webhooks in workflows, and the like), “Put” functionality (e.g., log events), and “Delete” functionality (e.g., delete a workflow, unenroll or remove an object such as a contact object from a workflow).

The workflow system 2100 includes a custom workflow actions system 2102 that may communicate with various and data sources according to one or more example embodiments of the disclosure. The custom workflow actions system 2102 may provide users with the ability to create custom workflow actions (e.g., custom code actions). In general, the custom workflow actions system 2102 may relate to a custom workflow action process for setting up a custom workflow action. Creating a custom workflow action may make it easier for users to integrate their services with other workflows on the multi-service business platform 1000. In example embodiments, this process may include an initial definition of a custom action that may include expected inputs and a web address (e.g., uniform resource locator (URL)) that may be requested when the custom action is executed. Users may then install an application and add the custom action to their workflows. When the workflows execute, requests (e.g., hypertext transfer protocol secure (HTTPS) requests) is sent to the configured URL with a payload that may be configured.

In an aspect, the custom workflow actions system 2102 may allow users to define custom actions. For example, a custom action definition may include all information needed for workflows (e.g., needed for workflow system 2100) to display the custom action in a workflows application. This same definition may also specify the request format for requests coming from other services, systems, data sources, etc. in the platform 1000 as well as the handling of responses from these other services, systems, data sources, and the like. In example embodiments, the custom action definition may include: an action name (e.g., label given to the action in the workflows application) and action inputs (e.g., fields that may be filled out by a user to control the action's behavior and/or the selected values that may be included in the request that may be sent to the action web address such as “actionUrl”). The custom action definition may also include input options (e.g., define a set of valid values for the action inputs). In some examples, the input options may be optional for each field. In other examples, the input options may be either a static list or a webhook URL that may be provided. If the webhook URL is provided, the options may be fetched from that URL whenever the action may be edited by a user in the workflow actions system (e.g., workflows tool). In example embodiments, the custom action definition may also include an action web address (e.g., action URL “actionUrl”) and labels. An HTTPS request may be sent to the action URL whenever the action may be executed by the workflow system 2100 (e.g., workflows tool). The request body may include information about which user the action is executing on behalf of, and what values may be entered for the input fields. The labels may be a user-facing copy that describes to the user what the action's fields may represent and what the action does. Labels may be specified in any number of languages (e.g., English, French, German, Spanish, etc.).

In example embodiments, the custom workflow actions system 2102 may provide for a variety of other processes with respect to the defined custom actions. Validating requests may be made for the custom actions. In some examples, there may be default payloads (e.g., field option fetch) such that requests to fetch options may be made when a user may be configuring a custom action in a workflow. In some examples, if there is a desire to limit the number of options that may be returned by an option fetch, a pagination cursor may be set which may instruct the workflow system 2100 (e.g., workflows tool) that more options may be loaded. The list of options may be made searchable allowing for results to be filtered by a search query (e.g., return “searchable”: true). In an example embodiment, execution requests may be made when a workflow may be executing a custom action against an enrolled object. For example, there may be input fields for workflows (e.g., contact and deal workflows) such that there may be a static input field (e.g., dropdown field with options) where one field may have a value for a platform user and another field may have a value pull from a property (e.g., as selected by a user for workflows) on the enrolled object.

In example embodiments, requests made for custom actions may be customized by configuring serverless functions for the custom actions. For example, field option fetches may be customized such that there may be two hooks to customize a field option fetch lifecycle (e.g., using pre-fetch and post-fetch options functions). The pre-fetch options function (e.g., “PRE FETCH_OPTIONS”) may allow the user to configure a request that may be sent from the platform 1000 and the post-fetch options function (e.g., “POST_FETCH_OPTIONS”) may allow for the user to transform responses from the user's service into formats that may be understood by the workflow system 2100 (e.g., workflows tool). In example embodiments, there may be a hook into an action execution lifecycle including a pre-action execution function (e.g., “PRE_ACTION_EXECUTION”). This function may allow users to configure requests that may be sent from the platform 1000. In example embodiments, a custom action may use a serverless function to transform a payload that may be sent to a configured action URL (e.g., “actionUrl”). When no object types (e.g., “objectTypes) may be specified, this may be available workflows.

In an example embodiment, a custom action with field dependencies and options may be fetched using an API. For example, where a widget size may depend on widget color, a user may not be able to input a value for the widget size until a widget color is selected. A widget cost may also be dependent on the widget color but may be conditional on a value that the user selects for the widget color (e.g., a user may not input a value for widget cost unless “Red” is selected as the widget color). In a blocking custom action example, a callbacks API may be used to instruct workflows to complete an action and have an enrolled object continue to next action in a workflow. In some examples, action blocks may not be specified when an action is created but may be determined by a response from a configured action URL (e.g., “actionUrl”).

In example embodiments, a custom action may be published. By default, the custom actions may be created in an unpublishable state and may only be visible in a developer portal associated with the platform 1000 (e.g., platform application). To make the custom action visible, a published flag on the action definition may be initiated (e.g., made “true”). In example embodiments, the custom action may be tested such as by creating a workflow in the workflow system 2100 (e.g., workflows app or tool) and adding the custom action. In example embodiments, the custom action may be executed such that a success of the custom action may be determined by examining a status code returned. For example, the status code returned may indicate that: the action completed successfully as indicated by the status code (e.g., 2xx status codes), the action failed (e.g., there may be some example exceptions where this may be indicating retries such as 429 Rate Limited status codes that may be retreated as retries and the Retry-After header may be respected) as indicated by the status code (e.g., 4xx status codes), or a temporary problem with service (e.g., action may be retried at a later time) as indicated by the status code (e.g., 5xx status codes). In some example embodiments, retries may occur through fetching of object properties using a platform API or by calling other platform API endpoints. In example embodiments, custom actions may block workflow execution. This means that instead of executing the next action (after the custom action) in the workflow after receiving a “completed” response (e.g., 2xx or 4xx status code), the workflow may stop executing (“block”) until the workflow may be instructed to continue. In example embodiments, a blocking execution may be kicked off or a blocked execution may be completed. In example embodiments where a blocking execution may be kicked off, a custom action may be blocked asynchronously. There may be an expiration that may be a default duration after which the custom action may be considered “expired”. At this stage, execution of the workflow may resume and an action following the custom action may be executed even though there may not be an instruction for the workflow to continue.

In example embodiments, the workflow actions system 2102 may allow for developers to print or export outputs from their code as part of logging. It may help debug issues and may provide support for end users. In example embodiments, a function may define output fields that may be used later in the workflow. Then, the data output type (e.g., number, string, boolean, datetime, enum, date, phone number) may be selected in a user interface (UI) such as by inputting a field preferred for output. The output fields may be part of a JSON object in some examples. In example embodiments, to define data outputs that may be used as inputs in a workflow, “Data type” may be clicked from a “Data outputs” dropdown menu and type of data may be selected (e.g., name for data output may be provided in “Name” field and multiple outputs may be added by clicking “Add output”). The output from the code action may be used as input to a “copy property” action as a “copy property value” in FIG. 83. This may remove a need to make another API call to store a value as a property on an object.

In example embodiments, there may be a variety of use cases for the workflow actions system 2102. Some example use cases may include: transforming data (e.g., turning a string into a date/time object such as “date_time” or changing a formatting of a phone number), data hygiene (e.g., name capitalization, name concatenation, etc.), lead assignment, territory management, service-level agreement (SLA) management for service issues, customizing webhook payloads (e.g., change format of a request that may get made for a webhook action, and with the custom code action (and the requests library)), and/or the like. In some example embodiments, random number generator functions may be used (e.g., cryptographically secure pseudo-random number generation) such as with respect to enrolling objects into a workflow.

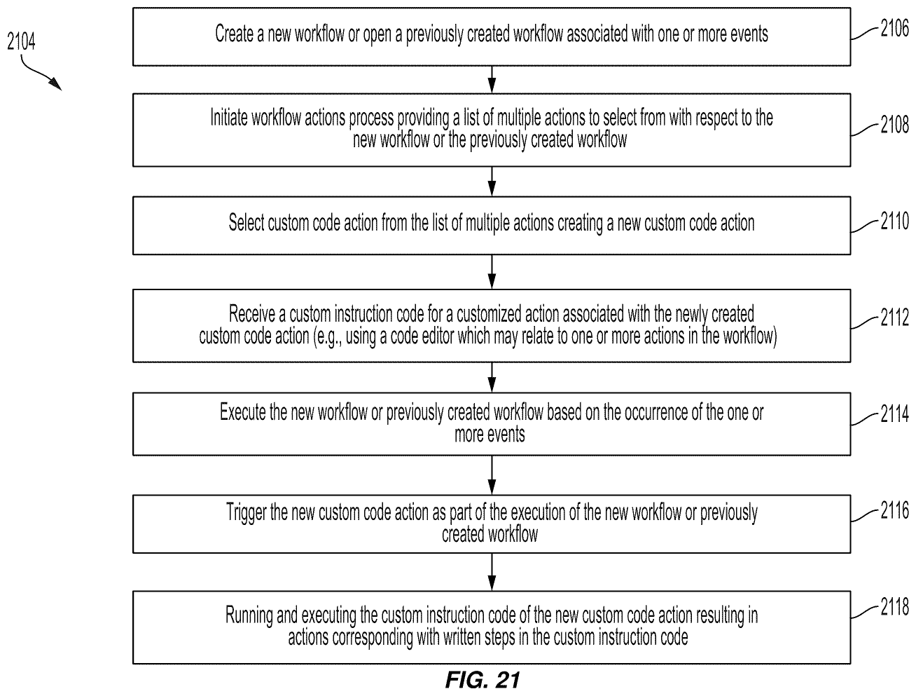

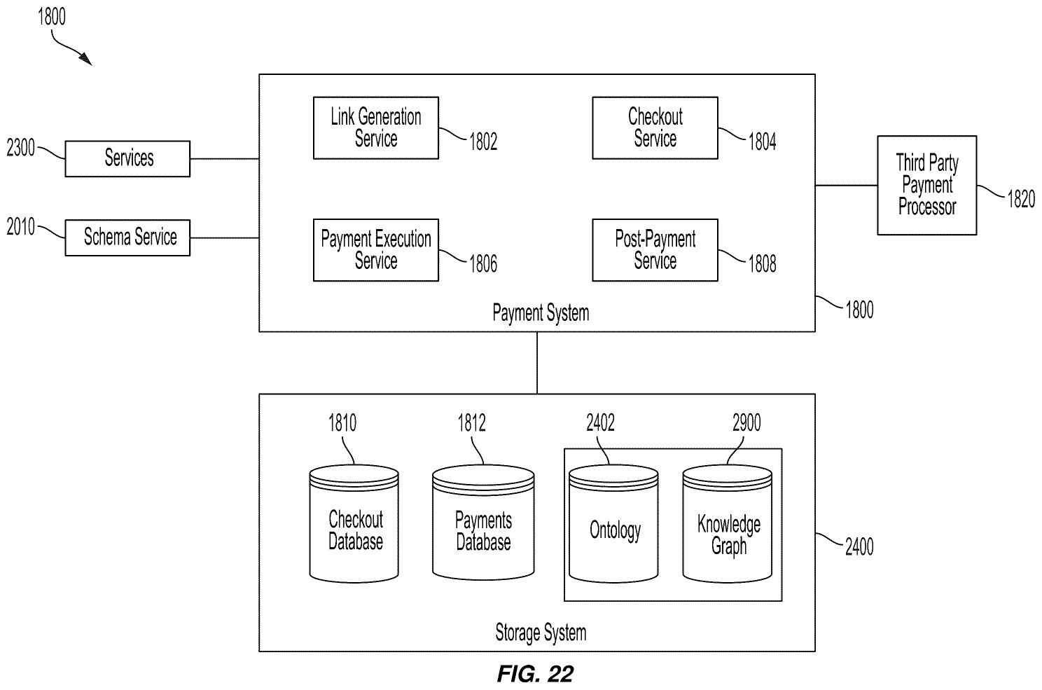

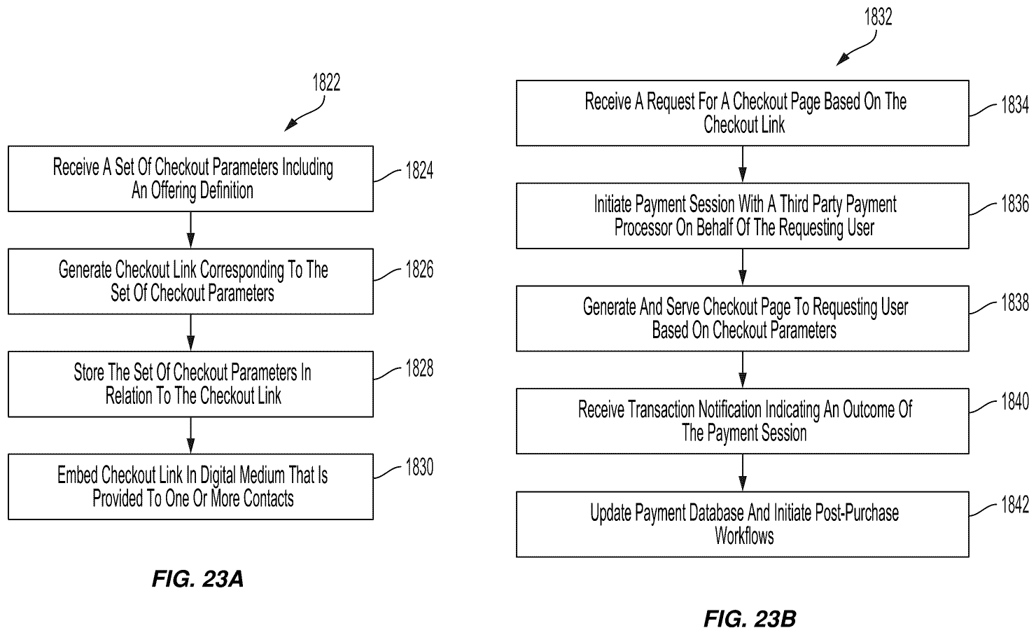

Referring now to FIG. 21, there is shown a flowchart 2104 having an example set of operations for creating and using a custom workflow (specifically creating and using a custom action process such as a custom code action process). The process includes creation of a new workflow or opening a previously created workflow associated with one or more events at step 2106. A workflow actions process may be initiated providing a list of multiple actions (e.g., action types) to select from with respect to the new workflow or the previously created workflow at step 2108. A custom code action may be selected from the list of multiple actions creating a new custom code action at step 2110. Next, a custom instruction code for a customized action associated with the newly created custom code action may be received from a user (e.g., a user may use a code editor which may relate to one or more actions in the workflow) at step 2114. The new workflow or previously created workflow may be executed based on the occurrence of the one or more events at 2104. Then, the new custom code action may be triggered as part of the execution of the new workflow or previously created workflow at step 2116. Running and executing the custom instruction code of the new custom code action may result in actions corresponding with written instructions (e.g., steps) in the custom instruction code at step 2118.

In general, the custom workflow actions system 2102 (e.g., custom code workflow actions tool) may allow users to create workflows that respond to events so that the users may customize any action that they want after an event has taken place. The custom workflow actions system 2102 may function within a custom workflow actions process. Other related actions and/or functions may also be included in the custom workflow actions process. In example embodiments, events may be defined generally as some change in the platform 1000. For example, this change may be a property change on a contact or anything that may drive a list change. Then, platform 1000 may take an action on any number of user-configured actions. For example, the platform 1000 may be used to configure or set properties, send emails, send notifications, call other URLs in other companies, and the like. In example embodiments, other actions may be taken within the scope of this disclosure providing a relatively broad list of actions that may be taken. Some examples of events of extensions may include create a ticket (e.g., an issue tracking ticket such as an internal ticket or call out a webhook to a third-party company. In other examples, messages may be sent through various channels (e.g., send internal messages).

In example embodiments, the custom workflow actions system 2102 uses a custom code action. Specifically, in example embodiments, the custom workflow actions system 2102 may provide the ability for users to write their own code and may execute arbitrary logic in response to the code. This may be a graphical programming language where there may be a condition (e.g., if/then statement). The custom code action allows users to author arbitrary logic to do whatever the user wants when an action shows up (e.g., using JavaScript). There may also be data passing between actions such that one action occurs and then there may be a result from that action. This result may be passed to another second action such that the second action may act on the result that may be used as part of the input of what it may be doing. In another example embodiment, the custom workflow actions system 2102 may use formula actions which may be relatively simple custom code actions (e.g., performing or providing data hygiene processes such as capitalization of names, spell checking, etc.). These actions (and related processes) may stem from the ability to execute an arbitrary process when an action takes place.

In an aspect, the workflow system 2100 may operate with the GUI of the platform 1000 for displaying an example workflow tool which may be found under a workflows section in a top navigation tool set. This may provide a home where a visual automation builder may be used.

This may allow for processes such as triggers and actions to be executed. In an aspect, the GUI of the platform 1000 displays a custom code action using custom workflow actions system 2102. In an aspect, the custom code action may provide a way for users to write and execute programming language (e.g., JavaScript) in an action.

In example embodiments, the custom workflow actions system 2102 may provide an interface (e.g., in the form of a relatively small instant virtual extranet (IVE)) that a user may use to create code (e.g., JavaScript) related to adding a function, such as a GUI for displaying an example custom code action development interface. Custom code actions may extend workflow functionality within and external to the platform 1000. In example embodiments, custom code actions may support JavaScript using a runtime framework such that when actions execute, a runtime compute may be managed through a serverless function 1000. In some examples, this may allow for the platform 1000 to operate on all of the data that currently exists in the workflow. The data that currently exists in the workflow may enroll one or more objects when the workflow may be triggered. For example, the custom workflow actions process may either enroll a contact or a deal such that all of the data about that object (e.g., contact or deal) may be made available to be able to operate on. This may occur with any action in the workflow. In example embodiments, the GUI may have a “choose an action” interface using custom workflow actions system 2102.

In another example, the GUI may display a selection of a custom code action from the “choose an action” interface (e.g., using custom workflow actions system 2102). For example, a client user can navigate to a “workflows” feature via “automation”, select a “name” of a workflow or create a new workflow, select the “plus icon +” to add a workflow action, and then select “custom code”. In example embodiments, the custom workflow actions process (including custom workflow actions system 2102) may be combined with supporting features in workflows. For example, when a workflow may be triggered, the workflow may enroll an object. Typically, all of the data made available to a workflow may be the data about that object.

In an aspect, the custom workflow actions system 2102 allows for the creation of custom code actions for a workflow. For example, users may write and execute programming language (e.g., JavaScript) within a custom action in workflows. In the workflow system 2100 a feature is contemplated referred to as “custom code action”, whereby upon selecting the “custom code action” link, a code editor may be opened for the user to input software code instructions for a workflow. This new custom code action may be triggered when an object reaches this stage of a workflow where the custom code action is initiated.

In example embodiments, the custom code actions may utilize an “exports” main function (e.g., “exports.main( )”) that may be called when a code snippet action may be executed. In example embodiments, the custom code actions may each have an event argument that may be an object that may have details for the workflow execution. Also, the custom code actions may each have a callback function (e.g., “callback( )”) that may be used to pass data back to the workflow (e.g., the callback function may be called in the “exports” main function). In some example embodiments, there may be an event object in JSON such as an example payload that includes reference to a portal ID, custom action definition ID, type of CRM object that may be enrolled in workflow, and a unique ID for execution. In example embodiments, there may be several libraries available for use within code actions. The libraries may be loaded using a normal require function of the code.

Using the custom code action may allow for various other use case examples (and related processes) that may be performed with objects. For example, the system may run different processes on objects, calculate different fields within that data, etc. Further, the custom workflow actions process (e.g., using the custom workflow actions system 2102) may execute API calls out to other systems or into the internal API to get other data.

There may be example instances where the code may refer to something that may not be widely shared. For example, this may be a means of authentication (e.g., an API key). The custom workflow actions system 2102 may allow for the management of secrets that a function may have access to directly in the workflow action definition. In example embodiments, the GUI of the platform displays an “add a secret” interface on a management interface requesting credentials information. (e.g., secret name: “hapikey” and secret value: “my-api-key”). Once added, the secrets may be available as environment variables used by the platform 1000.

In an aspect, the custom workflow actions system 2102 may provide the ability for users to add API secrets that users may authenticate into various different services that they want to call out. Within the code itself, the user may make API calls (e.g., call the platform contact API and/or call the contact API in order to obtain information such as zip codes of contacts or other data). This data may be obtained to be acted on by the user within the platform. In other example embodiments, this may be accomplished with external services and external APIs. In general, the custom code action may open up a variety of possibilities and example use cases that the user may write and execute (e.g., using JavaScript). In example embodiments, to use a secret in with a custom code action, a “Secrets” dropdown menu may be clicked and then an “existing secret” may be selected or a “new secret” may be added. The “new secret” may be added by clicking on “add secret”, enter “Secret name” and “Secret value”, and then save such that this “new secret” may be selected in future custom code actions. Existing secrets may be edited or deleted via a “Manage secrets” interface.

Example available data to workflows may be expanded. In one example, it may be expanded to include data passing. This may mean that any action that happens may also take the custom code action. In this example, the custom code action may view a contact, may pull in the zip code of the contact, and then may call out to the zip code API. The zip code API may allow for extraction of zip code data, calling up the API, and then may associate that data to different states and regions. With this information, the user may configure the workflow such that if a customer fills out that they are from a particular zip code, then that customer may be associated with a particular region which then may be passed off to a user (e.g., user's company's sales team). Other similar configurations may be performed using the custom code action. This may allow for extraction of the result of that data and then passing it through to the rest of the workflow. This may eliminate a need to make an API call back to the internal platform (e.g., multi-service business platform 1000) to write it onto a CRM property. This process of data passing may provide an expansion of the amount of data that may be accessible to the workflow itself. When the workflow may be executing, the workflow may become more successful (e.g., improved quality) and more capable with every action that may happen and may expand the amount of data that may be available.

In other examples, the user may prefer to use the custom workflow actions system 2102 to develop code to capitalize contact names (e.g., capitalize last names). In example embodiments, the platform 1000 displaying an example “format data” interface which allows the client user to provide custom code action used in to automatically capitalize names. Specifically, as described in the disclosure, the custom workflow actions system 2102 may be used to create a code action for capitalizing contact names (e.g., capitalize last names). The custom workflow actions system 2102 may provide flexibility to users based on their general business needs and purposes.

In example embodiments, there may be a passing in of what objects are enrolled and/or what objects (e.g., contact objects) may be started in workflows which may be directed to the code of the custom workflow actions system 2102 that the platform 1000 may need for some next actions. From there, the platform 1000 may search/query. Then at the end, the code may pass in the ability to pass out data. This may be called a callback where information or data may be passed.

In some examples, this code may execute an API from another service and may look up information and retrieve a phone number that may need to be found and pulled externally. This may enrich the contact data which may be passed out of the workflow by transferring the data to predefined fields (e.g., email and phone which may be defined). In example embodiments, the platform 1000 displays an example custom code action (e.g., using custom workflow actions system 2102) related to formatting a phone number. Then, the code may specify what kind of data may be expected to output this custom code action. The reason for specifying this output may be so that the downstream actions may know and anticipate what to expect (e.g., copy property action which may be copying the value of the phone number from the custom code action to a custom property boom. In example embodiments, the platform 1000 is configured to display an example copy property value interface utilizing the custom workflow actions system 2102. In example embodiments, this may allow for outputs (e.g., outputs passed from the workflow) to be used in subsequent actions in the workflow such that the output data may be passed to subsequent actions within the workflow and/or other workflows.

In example embodiments, workflows may be displayed as a flow diagram that relate to some change that occurred within the platform 1000 providing a series of steps that may occur as a result of that change. The workflow may span seconds or days or longer, in terms of how long it may take to execute. Accordingly, in some examples, starting the workflow may occur from a form submission from a contact, and then multiple days later the user may be working on a drip email campaign for customers. This may be all based around conditional actions that may occur where if a customer of the user filled out the form and then viewed the landing page after the email was sent, it may trigger some action. The custom workflow actions system 2102 may allow for users to customize what they may want to act on based on an event occurring. This may allow users or developers to take control over the value they may get out of the use of the platform 1000 by providing their own custom code. The custom workflow actions system 2102 may give users autonomy and control to build particular workflows for their business use cases and needs. The user may add any number of desired actions with custom code at any number of steps in a workflow that may be dependent upon particular challenges the user may be trying to solve by using the workflows tool 2102. For example, there may be a workflow that has four actions that may have a custom code for one of the four actions or there may be a workflow that may have one action that may be a custom code action. The custom workflow actions system 2102 and custom workflow actions processes may allow for running this code internally with respect to the platform 1000. This may allow any user from any company size to write this type of code which may be immediately run by the integrated platform.

In general, each custom code action may be an action within a larger workflow. The custom code action may fit into a broader category of actions. There may be pre-built actions that may have already been created, such as a “send email” interface which may be automatically built into workflows. This “send email” action may allow for a selection of emails to be sent such that when this action executes, contacts may be sent a particularly selected email. There may be other prepackaged actions that provide external communication by sending an email or sending a notification via a third party messaging service, provide assignment (e.g., rotate a record to the owner), provide creation (e.g., create a record or create a task), provide list management (e.g., add to a static list or remove from a static list), provide ads/advertisement management (e.g., add to an ads audience, remove from an ads audience, or the like), provide delay (e.g., delay for a set amount of time, delay until a day or a selected time, delay until an event happens, or the like), provide internal communication (e.g., send internal email notification, send internal marketing email, send internal short message service (SMS), send in-app notification, or the like), etc.

In some examples, an action may be a “delay” action. The delay action may wait or delay for a specified period of time (e.g., one day). In some examples, a custom code action may be written to do a similar delay along with other steps to form a new custom code action that may include delay as one step in the custom code action. In another example, there may be a “Set Properties” action where the workflow system 2100 may output the property that was enrolled and then request setting the specific property to a specific value which may then be set. This may be hard coded into the automation tool which may have been created with the user interface (UI) for this platform. In example embodiments, this action may be created with a custom code action by looking up or identifying the contact that was passed to the user and then the system may use APIs to set a property to a desired value by the user.

In example embodiments, the custom code action may be a type of extension which may be any action that is not hard coded into the platform. These custom actions may be written using an extension interface (e.g., of the custom workflow actions system 2102) as described in the disclosure. The custom code actions may be specific to each portal and each workflow for the user. The code that the user writes for the custom code action may be unique or specific to that workflow. Specific tasks or steps in the custom code (e.g., defined within the custom code action) may be used elsewhere but the combination of the custom code action in one workflow (with other actions in the workflow or by itself as a sole action in the workflow) may be unique to only that workflow.

In some examples, the users may use the platform marketplace to install an integration that may provide additional functionality inside of the automation tool. Converting some custom code actions to hard coded actions may occur where it may become apparent that the process (e.g., instruction steps of the process) of the custom code action may provide solutions to some problems for the majority of users. There may be a balance between use of custom code action (e.g., purpose built through code) versus default code within the platform.

In the example custom code action, the platform 1000 may be initially defined such that a library may be imported (e.g., importing a platform API client) so that API calls may be made from the platform. Next, the custom code action may open a scope such that code in two curly brackets may be inside a main function. The event and callback may be passed into this scope for use. For example, this event may be available, which may be the information that may be shown in the comment (e.g., towards the bottom of code) that this event may occur. Then, the callback may be a type of handle that may allow for passing of data. In this example, there may be a few comments that discuss secrets. Then, the custom code action request may ask to obtain an object from an API. The API request may be signed with an API key or other authentication mechanism to identify the user. Then, the code may extract an identification (ID) from the object data returned by the API and use it in subsequent actions or requests. In some examples, the custom code action may include requests for lookup of contacts at the CRM and then may use an API to obtain by ID. This may include a request to take some action. Then, the action that is being initiated or executed may be using the information that was passed on by the event to get the ID of the contact that has been enrolled in this workflow. For example, the platform 1000 may be used to obtain a contact by this event along with the related email and phone. In some examples, this custom code may limit the information request of contacts to emails and phone numbers only.

Referring back to FIG. 1, an example environment in provided to include a multi-client or tenant service business platform 1000 or generally “platform” in accordance with the present disclosure. As shown, the environment includes a platform which may be also referred to as a multi-tenant distributed system, framework system or a multifunction business platform that may serve the needs of multiple users who in turn use the system to provide services, support, and the like for their customers. The platform communicates with various systems, devices, and data sources according to example embodiments of the disclosure.

The platform communicates and sends/receives data over a communication network (e.g., Internet, public network, private network, etc.). In particular, the platform leverages network to send and receive data with one or more user devices, one or more client devices, one or more third party services, one or more integrator devices, and external information sources and databases.

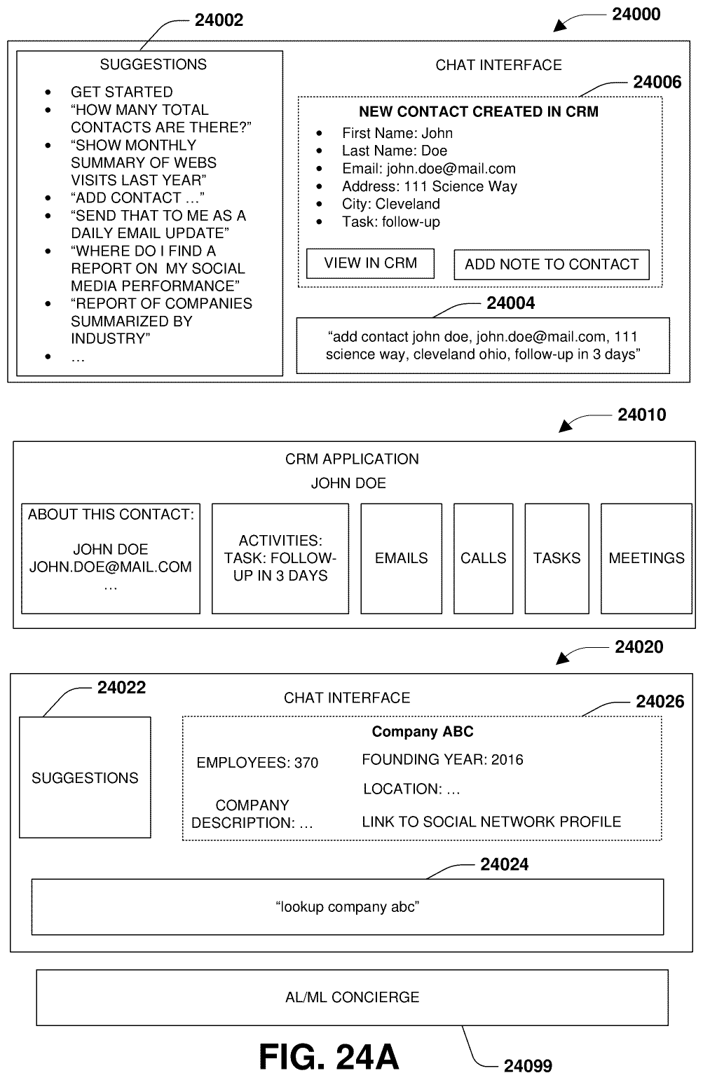

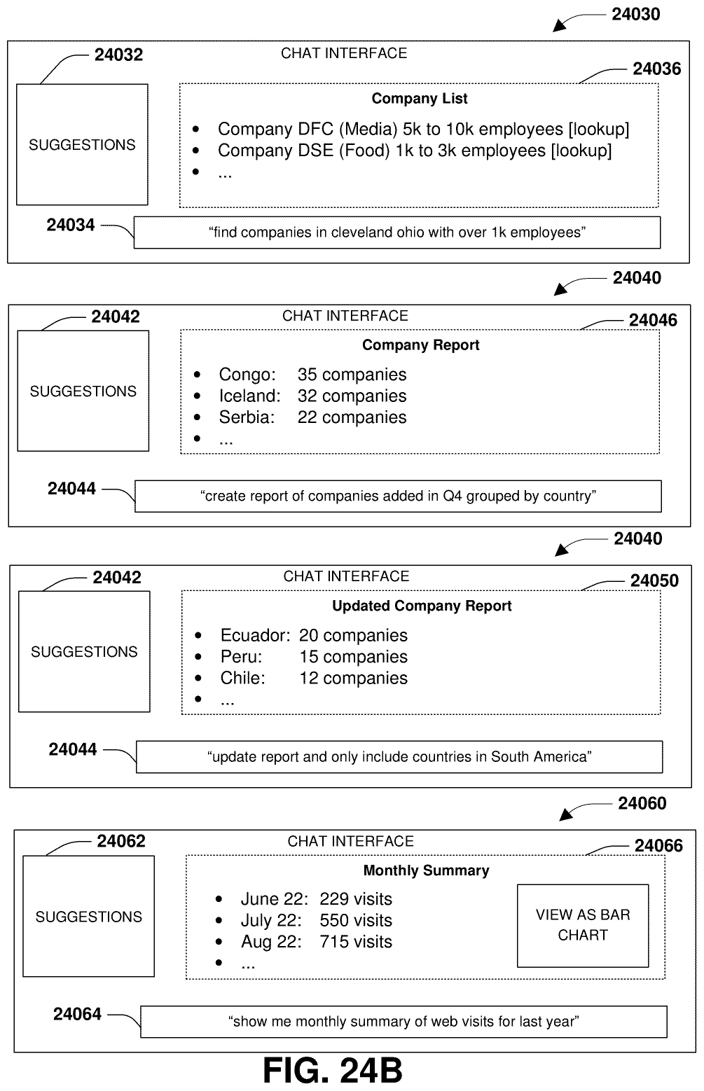

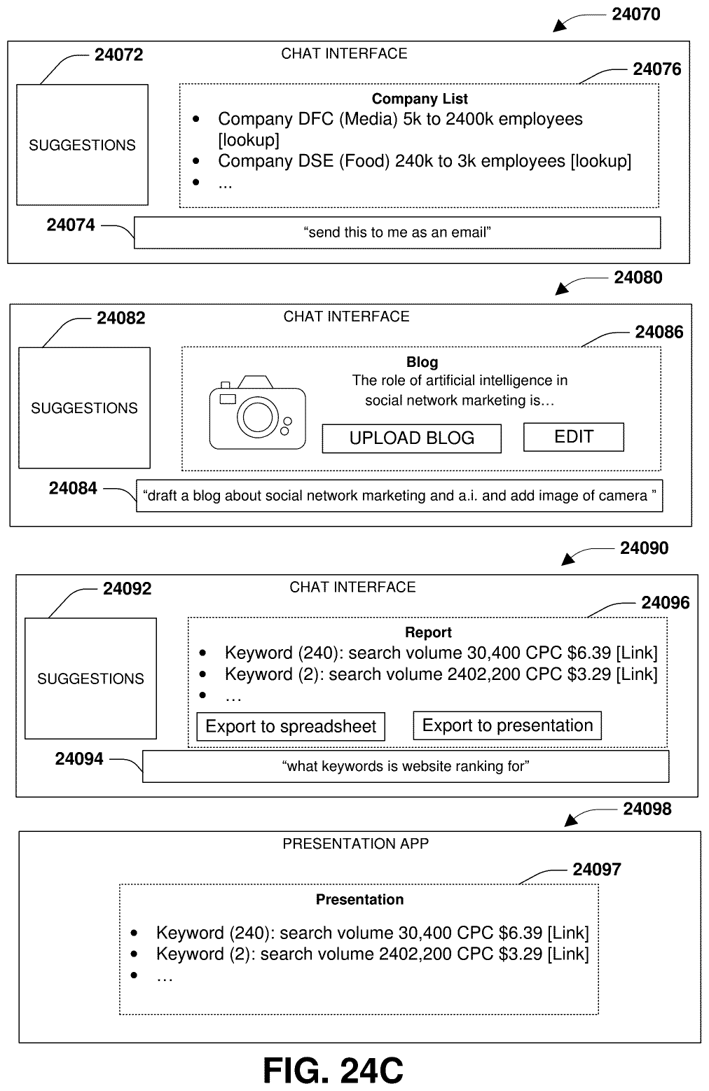

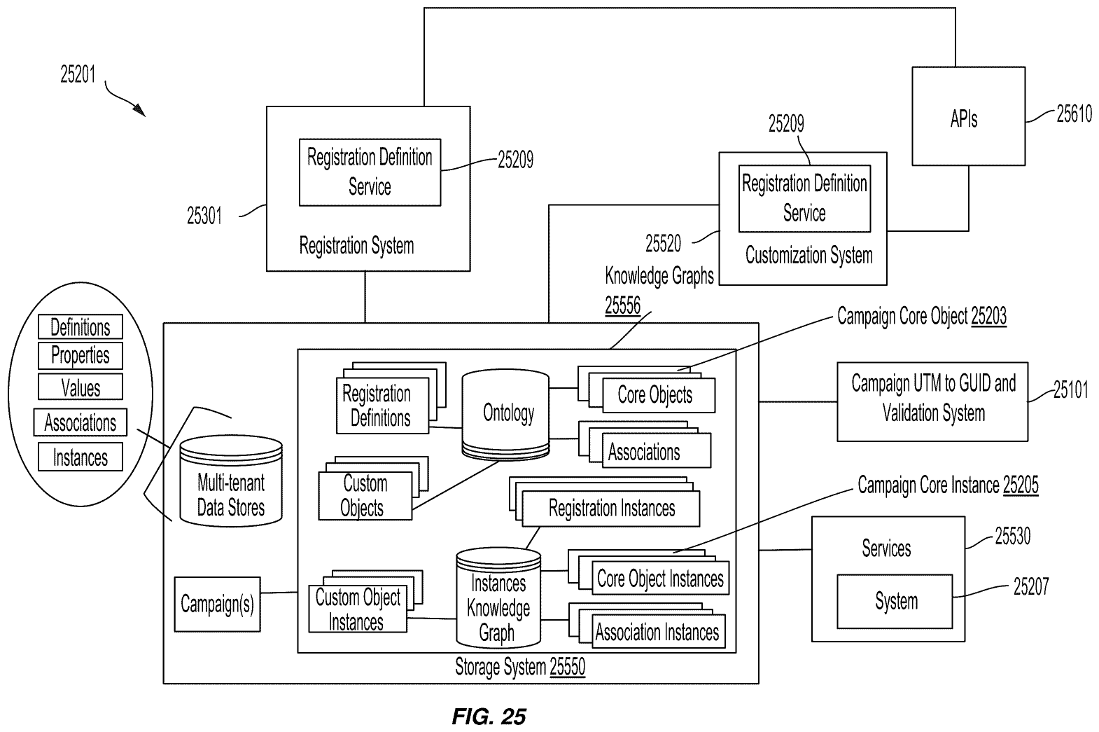

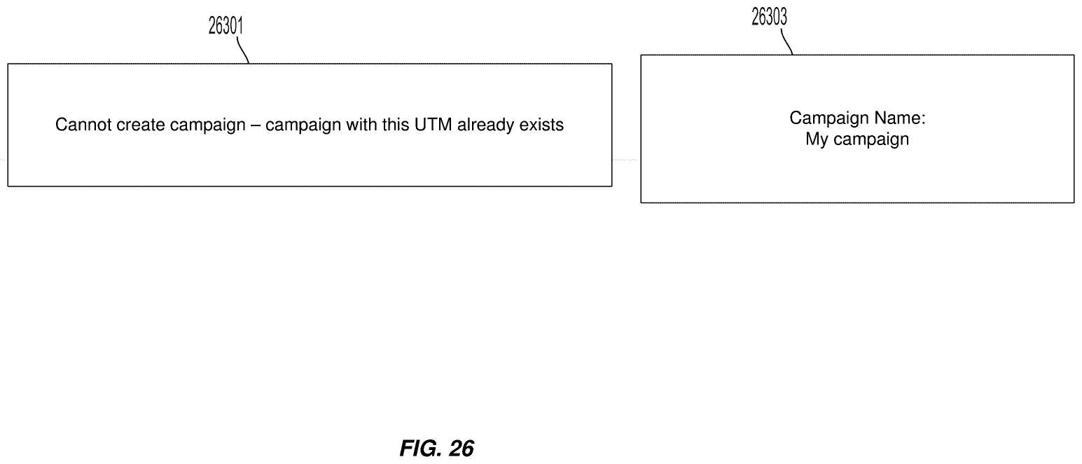

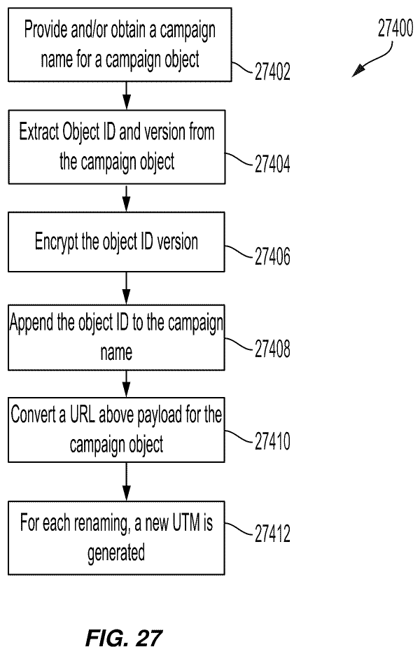

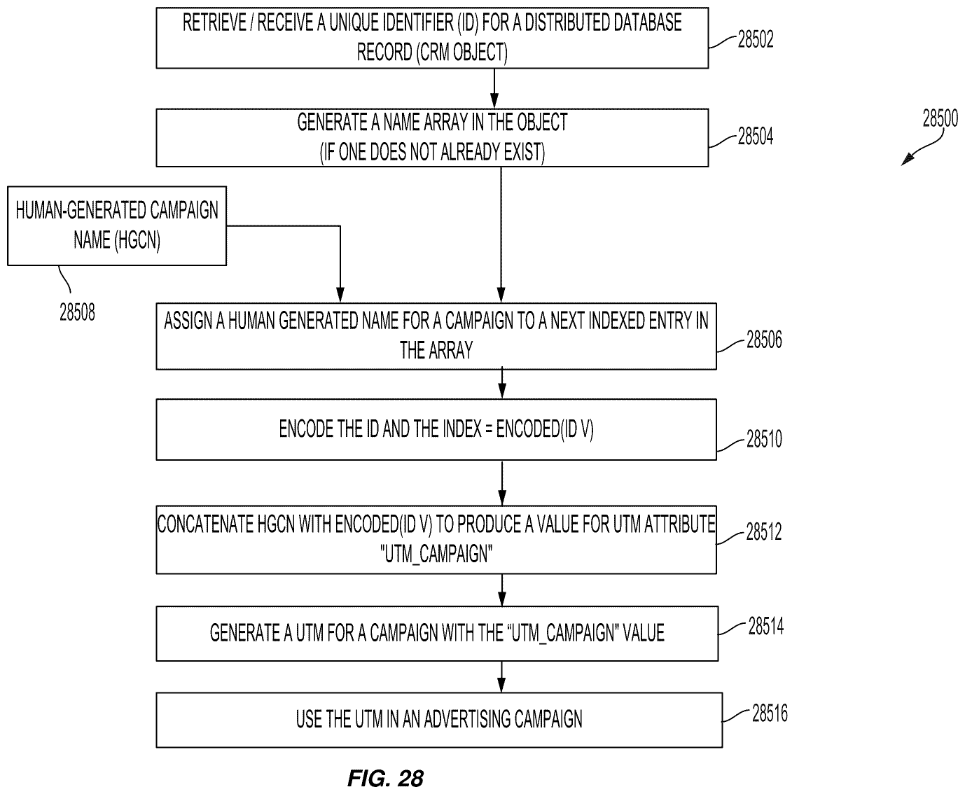

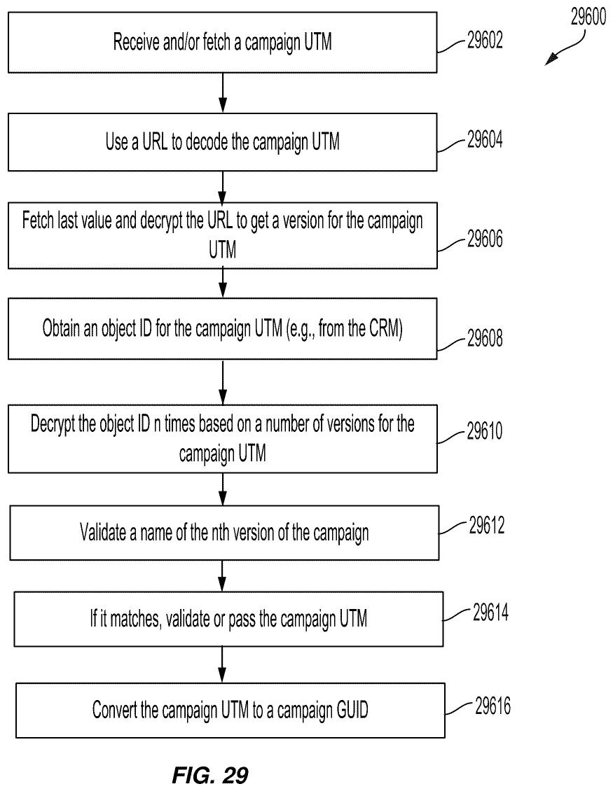

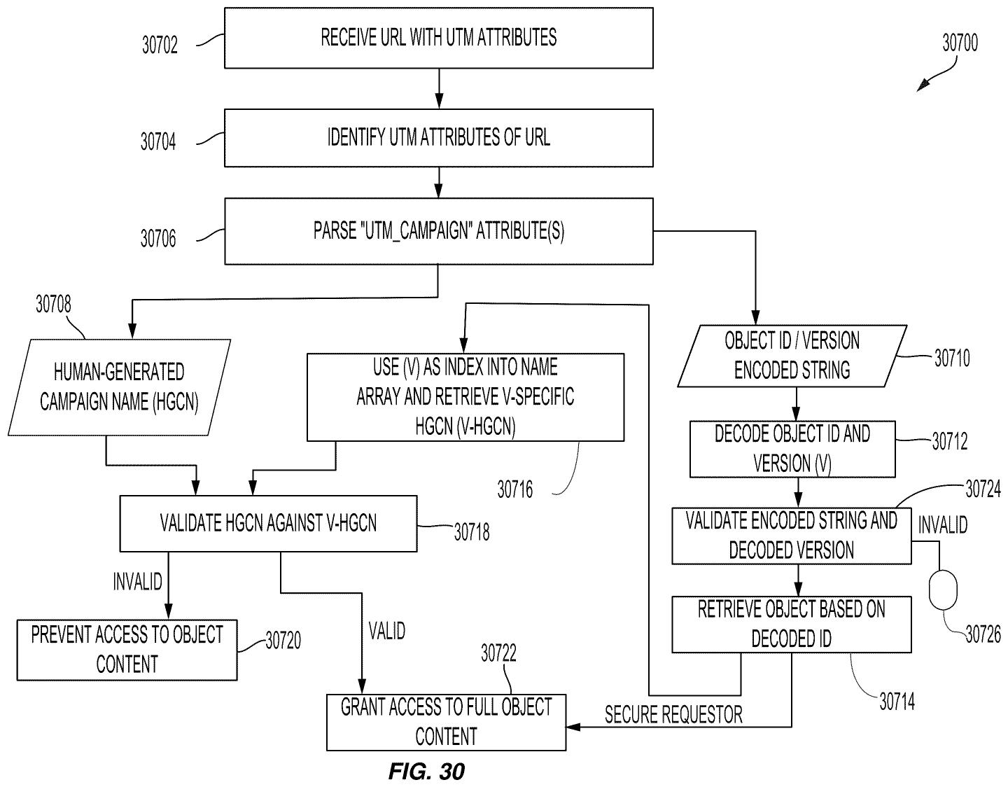

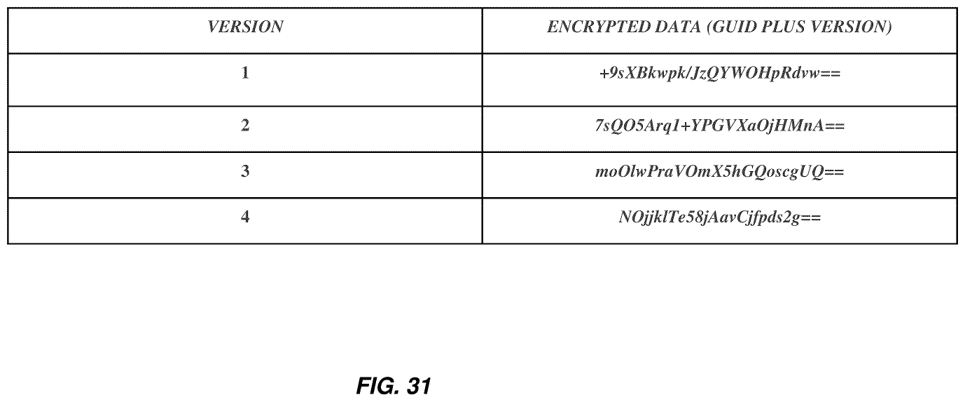

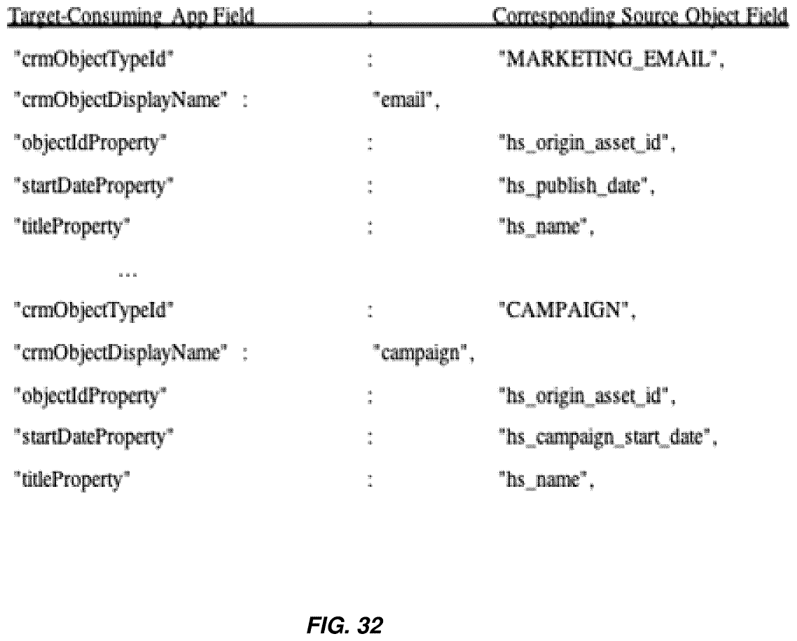

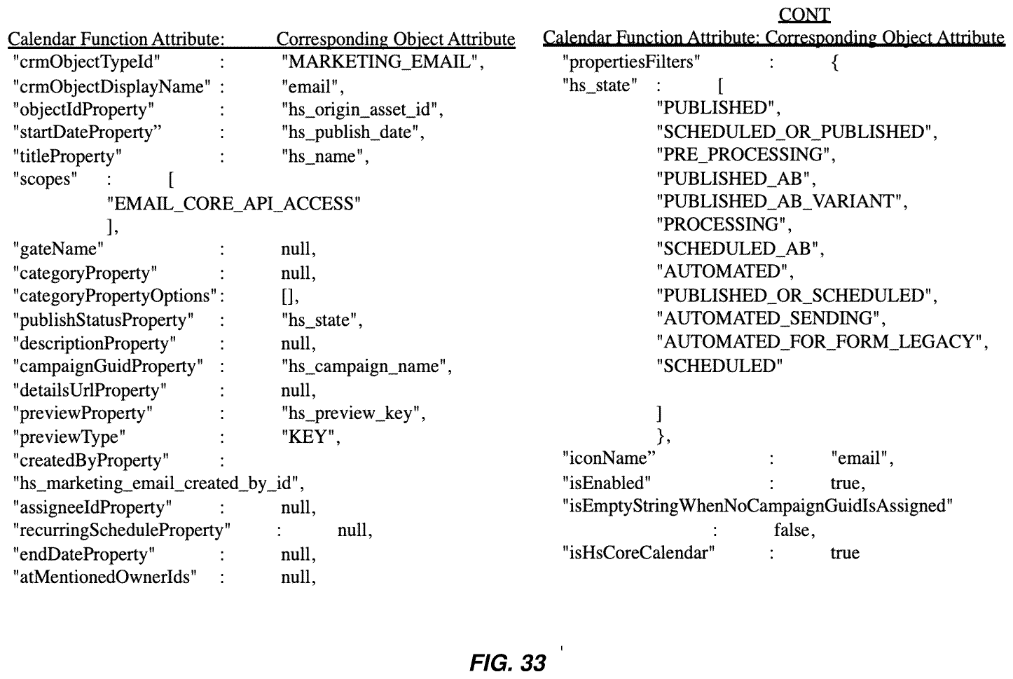

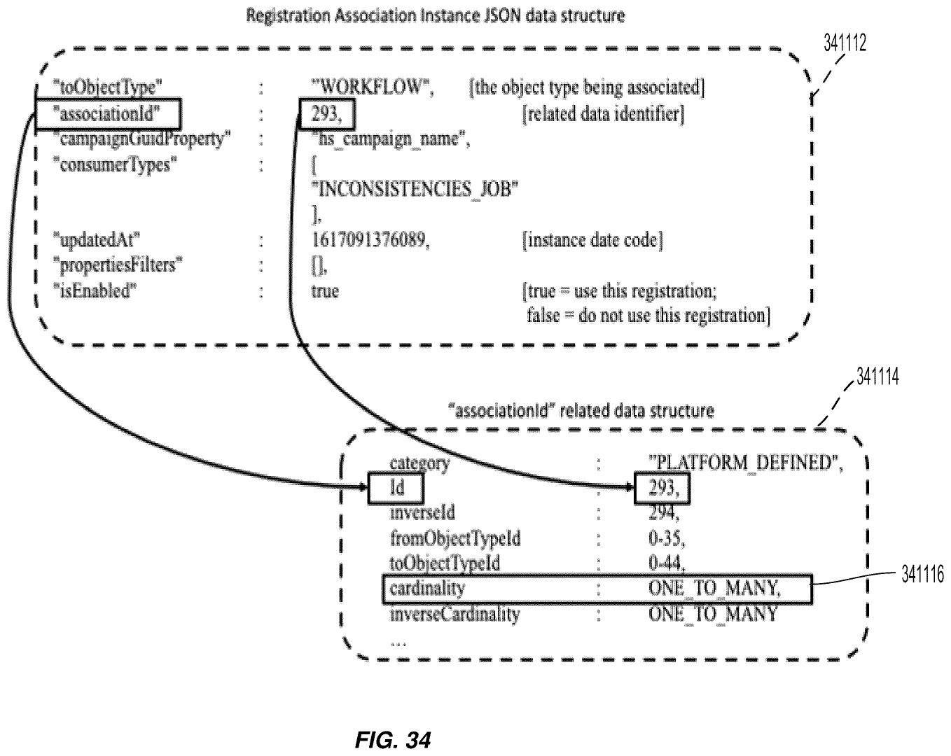

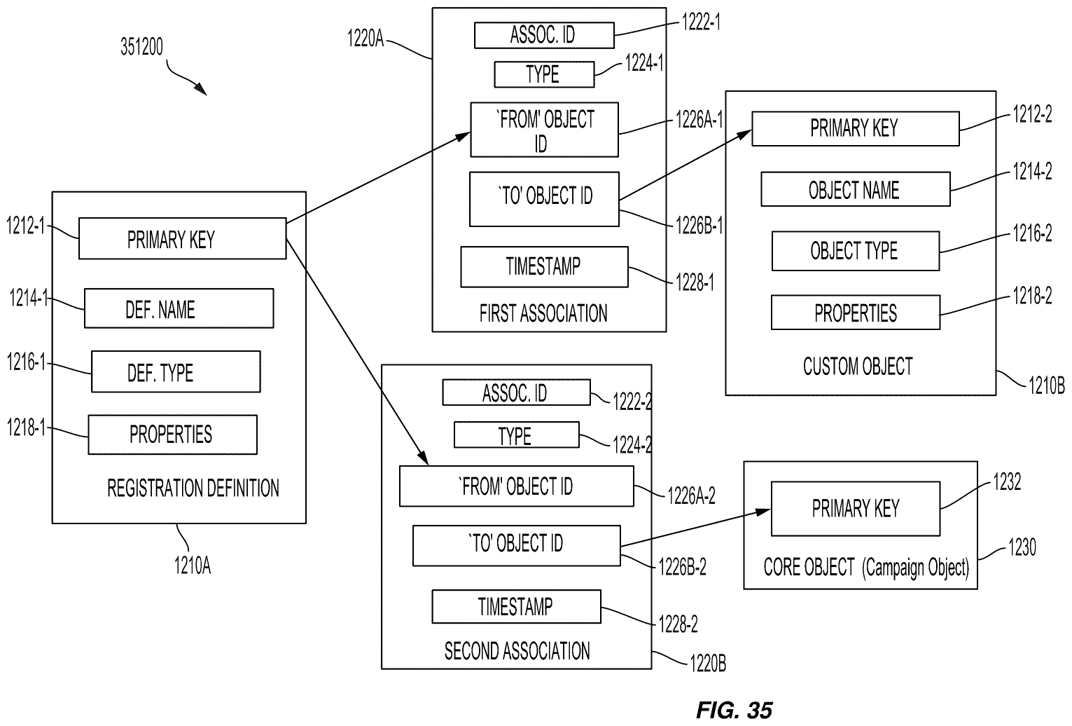

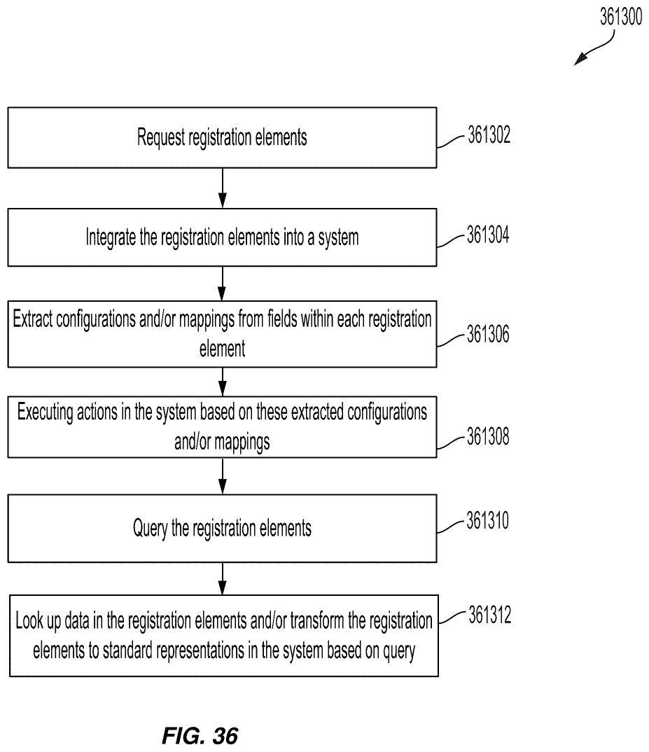

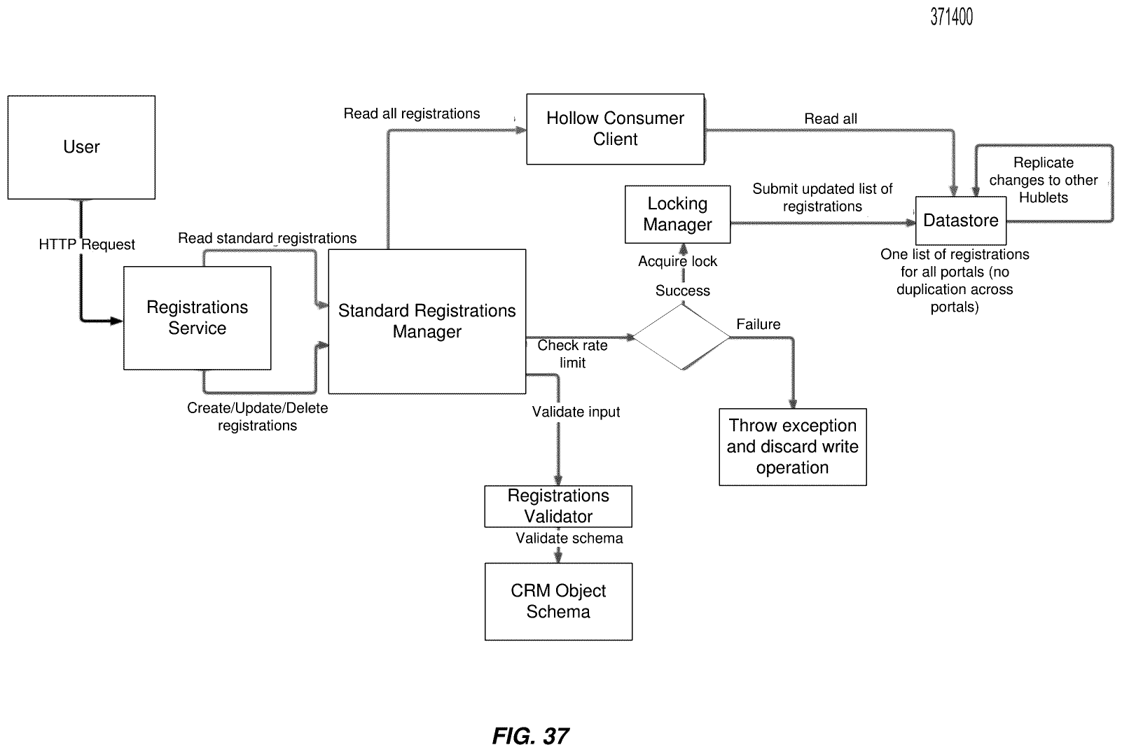

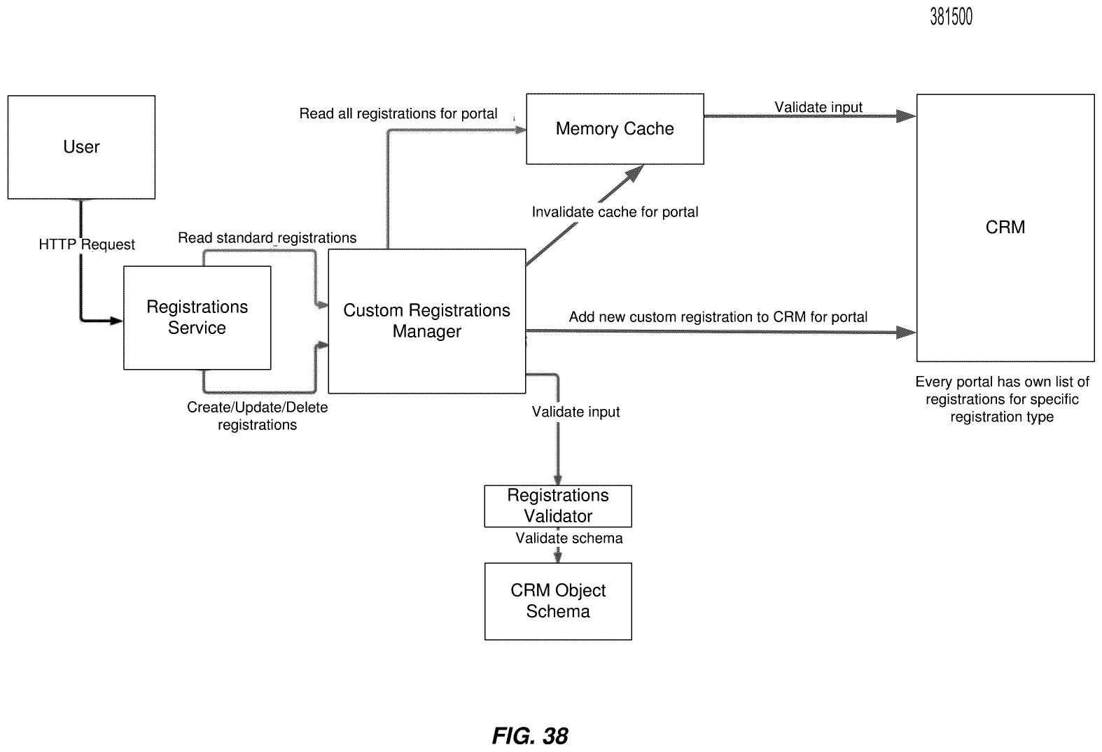

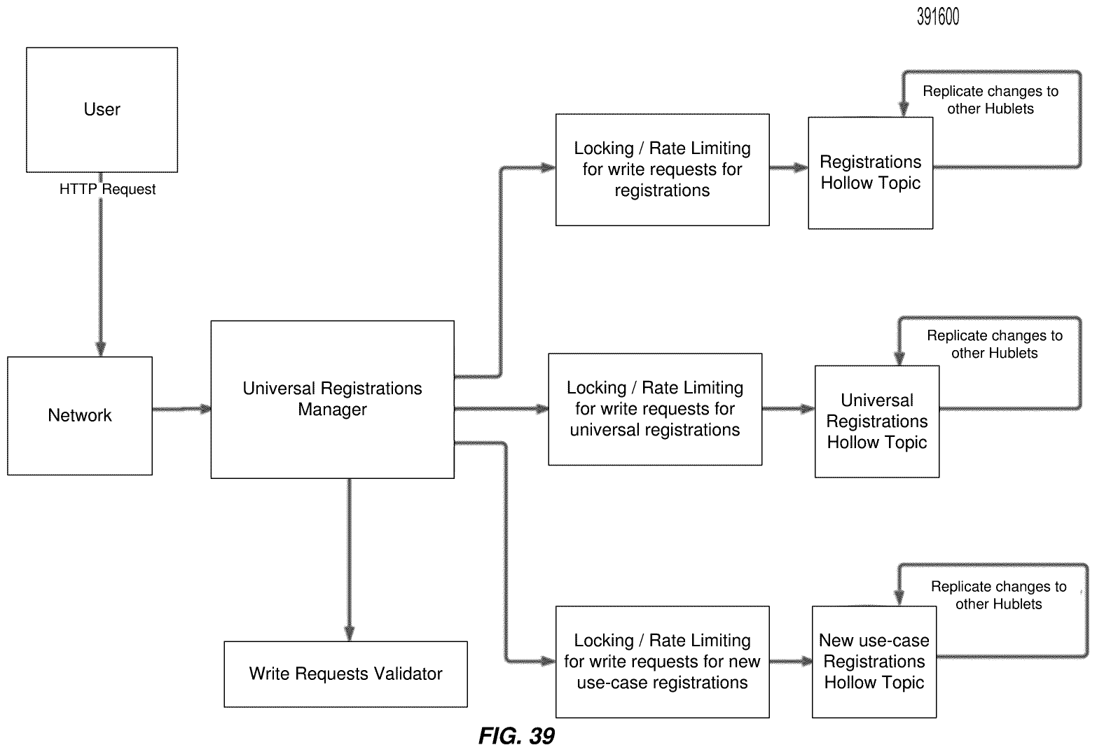

The platform includes a Customer Relationship Management (CRM) System, a Directed Content System, an Artificial Intelligence/Machine Learning (AI/ML) System, a Content Management System (CMS), a Multi-Client Ticketing System, a Customization System, a customizable Events System, a Payments System, a Reporting System, a Conversational Intelligence System, a Custom Workflow System, an Entity (or Object) Resolution System, an Infrastructure and Services System, and a Storage System in accordance with an aspect of the present disclosure. Additionally, the platform includes an AI/ML concierge system (e.g., AI/ML concierge system 24099 of FIGS. 24A-24C) and a chat interface (e.g., an AI/ML content assistance System) which operates seamlessly with the platform. The AI/ML concierge system is configured to send and receive data to any or all of the individual components shown in FIG. 1 to enable the use cases discussed herein.

The AI/ML Concierge System is shown in FIG. 1 as separate from the AI/ML System. However, in an embodiment, the AI/ML concierge is combined with the AI/ML System. In another embodiment, the AI/ML concierge leverages some or all of the AI/ML System and sends/receives data therewith to allow the platform to perform the functions described herein.

These systems may function and/or be used similarly to the same or similar systems described in the disclosure. For example, the AI/ML system is used with core objects and are also applied similarly to the custom objects. The platform may synchronize some arbitrary custom objects outside the platform to objects in the platform. In summary, in examples, the platform may act as an arbitrary platform that may act on arbitrary custom objects using various systems and the services (e.g., used with arbitrary actions and synced to arbitrary systems of the platform) thereby benefiting from these various capabilities. The external information sources may include company information or data on customers, products, sales, third party data, resource description framework (RDF) site summary (RSS) feeds or really simple syndication (RSS) feeds, telemetrics (e.g., from email, websites, app usage), and the like with respect to custom objects. The platform may also communicate with third party service(s) (e.g., third party applications, websites, databases, etc.) via network. The platform may also communicate with one or more integrator device(s) or apps, also referred to as developer apps. Developer apps may refer to user devices used by third-party integrators or developers who may create, define and deploy a series of custom objects, events, workflows, website themes and other services that may be integrated with other objects in the platform. The platform is configured to seamlessly connect and integrate objects and services that are deployed through an integrator or developer which then may be offered to users (e.g., clients) via the platform. For example, the platform may include internal and external APIs (as described in the disclosure) that a developer or integrator may use to define custom objects and integrate those custom objects into the CRM system. The integrator users may define a series of custom objects and then define object definitions. When a client device installs that integration, the platform may enable the user to then start creating and using instances of custom objects defined by the integrator users.

The AI/ML concierge includes a chat interface which allows users to input natural language commands that are processed using the power of AI/ML concierge. The AI/ML concierge can generate a wide variety of outputs based upon the natural language commands, such as programmatically generating reports, a blog on a particular topic, a presentation slide, a spreadsheet, images, software code, emails, contacts, etc. With AI/ML concierge, a user can complete a task using a declarative approach where the user inputs a natural language statement as a command/query that describes an outcome (e.g., “generate a report on a company ABC”), but does not include the actual functional steps or code to achieve the outcome. Instead, the AI/ML concierge takes the natural language statement as input, and generates and performs the functional steps or code that produces the outcome described by the natural language statement.

In some embodiments, the AI/ML concierge is linked to other various modules the multi-client service system platform, data sources (e.g., a website, a customer relations management database, an image repository, etc.) from sources and/or the Storage System, applications (e.g., a spreadsheet application, a presentation application, a word processing document, a social network application, an email or messaging application, etc.), and services (e.g., an email service) in order to enhance the capabilities of the chat interface. In some embodiments, the AI/ML concierge links to the CRM System in order to leverage information within the CRM System and populate new information within the CRM System (e.g., create tasks, create contacts, view marketing information, perform various analysis on sales data, create reports, etc.) based upon natural language commands input through the chat interface. In some embodiments, the AI/ML concierge and/or the chat interface may be integrated into and/or is a part of the multi-client service system platform.

The AI/ML concierge may implement various application programming interfaces (APIs) in order to interface with the modules (e.g., an API used to access the CRM System, a REST API to access a service accessible over a network, etc.). The AI/ML concierge may link to various applications, services, and content such as a spreadsheet application, a word processing application, a presentation application, a blogging service, a social network service, websites, databases, an image repository, social network profiles and posts, and/or other content in order to process natural language commands input through the chat interface, which is described in different use cases in FIGS. 24A-24C.

In an embodiment, the AI/ML concierge links to an artificial intelligence system of an integrator app that can create images and art from descriptions submitted through the chat interface in natural language. In another embodiment, the AI/ML concierge links to another integrator app keyword research service or tool that provides topics and content (e.g., ideas, concepts, topics, paragraphs of text, sentences of text, etc.) related to natural language commands input through a chat interface of the AI/ML concierge.

When a user inputs a natural language command through the chat interface (e.g., “generate a report on a company ABC”), the AI/ML concierge automatically selects certain modules, corresponding to the platforms, data sources, applications, and/or services, to utilize for processing the natural language command. The natural language command may describe a desired outcome such as the report about the company ABC, which may be used by the AI/ML concierge to select one or more of the modules to utilize for generating the desired outcome. The desired outcome, derived from the natural language command, may be used to select an order with which to access/invoke the modules, what inputs to input into each module (e.g., an output from one module may be used as an input to another module), and what outputs are expected from each module. For example, the CRM System and Storage System, a website of the company ABC, a business information repository, a social network service hosting a social network profile of the company ABC, and/or other modules or content may be selected in order to obtain information that the AI/ML concierge will use to generate the report. In this way, natural language commands input through the chat interface are used by the AI/ML concierge to select, order, and/or invoke certain modules in order to generate content using artificial intelligence, machine learning, and/or various types of models, which can be used by business growth professionals such as customer service agents, executives, a marketing team, a sales team, and/or a wide variety of other types of users.

FIG. 24A illustrates an embodiment of the chat interface 24000 powered by the AI/ML concierge of the platform 1000. The chat interface 24000 may be populated with a natural language input interface 24004 through which a user can input natural language commands to the AI/ML concierge 24099. The chat interface 24000 may include a suggestions interface 24002. The AI/ML concierge 24099 may generate suggested natural language commands to populate within the suggestions interface 24002 based upon a role of the user (e.g., the user may be part of a marketing, sales, IT, or management team of a company), a location of the user, prior natural language commands submitted by the user (e.g., the user may have recently submitted natural language commands to add new contacts from a contact spreadsheet into a Storage System 550), an employer of the user, information within emails of the user (e.g., a work email may indicate that the user is to add certain people as new contacts into the Storage System 550), information within a social network profile of the user, a web browser search history of the user, a purchase history of the user, information accessible through a module (e.g., information accessible through a CRM System 502, information within the spreadsheet accessible through a spreadsheet application or online spreadsheet hosting service, etc.), etc.

The suggestions interface 24002 may be populated with the suggested natural language commands that a user can select for inserting into the natural language input interface 24004, such as “how many total contacts are there?”, “show monthly summary of web visits last year”, “add contact . . . ”, “send that to me as a daily email update”, “where do I find a report on my social media performance”, “report of companies summarized by industry”, etc. In response to the user selecting a suggested natural language command through the suggestions interface 24002, the suggested natural language command may be auto populated within the natural language input interface 24004. In some embodiments, the suggested natural language command may be auto submitted through the natural language input interface 24004 or merely populated within the natural language input interface 24004 for further user editing.

In some embodiments, the user may input a first natural language command “add contact john doc, john.doc@mail.com, 24011 science way, cleveland ohio, follow-up in 3 days” into the natural language input interface 24004. In response to the user submitting the first natural language command through the natural language input interface 24004, the AI/ML concierge 24099 may parse the first natural language command using various parsing functionality (e.g., a declarative programming model or other functionality used to identify desired outcomes described in natural language, entity recognition functionality, semantic parsing, topic identification functionality, text classification functionality, deep learning-based text understanding, natural language processing functionality, machine learning, etc.). The AI/ML concierge 24099 evaluates the first natural language command using artificial intelligence, declarative programming models, and/or other machine learning in order to determine what functions and/or programming code to perform and what modules to use in order to achieve/generate the desired outcome. In some embodiments, the AI/ML concierge 24099 may identify a desired outcome of creating a contact for John Doe, along with a task of following up in 3 days with John Doc.

The AI/ML concierge 24099 may identify a module corresponding to the CRM system 502 that could be used as part of completing the desired outcome. The AI/ML concierge 24099 may generate an output 24006 by creating a contact in a particular format that could be used to create a contact within the CRM System 502. The AI/ML concierge 24099 may capitalize certain words, fill in missing information (e.g., add a zip code), query external data sources or modules in order to identify additional/supplementary information to include within the contact (e.g., retrieve a photo of John Doe from a social network profile), and/or perform other processing upon the first natural language command in order to create the contact. The AI/ML concierge 24099 may display the output 24006 of the contact through the chat interface 24000. The AI/ML concierge 24099 may populate the output 24006 with a View in CRM interface clement and an Add Note to Contact interface element. The user may utilize the Add Note to Contact interface element in order to add notes and/or edit the contact generated by the AI/ML concierge 24099. The user may utilize the View in CRM interface clement in order to invoke the AI/ML concierge 24099 to utilize various APIs in order to add the contact into the CRM System 502. Additionally, the user may be transitioned to a CRM application 24010 that displays the contact added to the CRM System 502. The CRM application 24010 may allow the user to view the contact, emails received by the contact, calls made to the contact, tasks related to the contact, meetings scheduled with the contact, activities related to the contact such as the task created by the AI/ML concierge 24099 for a later date or time period to follow-up with the contact, etc.

FIG. 24A also illustrates a chat interface 24020 powered by AI/ML concierge 24099. The chat interface 24020 may be populated with a natural language input interface 24024 and a suggestions interface 24022. The user may input a second natural language query “lookup company ABC” into the natural language input interface 24024. The AI/ML concierge 24099 may parse the second natural language query using various parsing functionality in order to identify a desired outcome of creating a company overview for Company ABC. The AI/ML concierge 24099 may utilize the desired outcome and/or information parsed from the second natural language query in order to determine what functions and/or programming code to implement, which modules to utilizes, what inputs to input into the modules, an order with which to utilize the modules, whether outputs from certain modules should be used as inputs for other modules, and/or how to format and/or combine the outputs for generating the desired outcome. In this way, the AI/ML concierge 24099 creates an output 24026 of the company overview for Company ABC for display through the chat interface 24020. The output 24026 may be populated with information retrieved from various modules (e.g., a website of Company ABC, a social network service hosting a social network profile of Company ABC, information about Company ABC within the Storage System 550, SEC filing data for Company ABC, news articles related to Company ABC, etc.). The output 24026 may be populated with a number of employees, a company description, a founding year, a location, a link to a social network profile of Company ABC, and/or other information related to Company ABC.

FIG. 24B illustrates a chat interface 24030 powered by AI/ML concierge 24099. The chat interface 24030 may be populated with a natural language input interface 24034 and a suggestions interface 24032. The user may input a third natural language query “find companies in cleveland ohio with over 240 k employees” into the natural language input interface 24034. The AI/ML concierge 24099 may parse the third natural language query using various parsing functionality in order to identify a desired outcome of generating a list of companies located in Cleveland, Ohio that have over 240,000 employees. The AI/ML concierge 24099 may utilize the desired outcome and/or information parsed from the third natural language query in order to determine what functions and/or programming code to implement, which modules to utilizes, what inputs to input into the modules, an order with which to utilize the modules, whether outputs from certain modules should be used as inputs for other modules, and/or how to format and/or combine the outputs for generating the desired outcome. In this way, the AI/ML concierge 24099 creates an output 24036 of the list of companies for display through the chat interface 24030. The output 24036 may be populated with information retrieved from various modules, such as information from a Storage System 550 relating to companies located in Cleveland, Ohio with over 240,000 employees. The output 24036 may also be populated with lookup links to perform web searches for additional information associated with each company (e.g., a hyperlink to search results for a company's name).

FIG. 24B also illustrates a chat interface 24040 powered by AI/ML concierge 24099. The chat interface 24040 may be populated with a natural language input interface 24044 and a suggestions interface 24042. The user may input a fourth natural language query “create report of companies added in Q4 grouped by country” into the natural language input interface 24044. The AI/ML concierge 24099 may parse the fourth natural language query using various parsing functionality in order to identify a desired outcome of generating a company report that lists the number of companies added as clients in the 4th quarter of a current year where the list is grouped by different countries. The AI/ML concierge 24099 may utilize the desired outcome and/or information parsed from the fourth natural language query in order to determine what functions and/or programming code to implement, which modules to utilizes, what inputs to input into the modules, an order with which to utilize the modules, whether outputs from certain modules should be used as inputs for other modules, and/or how to format and/or combine the outputs for generating the desired outcome. In this way, the AI/ML concierge 24099 creates an output 24046 of the company report for display through the chat interface 24040. The output 24046 may be populated with information retrieved from various modules, such as information from the Storage System relating to companies that were added as clients in the 4th quarter of a current year. The AI/ML concierge 24099 may reformat and/or group the information from the Storage System 550 based upon countries for inclusion within the company report.

The user may subsequently submit a fifth natural language query of “update report and only include countries in South America” through the natural language input interface 24044 while the company report is displayed as the output 24046 through the chat interface 24040. Accordingly, the AI/ML concierge 24099 may parse the fifth natural language query using various parsing functionality in order to identify a desired outcome of updating the company report by filtering out countries that are not included within South America. The AI/ML concierge 24099 may utilize the desired outcome and/or information parsed from the fifth natural language query in order to determine what functions/codes to implement, which modules to utilizes, what inputs to input into the modules, an order to which to utilizes the modules, whether outputs from certain modules should be used as inputs for other modules, and/or how to format and/or combine the outputs for generating the desired outcome. In this way, the AI/ML concierge 24099 creates an updated output 24050 of an updated company report for display through the chat interface 24040.

FIG. 24B also illustrates a chat interface 24060 powered by the AI/ML concierge 24099. The chat interface 24060 may be populated with a natural language input interface 24064 and a suggestions interface 24062. The user may input a sixth natural language query “show me monthly summary of web visits for last year” into the natural language input interface 24064. The AI/ML concierge 24099 may parse the sixth natural language query using various parsing functionality in order to identify a desired outcome of generating a monthly summary of users visiting a website of the user during the prior year (2022). The AI/ML concierge 24099 may utilize the desired outcome and/or information parsed from the sixth natural language query in order to determine what functions and/or programming code to implement, which modules to utilizes, what inputs to input into the modules, an order with which to utilize the modules, whether outputs from certain modules should be used as inputs for other modules, and/or how to format and/or combine the outputs for generating the desired outcome. In this way, the AI/ML concierge 24099 creates an output 24066 of the monthly summary for display through the chat interface 24060. The output 24066 may be populated with information retrieved from various modules, such as information from a Storage System 550 relating to users visiting the user's website.

FIG. 24C illustrates a chat interface 24070 powered by AI/ML concierge 24099. The chat interface 24070 may be populated with a natural language input interface 24074 and a suggestions interface 24072. The user may input a seventh natural language query “send this to me as an email” into the natural language input interface 24074 while an output 24076 of a company list is displayed through the chat interface 24070. The AI/ML concierge 24099 may parse the seventh natural language query using various parsing functionality in order to identify a desired outcome of the chat interface 24070 constructing and sending an email to an email address of the user where the email includes the company list as either an attachment or within a body of the email. The AI/ML concierge 24099 may utilize the desired outcome and/or information parsed from the seventh natural language query in order to determine what functions and/or programming code to implement, which modules to utilizes (e.g., an email service), what inputs to input into the modules, an order with which to utilize the modules, whether outputs from certain modules should be used as inputs for other modules, and/or how to format and/or combine the outputs for generating the desired outcome. In this way, the AI/ML concierge 24099 generates the email and transmits the email through an email service to a recipient.

FIG. 24C also illustrates a chat interface 24080 powered by AI/ML concierge 24099. The chat interface 24080 may be populated with a natural language input interface 24084 and a suggestions interface 24082. The user may input an eighth natural language query “draft a blog about social network marketing and a.i. and add image of camera” into the natural language input interface 24084. The AI/ML concierge 24099 may parse the eighth natural language query using various parsing functionality in order to identify a desired outcome of creating a blog describing how artificial intelligence is used in social network marketing, which includes an image of a camera.

The AI/ML concierge 24099 may utilize the desired outcome and/or information parsed from the eighth natural language query in order to determine what functions and/or programming code to implement, which modules to utilizes (e.g., a keyword research service, a text generation service, an image generation service, etc.), what inputs to input into the modules, an order with which to utilize the modules, whether outputs from certain modules should be used as inputs for other modules, and/or how to format and/or combine the outputs for generating the desired outcome. In this way, the AI/ML concierge 24099 creates an output 24086 of the blog with text describing how artificial intelligence is used in social network marketing and with the image of a camera. The blog may have a certain length, reading level, and/or format (e.g., bullet points, outline, etc.) derived from the desired outcome. The output 24086 may be populated with an Upload Blog interface element that the user can click in order to upload/post the blog to a website, blogging service, etc. The output 24086 may be populated with an Edit interface clement that the user can click in order to transition into a blog editor interface for modifying the text and/or the image of the camera.

FIG. 24C also illustrates a chat interface 24090 powered by AI/ML concierge 24099. The chat interface 24090 may be populated with a natural language input interface 24094 and a suggestions interface 24092. The user may input a ninth natural language query “what keywords is website ranking for” into the natural language input interface 24094. The AI/ML concierge 24099 may parse the ninth natural language query using various parsing functionality in order to identify a desired outcome of creating a report that lists information about keywords associated with a website of the user. The AI/ML concierge 24099 may utilize the desired outcome and/or information parsed from the ninth natural language query in order to determine what functions and/or programming code to implement, which modules to utilizes, what inputs to input into the modules, an order with which to utilize the modules, whether outputs from certain modules should be used as inputs for other modules, and/or how to format and/or combine the outputs for generating the desired outcome. In this way, the AI/ML concierge 24099 creates an output 24096 of a report about the keywords associated with the website, which may include the keywords, a search volume for the keywords, a cost per click for the keywords, and/or links to landing pages for the keywords. The output 24096 may be populated with an Export to Spreadsheet interface clement that the user can click in order to export the report into a spreadsheet hosted by a spreadsheet service. The output 24096 may be populated with an Export to Presentation interface clement that the user can click in order to export the report into a presentation 24097 hosted by a presentation application 24098.

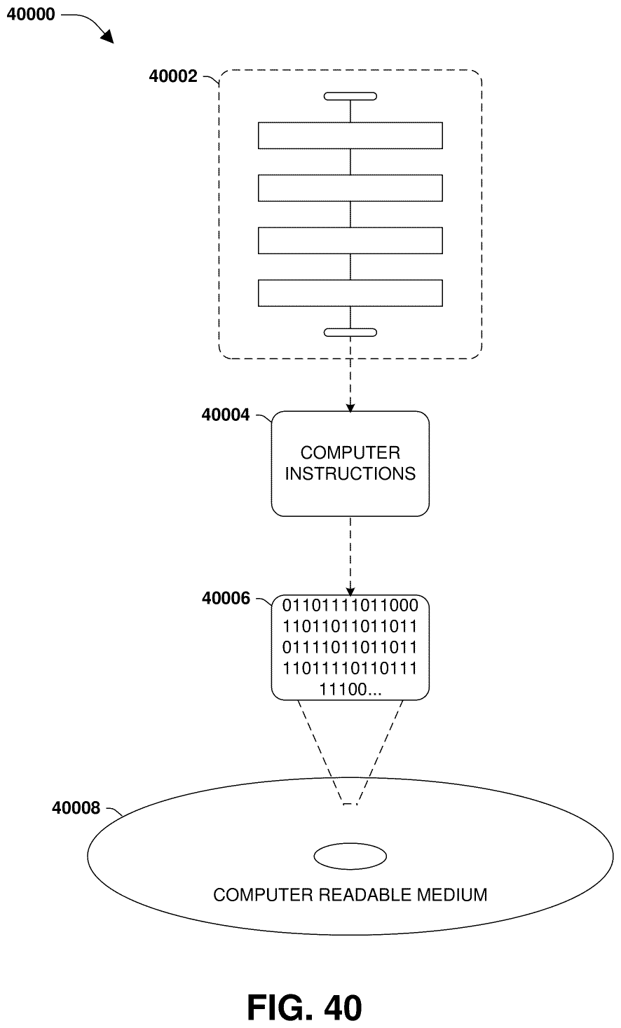

A computer-readable medium comprises processor-executable instructions configured to implement one or more of the techniques presented herein. An example embodiment of a computer-readable medium or a computer-readable device is illustrated in FIG. 40, wherein the implementation 40000 comprises a computer-readable medium 40008, such as a CD-R, DVD-R, flash drive, a platter of a hard disk drive, etc., on which is encoded computer-readable data 40006. This computer-readable data 40006, such as binary data comprising at least one of a zero or a one, in turn comprises a set of computer instructions 40004 configured to operate according to one or more of the principles set forth herein. In some embodiments, the processor-executable computer instructions 40004 are configured to perform a method 40002, for example. In some embodiments, the processor-executable instructions 40004 are configured to implement a system, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims. As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. A component may reside within a process and/or thread of execution and a component may be localized on one computer and/or distributed between two or more computers. Furthermore, the claimed subject matter may be implemented as a method, apparatus, or article of manufacture using programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Many modifications may be made to this configuration without departing from the scope or spirit of the claimed subject matter.

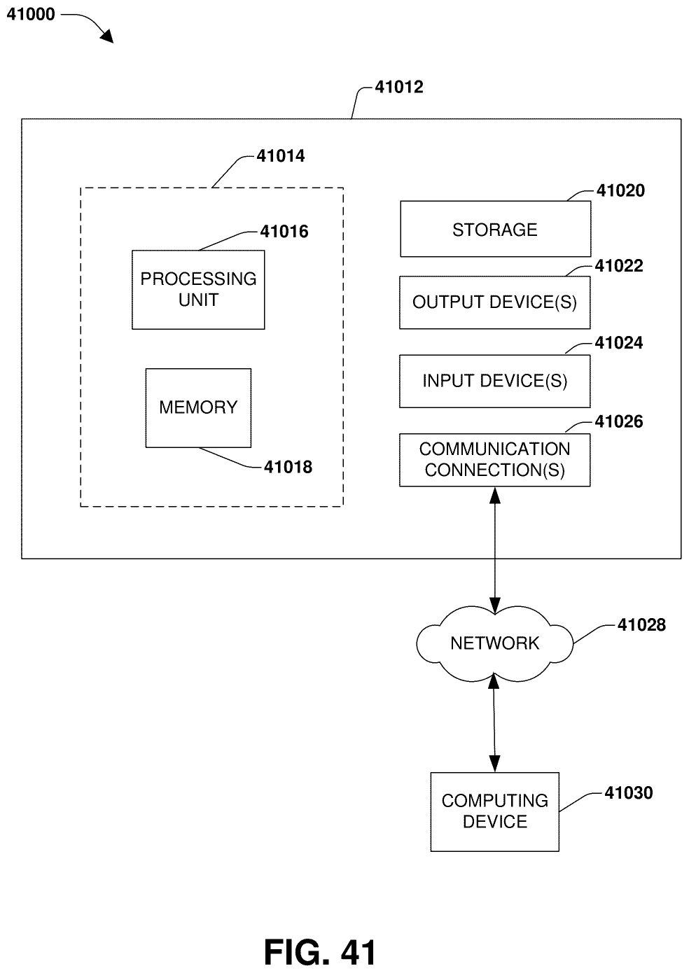

FIG. 41 and the following discussion provide a brief, general description of a suitable computing environment to implement embodiments of one or more of the provisions set forth herein. The operating environment of FIG. 41 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like. Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 41 illustrates an example of a system 41000 comprising a computing device 41012 configured to implement one or more embodiments provided herein. In one configuration, computing device 41012 includes at least one processing unit 41016 and memory 41018. Depending on the exact configuration and type of computing device, memory 41018 may be volatile (such as RAM, for example), non-volatile (such as ROM, flash memory, etc., for example) or some combination of the two. This configuration is illustrated in FIG. 41 by dashed line 41014. In other embodiments, device 41012 may include additional features and/or functionality. For example, device 41012 may also include additional storage (e.g., removable and/or non-removable) including, but not limited to, magnetic storage, optical storage, and the like. Such additional storage is illustrated in FIG. 41 by storage 41020. In one embodiment, computer readable instructions to implement one or more embodiments provided herein may be in storage 41020. Storage 41020 may also store other computer readable instructions to implement an operating system, an application program, and the like. Computer readable instructions may be loaded in memory 41018 for execution by processing unit 41016, for example. The term “computer readable media” as used herein includes computer storage media. Computer storage media includes volatile and nonvolatile, removable and non-removable media implemented in any method or technology for storage of information such as computer readable instructions or other data. Memory 41018 and storage 41020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 41012. Computer storage media does not, however, include propagated signals. Rather, computer storage media excludes propagated signals. Any such computer storage media may be part of device 41012.

Device 41012 may also include communication connection(s) 41026 that allows device 41012 to communicate with other devices. Communication connection(s) 41026 may include, but is not limited to, a modem, a Network Interface Card (NIC), an integrated network interface, a radio frequency transmitter/receiver, an infrared port, a USB connection, or other interfaces for connecting computing device 41012 to other computing devices. Communication connection(s) 41026 may include a wired connection or a wireless connection. Communication connection(s) 41026 may transmit and/or receive communication media. The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal. Device 41012 may include input device(s) 41024 such as keyboard, mouse, pen, voice input device, touch input device, infrared cameras, video input devices, and/or any other input device. Output device(s) 41022 such as one or more displays, speakers, printers, and/or any other output device may also be included in device 41012. Input device(s) 41024 and output device(s) 41022 may be connected to device 41012 via a wired connection, wireless connection, etc. In one embodiment, an input device or an output device from another computing device may be used as input device(s) 41024 or output device(s) 41022 for computing device 41012. Components of computing device 41012 may be connected by various interconnects, such as a bus. Components of computing device 41012 may be interconnected by a network. For example, memory 41018 may be comprised of multiple physical memory units located in different physical locations interconnected by a network. For example, a computing device 41030 accessible via a network 41028 may store computer readable instructions to implement one or more embodiments provided herein.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments. Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object. Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”. Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system comprising:
a customer relationship management (CRM) database; and
a multi-client service system platform that includes an artificial intelligence and machine learning (AI/ML) concierge configured to host a chat interface, wherein the AI/ML concierge performs operations including:
receiving a natural language command through the chat interface;
parsing the natural language command using AI/ML parsing functionality to determine a desired outcome;
generating programming code for execution to achieve the desired outcome;
executing the programming code to generate content related to the desired outcome, wherein the programming code interacts with objects within the CRM database; and
displaying the content through the chat interface.

2. The system of claim 1, wherein the AI/ML concierge displays a suggestion interface populated with suggested natural language commands.

3. The system of claim 1, wherein the AI/ML concierge transitions a user from the chat interface to a CRM application.

4. The system of claim 1, wherein the AI/ML concierge transitions a user from the chat interface to a spreadsheet application displaying a spreadsheet generated and populated by the AI/ML concierge using information within the content displayed through the chat interface.

5. The system of claim 1, wherein the AI/ML concierge transitions a user from the chat interface to a presentation application displaying a presentation generated and populated by the AI/ML concierge using information within the content displayed through the chat interface.

6. The system of claim 1, wherein the AI/ML concierge transitions a user from the chat interface to a blog service displaying a blog generated by the AI/ML concierge using information within the content displayed through the chat interface.

7. A method, comprising:
receiving a natural language command through a chat interface hosted by an artificial intelligence and machine learning (AI/ML) concierge of a multi-client service system platform;
parsing the natural language command using AI/ML parsing functionality to determine a desired outcome;
generating programming code for execution to achieve the desired outcome;
executing the programming code to generate content related to the desired outcome, wherein the programming code interacts with objects within a customer relationship management (CRM) database of a storage system; and
displaying the content through the chat interface.

8. The method of claim 7, comprising:
providing, through the chat interface, a toggle option to toggle between manual creation and AI generated content by the AI/ML concierge for creating new content.

9. The method of claim 7, comprising:
in response to the AI/ML concierge receiving a chat-based command through the chat interface, executing a database command to modify the CRM database.

10. The method of claim 7, comprising:
in response to the AI/ML concierge receiving a chat-based command through the chat interface, creating a new contact object within the CRM database.

11. The method of claim 7, comprising:
in response to the AI/ML concierge receiving a chat-based command through the chat interface, creating and sending an email.

12. The method of claim 7, comprising:
in response to the AI/ML concierge receiving a chat-based command through the chat interface, obtaining and displaying a report generated from the objects within the CRM database.

13. The method of claim 7, comprising:
in response to the AI/ML concierge receiving a chat-based command through the chat interface, deduplicating the objects within the CRM database.

14. The method of claim 7, comprising:
in response to the AI/ML concierge receiving a chat-based command through the chat interface, automatically capturing and transcribing a recorded conversation to create a transcription.

15. The method of claim 7, comprising:
in response to the AI/ML concierge receiving a chat-based command through the chat interface, logging and segmenting email contact information.

16. The method of claim 7, comprising:
in response to the AI/ML concierge receiving a chat-based command through the chat interface, importing contact and company information from a spreadsheet by mapping each cell of the spreadsheet to a CRM property of the objects within the CRM database.

17. A non-transitory computer-readable medium storing instructions that when executed facilitate performance of operations comprising:
receiving a natural language command through a chat interface hosted by an artificial intelligence and machine learning (AI/ML) concierge of a multi-client service system platform;
parsing the natural language command using AI/ML parsing functionality to determine a desired outcome;
generating programming code for execution to achieve the desired outcome;
executing the programming code to generate content related to the desired outcome, wherein the programming code interacts with objects within a customer relationship management (CRM) database of a storage system; and
displaying the content through the chat interface.

18. The non-transitory computer-readable medium of claim 17, wherein the operations further comprise:
in response to the AI/ML concierge receiving a chat-based command through the chat interface, generating a follow-up email based upon information within the objects in the CRM database.

19. The non-transitory computer-readable medium of claim 17, wherein the operations further comprise:
in response to the AI/ML concierge receiving a chat-based command through the chat interface, generating and including an image within a blog article.

20. The non-transitory computer-readable medium of claim 17, wherein the operations further comprise:
in response to the AI/ML concierge receiving a chat-based command through the chat interface, generating a custom report using information from the objects within the CRM database.
